(19) United States
(12) Patent Application Publication
(10) Pub. No.: US 2012/0051557 A1
(43) Pub. Date: Mar. 1, 2012

(54) VOICE COIL FOR SPEAKER DEVICE, AND SPEAKER DEVICE

(75) Inventors: Minoru Horigome, Yamagata (JP); Yasuhisa Abe, Yamagata (JP); Toshihiro Hikichi, Yamagata (JP); Hiroyuki Kobayashi, Yamagata (JP); Tempei Katsuta, Yamagata (JP); Kodai Nagasawa, Yamagata (JP)

(73) Assignees: TOHOKU PIONEER CORPORATION, Yamagata (JP); PIONEER CORPORATION, Kawasaki-Shi, Kanagawa (JP)

(21) Appl. No.: 13/146,809

(22) PCT Filed: Jul. 9, 2009
(86) PCT No.: PCT/JP2009/062477

§ 371 Date: Nov. 2, 2011

(30) Foreign Application Priority Data
Feb. 26, 2009 (JP) PCT/JP2009/053592

(51) Int. Cl. H04R 11/02; H04R 9/04

(52) U.S. Cl. 381/86; 381/400; 381/332

(57) ABSTRACT

To provide a thin speaker device a voice coil itself is made thin and vibration of the voice coil is efficiently transmitted to a diaphragm. The voice coil is used for a speaker device in which the vibration in one axial direction of the voice coil is transmitted to the diaphragm via a rigid vibration direction converter part, and the diaphragm is vibrated in a direction different from the one axial direction. The voice coil is formed with planarly and annularly wound conducting member and has rigidity at least in the vibration direction along the planar direction.

### BACKGROUND OF INVENTION

1. Field of the Invention

One or more embodiments of the present invention relate to a voice coil for speaker device and the speaker device.

2. Background Art

FIG. 1 shows a conventional speaker device. As a general speaker device, a dynamic speaker device as disclosed is known (for example, see patent literature 1). For example, as shown in FIG. 1, the dynamic speaker device described in this publication includes a frame 3J, a cone-shaped diaphragm 21J, an edge 4J which supports the diaphragm 21J to the frame 3J, a voice coil bobbin 610J joined to the inner periphery of the diaphragm 21J, a damper 7J which supports the voice coil bobbin 610J to the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by the Lorentz force developed in the voice coil 611J in the magnetic gap and the diaphragm 21J is driven by the vibration.

[Patent literature 1] Publication of unexamined patent application H8-149596 (FIG. 1)

The general dynamic speaker device described above is, for example as shown in FIG. 1, configured such that the voice coil 611J is disposed opposite to the sound emission side of the diaphragm 21J, and the vibration direction of the voice coil 611J and the voice coil bobbin 610J is the same as the vibration direction of the diaphragm 21J. In such a speaker device, a region for vibration of the diaphragm 10J, a region for vibration of the voice coil bobbin 610J, and a region for arranging the magnetic circuit, etc. are formed along the vibration direction (sound emission direction) of the diaphragm 21J. Accordingly, the total height of the speaker device inevitably becomes comparatively large.

Specifically, as shown in FIG. 1, the dimension of the speaker device along the vibration direction of the diaphragm 21J is defined by: (a) the height of the cone-shaped diaphragm 21J along the vibration direction plus the total height of the edge 4J which supports the diaphragm 21J to the frame 3J, (b) the height of the voice coil bobbin from the junction of the diaphragm 21J and the voice coil bobbin 610J to the upper end of the voice coil 611J, (c) the height of the voice coil, (d) the height mainly of the magnet of the magnetic circuit, corresponding to the height from the lower end of the voice coil 611J to the upper end of the yoke 51J, and (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to obtain a sufficient driving force. Accordingly, particularly in a speaker device for large volume, the total height of the speaker device inevitably becomes large.

Because the vibration direction of the voice coil bobbin 610J is the same direction as the vibration direction of the diaphragm 21J in conventional speaker devices as described above, the total height of the speaker devices inevitably becomes large to ensure the vibration stroke of the voice coil bobbin 610J, when seeking a large volume of sound by increasing the amplitude of the diaphragm 21J. Thus, it becomes difficult to make a device thin. In other words, making a device thin and securing a large volume of sound are contradictory.

Nevertheless, in order to efficiently transmit the vibration of the voice coil 611J to the diaphragm 21J, a direct transmission of the vibration from the voice coil 611J to the diaphragm 21J, i.e. the alignment of the vibration direction of the voice coil 611J and the vibration direction of the diaphragm 21J is possible. In the case that the vibration direction of the voice coil 611J and the vibration direction of the diaphragm 21J are different, the vibration of the voice coil 611J may not be securely transmitted to the diaphragm 21J, which may cause deterioration of the reproduction efficiency of the speaker device.

On the other hand, in a conventional dynamic type speaker device, because the voice coil bobbin 610J is joined to an inner periphery part of the diaphragm 21J having cone-shape and a driving force is transmitted from the voice coil bobbin 610J to the inner periphery part of the diaphragm 21J, it is comparatively difficult to drive the whole diaphragm substantially in the same phase. Therefore, a speaker device allowing the whole diaphragm to vibrate substantially in the same phase is desired.

For example, a condenser type speaker device is known as a thin speaker device. The condenser type speaker device has such a configuration that a diaphragm (movable electrode) and a fixed electrode are arranged opposite to each other. In this speaker device, the diaphragm is displaced by application of a DC voltage across the electrodes, and when a signal superimposed with an audio signal is inputted to the electrodes, the diaphragm vibrates in response to the signal. In the above-mentioned condenser type speaker device, however, if the audio signal with comparatively large amplitude of vibration is inputted, a driving force may nonlinearly vary considerably and thereby the quality of reproduced sound may be comparatively deteriorated.

That is, one or more embodiments of the present invention may provide a thin speaker device capable of emitting a loud reproduced sound with a comparatively simple configuration, a speaker device with a high reproduction efficiency capable of securely transmitting the vibration of the voice coil to the diaphragm, a thin speaker device capable of emitting a high-quality reproduced sound with a comparatively simple configuration, or a thin speaker device capable of vibrating the diaphragm substantially in the same phase with a comparatively simple configuration.

Further, to realize the above-mentioned thin speaker device, the voice coil itself as a vibration source is required to be made thin, and therefore one or more embodiments of the present invention may efficiently transmit a driving force generated by this thin voice coil to the diaphragm.

### SUMMARY OF INVENTION

The voice coil for speaker device and the speaker device according to one or more embodiments of the present invention have at least configurations described below:

A voice coil for speaker device, used for a speaker device, which transmits vibration in one axial direction of the voice coil to a diaphragm via a rigid vibration direction converter part and vibrates the diaphragm in a direction different from the one axial direction, wherein the voice coil includes a conducting member that is planarly and annularly wound, and has rigidity at least in the vibration direction in the planar direction.

A speaker device including a driving part having the voice coil and a magnetic circuit vibrating the voice coil; a diaphragm to which the vibration of the driving part is transmitted in response to an audio signal; and a static part supporting the driving part and the diaphragm; wherein the driving part includes a vibration direction converter part that angle converts the vibration of the voice coil and transmits the vibration to the diaphragm, and the vibration direction converter part includes a rigid link part that is provided slantwise with respect to each of the vibration direction of the diaphragm and the vibration direction of the voice coil.

A speaker device including: a driving part that has a voice coil with rigidity at least in the vibration direction including an annularly wound conducting member, and a magnetic circuit vibrating the voice coil; a diaphragm to which the vibration of the driving part is transmitted in response to an audio signal; and a static part supporting the driving part and the diaphragm; wherein the driving part includes a vibration direction converter part that angle converts the vibration of the voice coil and transmits the vibration to the diaphragm, and one end part of the vibration direction converter part is angle-variably connected with the voice coil directly or via other member while another end part of the vibration direction converter part is angle-variably connected with the diaphragm directly or via other member, the rigid link part being provided slantwise with respect to each of the vibration directions of the diaphragm and the voice coil.

### BRIEF DESCRIPTION OF THE DRAWINGS

FIG. 1 is a view illustrating a speaker device of a prior art;

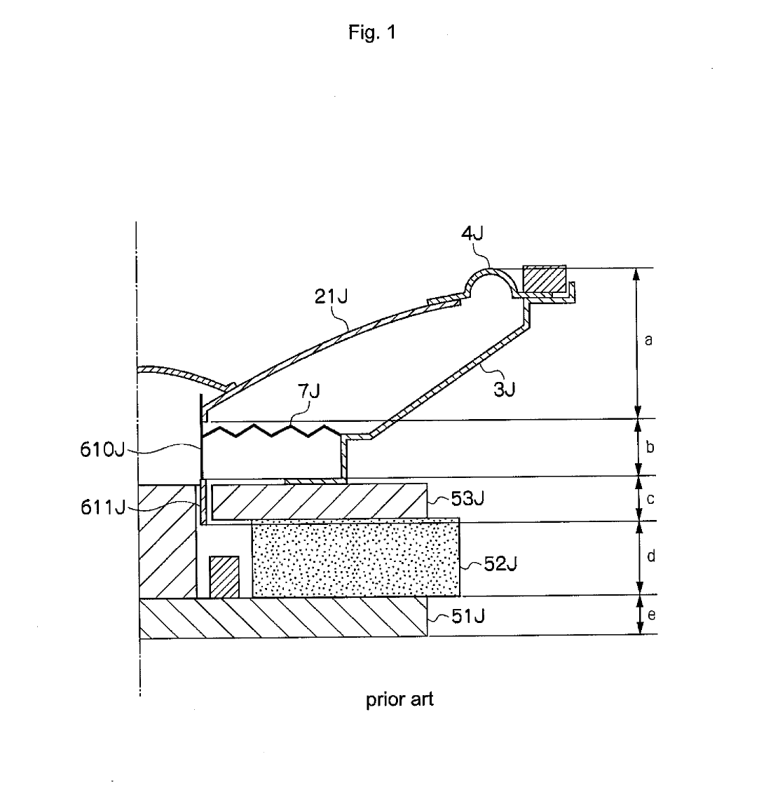

FIGS. 2(a)-(d) are views illustrating a voice coil for the speaker device according to an embodiment of the present invention (cross-sectional view on the right hand from the center O);

FIGS. 3(a)-(g) are views illustrating a voice coil for the speaker device according to an embodiment of the present invention (cross-sectional view on the right hand from the center O);

FIGS. 4(a)-(e) are views illustrating a voice coil for the speaker device according to an embodiment of the present invention (cross-sectional view);

FIGS. 5(a)-(c) are views illustrating a voice coil for the speaker device according to an embodiment of the present invention;

FIG. 6 is a view illustrating a voice coil for the speaker device according to an embodiment of the present invention;

FIGS. 7(a)-(b) are views illustrating a voice coil for the speaker device according to an embodiment of the present invention;

FIGS. 8(a)-(c) are views illustrating a voice coil for the speaker device according to an embodiment of the present invention;

FIGS. 9(a)-(b) are views illustrating a voice coil for the speaker device according to an embodiment of the present invention;

FIGS. 10(a)-(b) are views illustrating a voice coil for the speaker device according to an embodiment of the present invention;

FIGS. 11(a)-(b) are views illustrating a voice coil for the speaker device according to an embodiment of the present invention;

FIGS. 12(a)-(b) are views illustrating a voice coil for the speaker device according to an embodiment of the present invention;

FIGS. 13(a)-(c) are views illustrating a voice coil for the speaker device according to an embodiment of the present invention;

FIG. 14 is a view illustrating a voice coil for the speaker device according to an embodiment of the present invention;

FIG. 15 is a view illustrating a magnetic circuit vibrating a voice coil for the speaker device according to an embodiment of the present invention;

FIG. 16 is a view illustrating a magnetic circuit vibrating a voice coil for the speaker device according to an embodiment of the present invention;

FIG. 17 is a view illustrating a magnetic circuit vibrating a voice coil for the speaker device according to an embodiment of the present invention;

FIGS. 18(a)-(c) are views illustrating a whole configuration of the speaker device including the voice coil according to an embodiment of the present invention;

FIGS. 19(a)-(c) are views illustrating a whole configuration of the speaker device including the voice coil according to an embodiment of the present invention;

FIGS. 20(a)-(c) are views illustrating a whole configuration of the speaker device including the voice coil according to an embodiment of the present invention;

FIG. 21 is a view illustrating a body holding the voice coil according to an embodiment of the present invention to the frame;

FIGS. 22(a)-(b) are views illustrating a body holding the voice coil according to an embodiment of the present invention to the frame;

FIGS. 23(a)-(c) are views illustrating a vibration direction converter part of the speaker device according to an embodiment of the present invention;

FIGS. 24(a)-(c) are views illustrating a vibration direction converter part of the speaker device according to an embodiment of the present invention;

FIG. 25 is a view illustrating a vibration direction converter part of the speaker device according to an embodiment of the present invention;

FIGS. 26(a)-(b) are views illustrating a vibration direction converter part of the speaker device according to an embodiment of the present invention;

FIGS. 27(a)-(c) are views illustrating a modification of the voice coil;

FIG. 28 is a view illustrating a modification of the magnetic circuit;

FIG. 29 is a view illustrating a modification of the magnetic circuit;

FIG. 30 is a view illustrating the speaker device according to an embodiment of the present invention;

FIG. 31 is a view illustrating the speaker device according to an embodiment of the present invention;

FIG. 32 is a view illustrating the speaker device according to an embodiment of the present invention;

FIG. 33 is a view illustrating the speaker device according to an embodiment of the present invention;

FIG. 34 is a view illustrating the speaker device according to an embodiment of the present invention;

FIGS. 35(a)-(b) are views illustrating the speaker device according to a reference example of the present invention;

FIG. 36 is a view illustrating the speaker device according to another embodiment of the present invention;

FIG. 37 is a view illustrating the speaker device according to another embodiment of the present invention;

FIG. 38 is a view illustrating the speaker device according to another embodiment of the present invention;

FIG. 39 is a view illustrating the speaker device according to another embodiment of the present invention;

FIG. 40 is a view illustrating the speaker device according to another embodiment of the present invention;

FIGS. 41(a)-(b) are views illustrating the speaker device according to another embodiment of the present invention;

FIG. 42 is a view illustrating the speaker device according to another embodiment of the present invention;

FIG. 43 is a view illustrating the speaker device according to another embodiment of the present invention;

FIG. 44 is a view illustrating an assembly configuration of the speaker device according to an embodiment of the present invention;

FIG. 45 is a view illustrating a modification of the present invention;

FIGS. 46(a)-(b) are views illustrating an electronic device incorporating the speaker device according to an embodiment of the present invention; and

FIG. 47 is a view illustrating a vehicle incorporating the speaker device according to an embodiment of the present invention.

### DETAILED DESCRIPTION

A voice coil for a speaker device according to an embodiment of the present invention is used for a speaker device, which transmits vibration in one axial direction of the voice coil to a diaphragm via a rigid vibration direction converter part and vibrates the diaphragm in a different direction with respect to the one axial direction, and the voice coil includes a planarly and annularly wound conducting member. The voice coil has rigidity at least in the vibration direction along the planar direction.

According to this feature, the voice coil itself can be made thin compared to a conventional cylindrical voice coil, and thus the whole speaker device can be made thin. Further, the speaker device including this voice coil is configured such that vibration direction of the voice coil does not directly affect the total thickness of the speaker device because the speaker device transmits the vibration in one axial direction of the voice coil to a diaphragm via a rigid direction converter part and vibrates the diaphragm in a direction different with respect to the one axial direction of the voice coil. This will enable the speaker device to be made thin while a loud reproduced sound can be produced by increasing the amplitude of vibration of the voice coil. Further, because the voice coil itself has rigidity, the vibration of the voice coil can be securely transmitted to the diaphragm via the rigid vibration direction converter part, and thus a speaker device with high reproduction efficiency can be provided while the speaker device can be made thin and is capable of producing loud sound. Here, rigidity means property causing little bending, buckling and deflection by resonance, but not implying only perfect rigidity.

Further the above-mentioned voice coil for speaker device has rigidity supported by a rigid base. According to this feature, a given material can be applied to the conducting member itself of the voice coil.

Further the above voice coil for speaker device is configured such that the above conducting member is arranged on the surface of the base. According to this configuration, conducting member is arranged on the surface of a planar base, and thereby a planar voice coil having rigidity can be simply formed.

Further an annular step part is formed at the base of the above voice coil for speaker device and the above conducting member is arranged at the above step part. According to this configuration, annular conducting member can be positioned at the annular step part of the base while the conducting member having a thickness can be embedded in a groove of the step part, and thus the conducting member can be arranged at the base without taking up little space of the voice coil itself.

Further, the above voice coil for speaker device includes an opening part with the base and the conducting member being annularly formed, which can form a hollow portion at the opening part, thereby the weight of the voice coil can be reduced. Also, the weight of the base can be reduced such that the voice coil can be vibrated sensitively in response to a driving force generated at the voice coil. With the opening part formed inside the conducting member, abnormal noise can be prevented from occurring due to vibration of the inner side of the conducting member.

Further, in the above voice coil for speaker device, a part of the conducting member is placed on and joined to a rigid placement portion that is formed at the base from the inner periphery part to the inner side, and thus the conducting member can be formed integrally with the voice coil, and therefore the voice coil can be securely vibrated due to a driving force generated at the conducting member.

Further, in the above voice coil for speaker device, the conducting member is sandwiched between at least two bases. According to this feature, the conducting member is sandwiched between bases having rigidity, and thereby the conducting member can be protected by the bases having rigidity.

Further, inner filling member is arranged in the above voice coil for speaker device so as to fill a gap between the two bases. According to this configuration, a gap formed between bases by sandwiching the conducting member with the two bases is filled with inner filling member, rigidity of the whole voice coil including the conducting member and the bases can be further increased. Further, when a gap is formed between the bases, the bases vibrate and generate abnormal noise, and so-called “squeal noise phenomenon” may occur. However, such “squeal noise phenomenon” can be prevented by filling the gap with the inner filling member.

Further, in the above voice coil for speaker device, the inner filling member has higher rigidity than the above base. According to this feature, rigidity of the whole voice coil including the inner filling member, the conducting member and the base can be further increased due to rigidity of the inner filling member. Further, the inner filling member having higher rigidity than the base, abnormal noise occurring by the base being bent can be prevented. Also, vibration of the voice coil can be efficiently transmitted by preventing the base from being bent.

Further, in the above voice coil for speaker device, the inner filling member is formed with the similar material to the base. According to this feature, unity of the whole voice coil including the inner filling member, the conducting member and the base can be enhanced. In other words, it becomes possible to comparatively decrease difference between resonance frequency in the inner filling member and resonance frequency in the base or to prevent occurrence of specific resonance frequency, etc.

Further, in the above voice coil for speaker device, the thickness of the base is smaller than that of the inner filling member or the conducting member. According to this configuration, because the thickness of the base is made thin, the thickness of the whole voice coil can be made small without affecting the conducting member.

Further, in the above voice coil for speaker device, a conducting layer is pattern formed at the surface of the base in the outside of the conducting member. Because the conducting layer is provided on the base, occurrence of current distortion (harmonic distortion) can be prevented or a damping force can be applied to vibration of the voice coil, and thereby the voice coil can be prevented from vibrating with excessive amplitude of vibration.

Further, in the above voice coil for speaker device, a pair of the conducting layer is arranged so as to surround the conducting member and functions as a junction wire introducing an audio signal into the conducting member. According to this configuration, wiring of the conducting member can be applied anywhere around the conducting layer, and thereby space efficiency of wiring of audio signal input can be improved.

Further, in the above voice coil for speaker device, the conducting layer is formed annularly. According to this configuration, the conducting layer can have a short ring function, and thereby occurrence of current distortion (harmonic distortion) can be effectively prevented.

Further, in the above voice coil for speaker device, a plurality of the conducting layers is pattern formed at both sides of the conducting member in the vibration direction of the voice coil. According to this configuration, because a damping force can be applied to vibration of the voice coil, vibration of the voice coil with excessive amplitude of vibration can be prevented. Further, acoustic characteristic can be adjusted by applying a damping force to the voice coil.

Further, in the above voice coil for speaker device, one of a plurality of the conducting layers is formed in a closed shape while another is formed in an open shape. According to the above configuration, the above-mentioned short ring function can be obtained due to the closed shape, and a terminal leading configuration can be formed due to the open shape. One conducting layer is formed as the short ring layer, and the width of the short ring layer is adapted to be substantially the same or smaller than the width of the conducting member, and a damping force applied to the voice coil due to the short ring function can be adjusted by adjusting the width of the short ring layer.

Further, the above-mentioned voice coil for speaker device is wound from the center side to the outer side with different diameters and is arranged between two bases. According to this feature, the amount of voice currents passing through the conducting member can be adapted to be substantially equal to the inputted voice currents, thereby an electromagnetic force applied to the conducting member can be adjusted to be comparatively large.

Further, in the above mentioned voice coil for speaker device, the conducting member wound in the similar diameter is stacked in the thickness direction of the base. According to this configuration, the conducting member can be wound tightly, thereby a driving force can be further increased.

Further, in the above-mentioned voice coil for speaker device, the conducting member includes a polygonal cross-sectional shape. According to this configuration, occupancy ratio of the conducting member can be increased compared to the conducting member having a circular cross-sectional shape. According to this configuration, the voice coil can be made thin while a driving force generated by the voice coil can be increased.

Hereinafter, an embodiment of the present invention is described with reference to the drawings. In the drawings, the vibration direction of the voice coil is defined as X axial direction, the vibration direction of the diaphragm orthogonal to the X axial direction is defined as Z axial direction and the direction orthogonal to these directions is defined as Y axial direction.

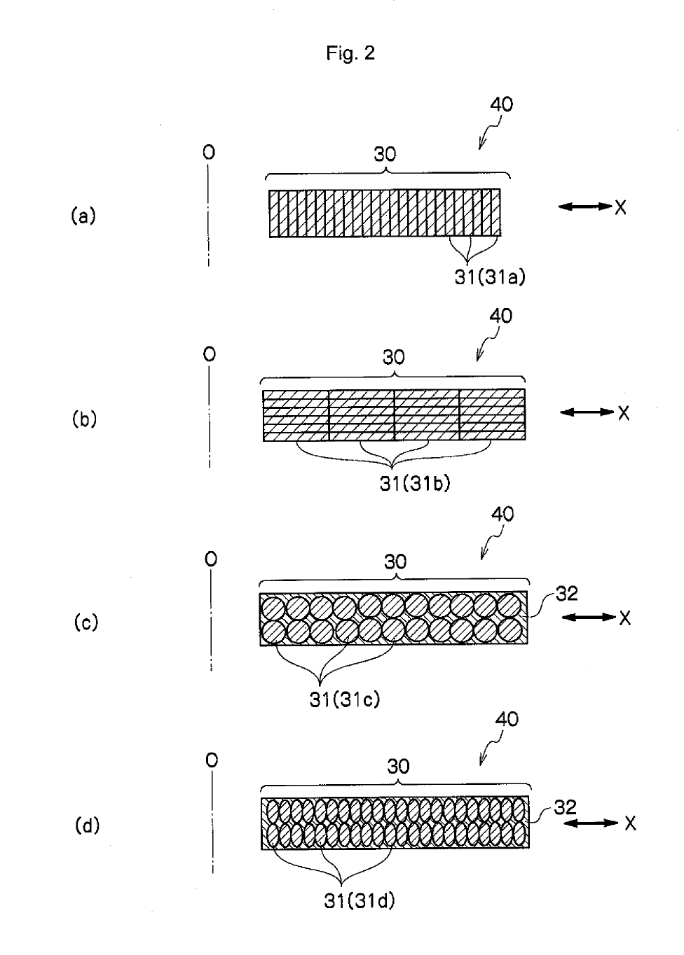

### Voice Coil; FIGS. 2 to 14

FIG. 2 is a view illustrating a voice coil for the speaker device according to an embodiment of the present invention (cross-sectional view on the right hand from the center O). The voice coil 40 is formed with a conducting member 30 planarly and annularly wound and has rigidity with respect to the vibration direction (X axial direction) at least along the planar direction. The conducting member 30 is formed by planarly wiring a wire 31, which is one of wires having various kinds of shapes respectively. In the example shown in FIGS. 2(a) and 2(b), the wire 31 (31a, 31b) itself has a polygonal (rectangular) cross-sectional shape, and has rigidity at least with respect to the vibration direction (X axial direction). In the example shown in FIG. 2(a), a wire 31a having a long cross-sectional shape in the direction orthogonal to the vibration direction (X axial direction) is wound in one layer, while in the example shown in FIG. 2(b), a wire 31b having a long cross-sectional shape in the vibration direction is wound in plural layers stacked in the direction orthogonal to the vibration direction (X axial direction).

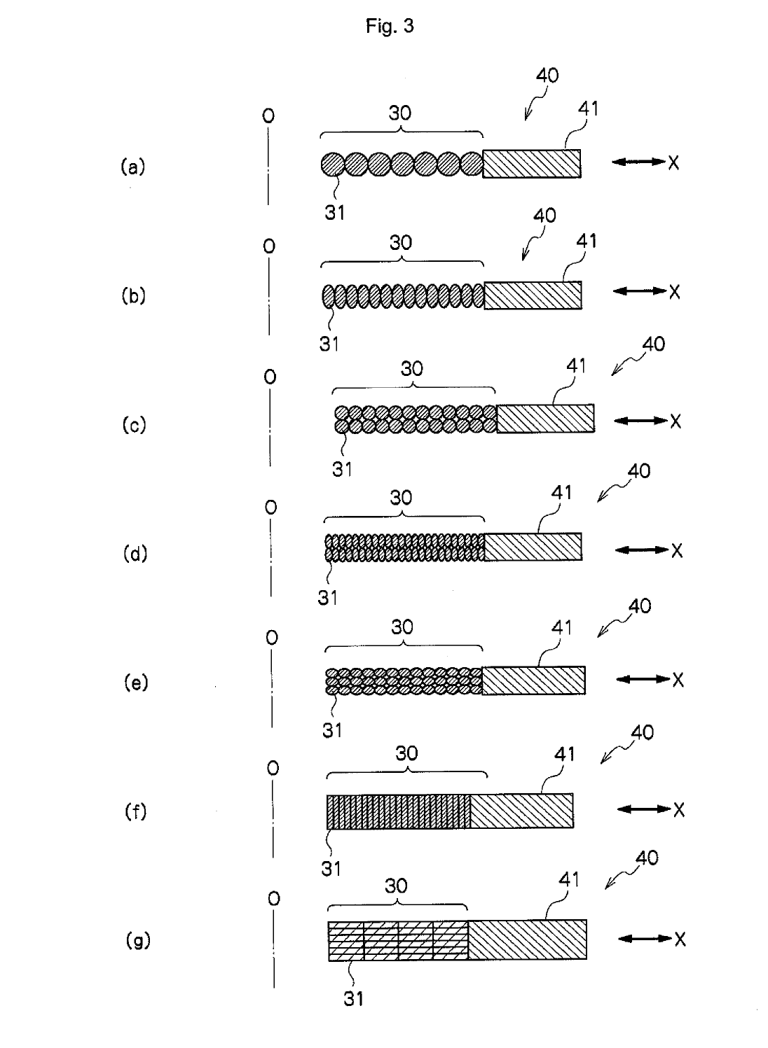

In the examples shown in FIGS. 2(c) and 2(d), the whole conducting member 30 formed with the wire 31 is connected with fixation agent 32 and rigidity in the vibration direction (X axial direction) is provided. The wire 31 may be a wire 31c having a circular cross-sectional shape as shown in FIG. 2(c), or may be a wire 31d having an elliptical cross-sectional shape as shown in FIG. 3(d). Although, in any of these examples shown in the drawings, the wire is wound stacked in multi layers having two layers in the direction orthogonal to the vibration direction, the wire may be wound in a single layer or may be wound in multi layers having three or more layers. Resin adhesive, etc. may be used as the fixation agent 32. The conducting member 30 may be formed with a single linear conducting wire, or may be formed with constructed with a plurality of conducting wires.

FIG. 3 is a view illustrating a voice coil for speaker device according to an embodiment of the present invention (cross-sectional view on the right hand from the center O). The voice coil 40, which is formed with the conducting member 30 that is wound planarly and annularly and has rigidity at least in the vibration direction (X axial direction) along the planar direction, is supported by a base 41 having rigidity. The wire 31 forming the conducting member 30 may have various kinds of cross-sectional shapes such as a circular cross-sectional shape (FIGS. 2(a) and 2(c)), an elliptical cross-sectional shape (FIGS. 2(b), 2(d) and 2(e)), a polygonal (rectangular) cross-sectional shape (FIGS. 2(f) and 2(g)), etc. Further, the wire 31 may be wound in given layer(s), including winding in one layer (FIGS. 2(a), 2(b) and 2(f)), winding in two layers (FIGS. 2(c) and 2(d)), and winding in multi layers formed with a plastic plate, etc. that has rigidity and insulating property.

Specifically, the base may be formed with a substrate used for a printed circuit board, for example, such as a paper-phenol substrate (phenol system resin impregnated paper), a paper-epoxy substrate (epoxy resin impregnated paper), a glass-composite substrate (epoxy resin impregnated glass fibers that is stacked and trimmed), a glass-epoxy substrate (epoxy system resin impregnated sheeted member formed with having stacked cloths formed glass fibers, stacked woven fabrics, or stacked unwoven fabrics, etc.), Teflon substrate (substrate formed with Teflon (a registered trademark)), an alumina substrate (substrate formed with aluminum oxide), and a composite substrate (substrate formed with paper-epoxy substrates and the above glass-epoxy substrate sandwiched between the paper-epoxy substrates).

In the example shown in the drawings, an opening for attachment is formed at the base 41, and the conducting member 30 is arranged in the opening. Rigidity of the voice coil 40 can be obtained by the base 41 having rigidity, and thus options of material for conducting member 30 can be expanded.

In FIG. 3, the conducting member 30 is formed with the wire 31 wound from the center side to outer side in different diameters, and when the conducting member is wound in multi layers, the wire 31 of the conducting member 30 wound in the similar diameter is stacked in the thickness direction of the base 41. Further, an opening part is formed in the inner side of the inner periphery part of the conducting member 30.

When the cross-sectional shape of the conducting member 30 is formed, for example, in a circular shape, a gap is formed between each conducting members 30. On the other hand, when the cross-sectional shape of the conducting member is formed in a rectangular shape or a polygonal shape, the occupancy ratio of the conducting member 30 in the voice coil 40 becomes comparatively large compared to the conducting member 30 with circular cross-sectional shape, and thus an electromagnetic force applied to the voice coil 40, more specifically, an electromagnetic force, applied to the conducting member 30, which forms the voice coil 40 arranged in the magnetic gap described below and receives the audio signal, can be comparatively increased. According to the above configuration, a comparatively large driving force can be applied to the diaphragm. Further, because the occupancy ratio can be large, the thickness of the voice coil 40 can be made comparatively small, which contributes to making the speaker device thin. Here, the occupancy is defined as a occupancy ratio of the conducting member over a prescribed area, which is represented as B*C/A, where C conducting members with cross-sectional area of B passes through a two dimensional region (plane) with prescribed area A.

Particularly, when comparing the conducting member 30 having circular cross-sectional shape with the conducting member 30 having non-circular cross-sectional shape under the condition that both cross-sectional areas are the same in size, the occupancy ratio can become larger in the conducting member 30 having non-circular cross sectional shape than in the conducting member 30 with circular cross sectional shape because a gap between the conducting members 30 having circular cross-sectional shapes are larger than a gap between the conducting members 30 having non-circular cross-sectional shapes.

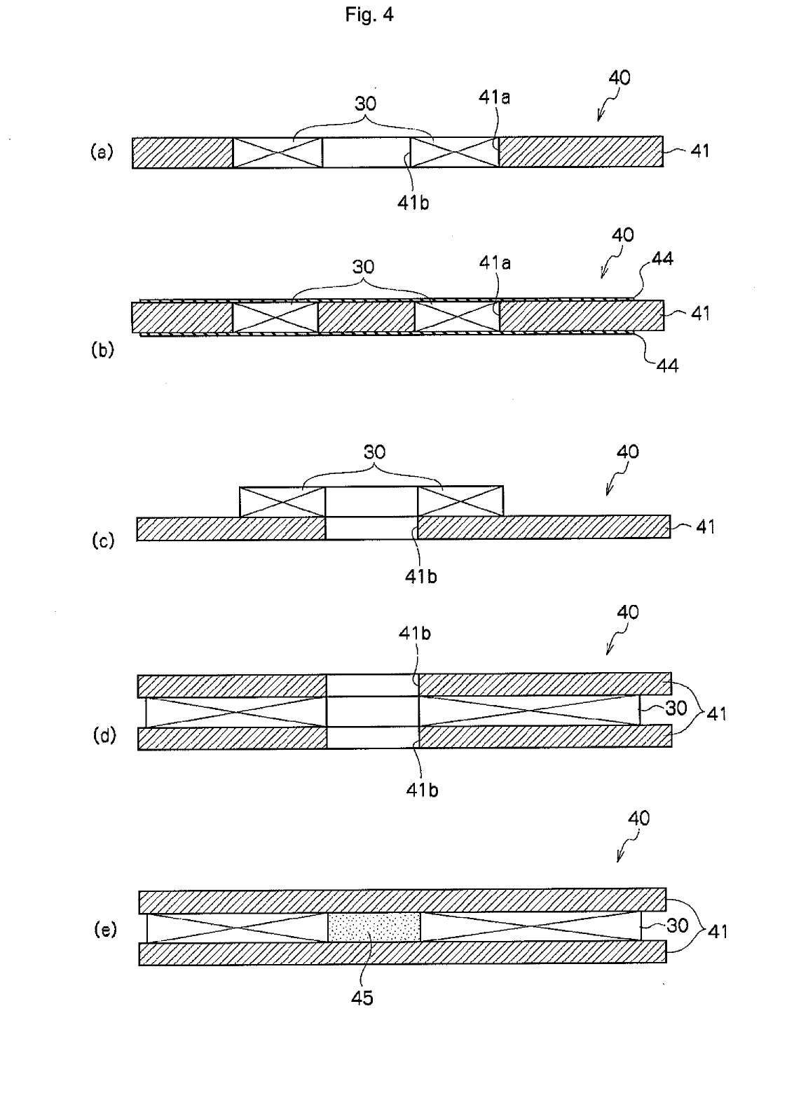

FIG. 4 is a view illustrating a voice coil for the speaker device according to an embodiment of the present invention (cross-sectional view) and a state in which the conducting member 30 is supported. Here, the conducting member 30 can have a configuration as shown in FIG. 3. The example shown in FIG. 4(a) has the configuration shown in FIG. 3, and the base 41 forms an opening for a voice coil attachment 41a. Inside the opening, the conducting member 30 is arranged. Further, an opening part 41b is formed at the inside of the inner periphery part of the conducting member 30.

In the example shown in FIG. 4(b), the annular conducting member 30 is attached to the voice coil attachment 41a having annular shape and a protection films 44 are applied to both faces of the base 41 so as to cover the conducting member 30.

In the example shown in FIG. 4(c), the conducting member 30 is arranged at the surface of the base 41. The opening 41b is formed at the base 41 so as to correspond to the center opening of the conducting member 30. In the examples shown in FIGS. 4(d) and 4(e), the conducting member 30 is sandwiched at least between two bases 41. In the example shown in FIG. 4(d), the above opening part 41b is formed at each of the bases 41, while in the example shown in FIG. 4(e), no such opening part 41b is formed. Inner filling member 45 is arranged so as to fill the gap between the two bases 41. The inner filling member 45 can have higher rigidity than the base 41 or can be formed with the similar material as the base 41. If difference between inner filling member 45 and the base 41 in resonance frequency is comparatively small, other material different from the base 41 can be used. Also, a material having no large difference in rigidity or internal loss compared to the base 41 may be used as the inner filling member 45. Further, to make thin the whole thickness of the voice coil 40, the thickness of the base 41 may be made smaller than that of the inner filling member 45 or that of the conducting member 30.

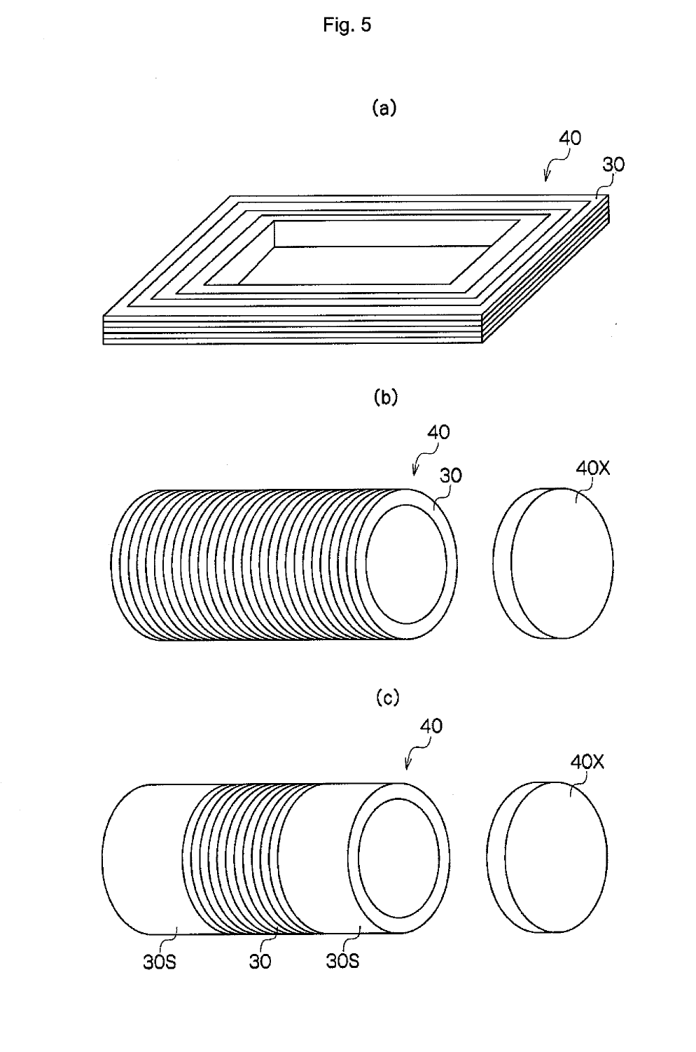

FIGS. 5 to 14 are views illustrating more specific embodiments of a voice coil for the speaker device. In the example shown in FIG. 5, the voice coil 40 is formed with the conducting member 30 alone. In the example shown in FIG. 5(a), a tabular voice coil is formed by winding the conducting member 30 in a rectangular shape. In the example shown in FIG. 5(b), a voice coil 40 is formed by winding the conducting member 30 cylindrically. A cap member 40X can be fixed to the edge end part to connect other member to the edge end part. In the example shown in FIG. 5(c), the conducting member 30 is wound cylindrically to form the voice coil 40 and is sandwiched by supporting members 30S formed with resin. Also, in this example, the cap member 40X can be fixed to the edge end part to connect other members to the edge end part. In both examples, rigidity is provided in the vibration direction, however, the voice coil can be made thin in the example shown in FIG. 5(a).

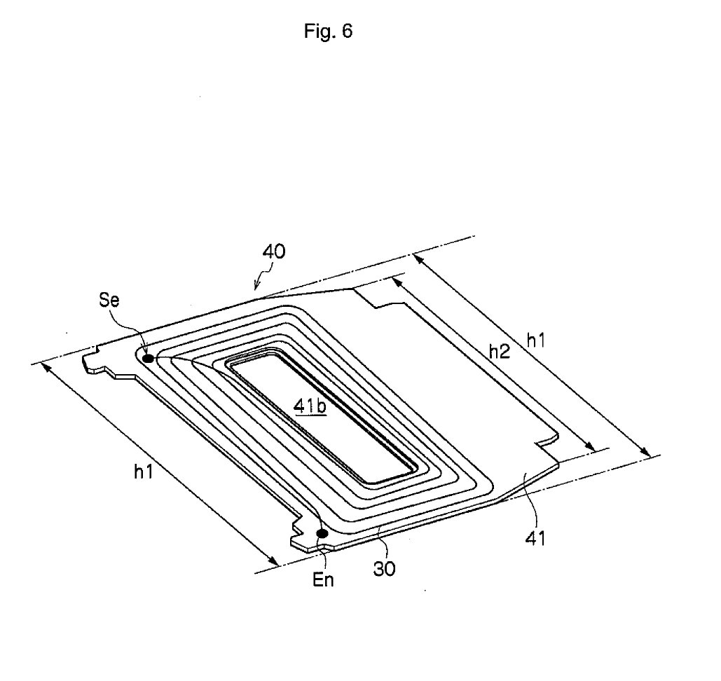

In the voice coil 40 shown in FIG. 6, the conducting member 30 is supported by the base 41. In the conducting member 30 supported on the base 41, winding of a conducting wire starts at a terminal Se and ends at a terminal En. An opening part 41b is formed at the center part of the wound conducting member 30. In the voice coil 40, both widths h1 of the voice coil 40 in the direction orthogonal to the vibration direction are substantially the same between the end parts of the conducting member 30 in the vibration direction. The voice coil 40 is formed to be gradually narrowed down from the proximity of the end part of the conducting member 30 toward the end part of the voice coil (width h2) that is connected to the after-mentioned vibration direction converter part. Further, voice coil 40 is formed such that the length of the voice coil 40 in the direction orthogonal to the vibration direction of the voice coil is larger than the length of the voice coil 40 in the vibration direction of the voice coil, and thus a comparatively large driving force or electromagnetic force can be obtained when driving the speaker.

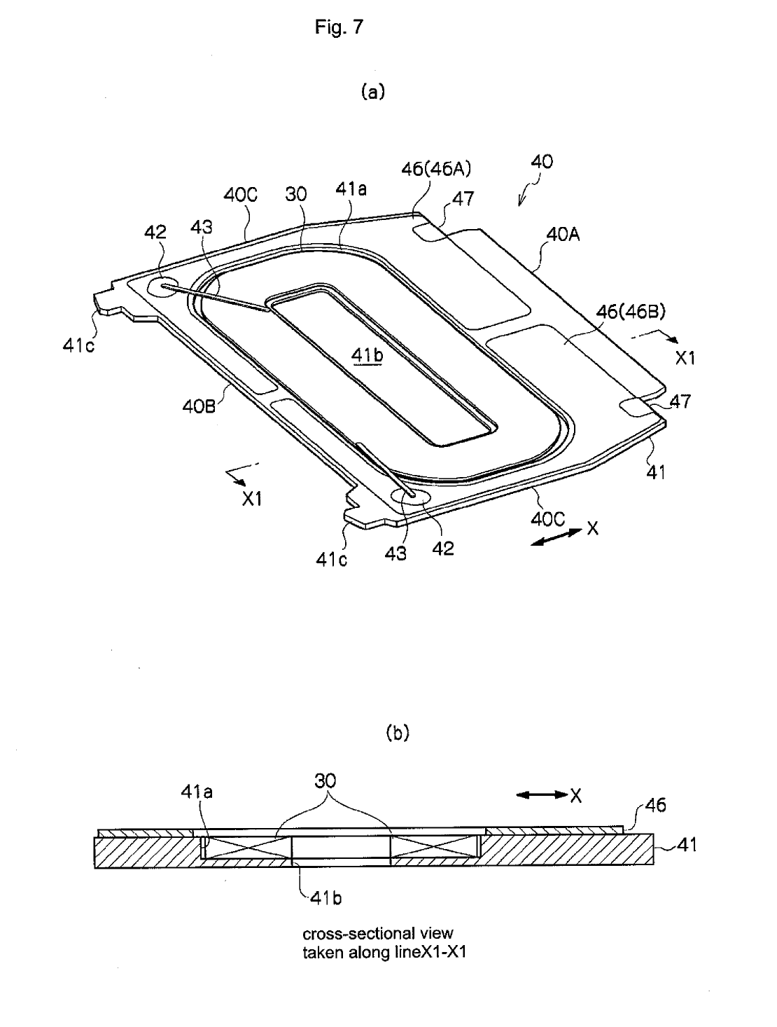

In the voice coil 40 shown in FIG. 7, the conducting member 30 is supported by the base 41. The voice coil attachment portion 41a of the base 41 to which the conducting member 30 is attached is formed in a stepped groove having a recessed shape, and the conducting member 30 is supported by the bottom face of the voice coil attachment portion. Further an opening part 41b is formed in the inner side of the conducting member 30 in the base 41.

The shape of the voice coil 40 in a plane view is formed in an elongated shape that is longer in the direction orthogonal to the vibration direction (X axial direction). According to this shape, rigidity in the vibration direction is further increased, and thereby the vibration of the voice coil 40 can be transmitted to the vibration direction converter part 50 described below with little self-deformation. Further, voice coil 40 is formed such that the length of the voice coil 40 in the direction orthogonal to the vibration direction of the voice coil is larger than the length of the voice coil 40 in the vibration direction of the voice coil, and thus a comparatively large driving force can be obtained when driving the speaker.

A conducting layer 46 is pattern formed at the surface of the base 41 in the outside of the conducting member 30, and a pair of the conducting layers 46 (46A, 46B) is arranged so as to surround the conducting member 30. These conducting layers 46 (46A, 46B) functions as a junction wire inputting the audio signal to the conducting member 30. Each of the conducting layers 46 includes a voice coil connecting terminal 42 connected with the end part of a voice coil lead wire 43, the voice coil lead wire 43 is pulled out of one end part of the winding wire of the conducting member 30, and a connecting terminal 47 for inputting the audio signal to the conducting layer 46.

Further, an end part 40A to which the connecting part described below or vibration direction converter part described below is connected, is formed at one end part of the base 41, and engaging protrusions 41c, 41c to which the holding part described below is connected, is formed at another end of the base 41.

The voice coil 40 is formed such that the width of the outer periphery part 40C is narrowed down between an end part 40B having the engaging protrusions 41c, 41c with which the holding part described below is connected, and the end part 40A with which the connecting part or vibration direction converter part which are described below is connected. Particularly, the width of the outer periphery parts 40C is narrowed down from the end part 40B of the voice coil 40 to the proximity of the end part of the conducting member 30 in the side of the end part 40A of the voice coil 40. As shown in FIGS. 6 and 7, because the voice coil 40 is formed such that the width of the outer periphery parts 40C is narrowed down, flexture of the voice coil 40 is prevented while the vibration of the voice coil 40 can be effectively transmitted to the vibration direction converter part and the diaphragm described below.

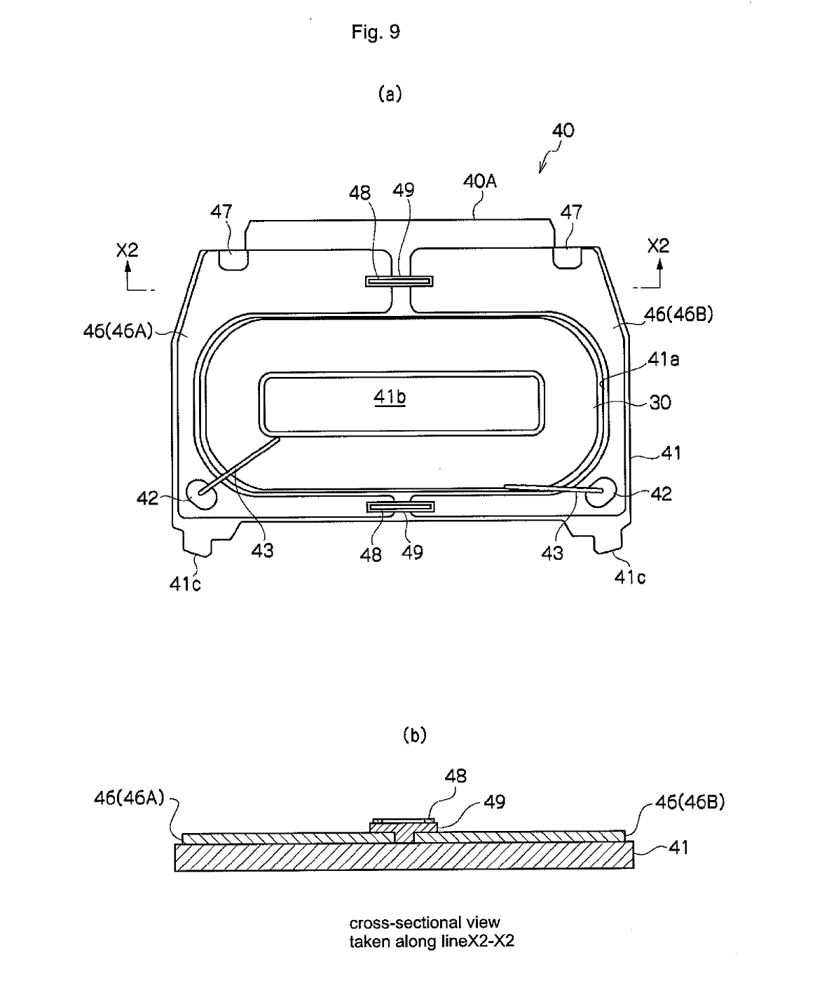

As in the example shown in FIG. 7, the conducting layers 46 is provided so as to surround the conducting member 30 and thereby occurrence of current distortion (harmonic distortion) of currents flowing through the conducting member 30 is prevented (conducting layer has an opened shape). On the other hand, as shown in FIGS. 9 to 13, a short ring layer 48 that is formed with a closed conducting layer is arranged around the conducting member 30, and thereby current distortion can be further considerably prevented (short ring has an opened shape). Further, provided with the conducting layers 46 shown in FIG. 7, also a damping force can be applied to the voice coil 40 in the vibration direction of the voice coil 40. In the example shown in FIG. 7, an insulating layer 49 is formed bridging the end parts of the conducting layers 46, and the short ring layer 48 is formed on the insulating layer 49. The short ring layers 48 are annularly pattern formed in both sides of the conducting member 30 in the vibration direction of the voice coil 40.

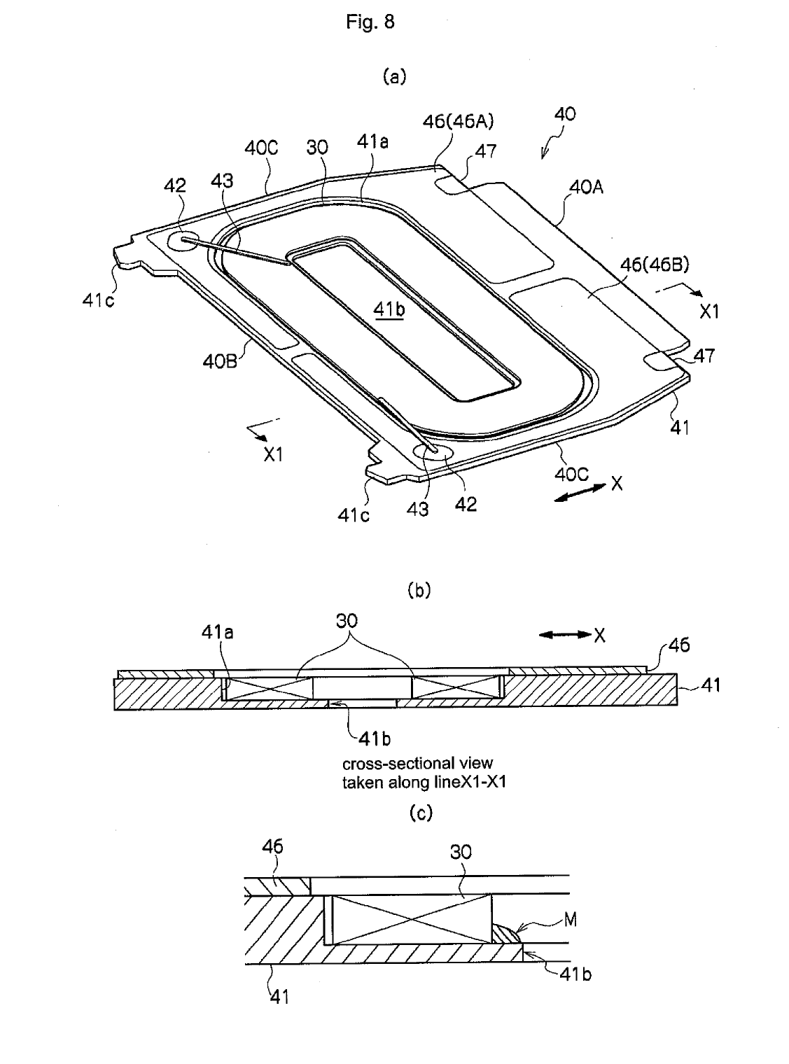

Further as shown in FIGS. 8(a) and 8(b), a placement portion (projection part) projecting toward the inner side of the voice coil 40 is provided in an opening part 41b formed at the base 41. For example, this projection part may be formed by projecting the inner periphery part of the protection film 44 as shown in FIG. 4(b) toward the inner side of the voice coil 40, that is, the opening part 41b, or by projecting the inner periphery part of the base 41 toward the opening part 41b, and can be formed with a member forming the voice coil 40 except the conducting member 30. A part of the voice coil (for example, lead wire) is arranged at this projection part, and adhesive M is applied to connect the conducting member 30 and base 41 including the projection part. Further, the projection part may have rigidity in order to support the conducting member 30. By connecting the conducting member 30 and the base 41 including the projection part with adhesive, etc., the conducting member 30 can be prevented from removing from the base 41 when the voice coil 40 is vibrated, which will enable the speaker device to be driven for long time.

In FIG. 9, the shortring layer 48 is formed such that the width of the short ring layer 48 is smaller than the width of the magnetic gap 20 G or the width of the conducting member 30 in the direction orthogonal to the vibration direction of the voice coil 40.

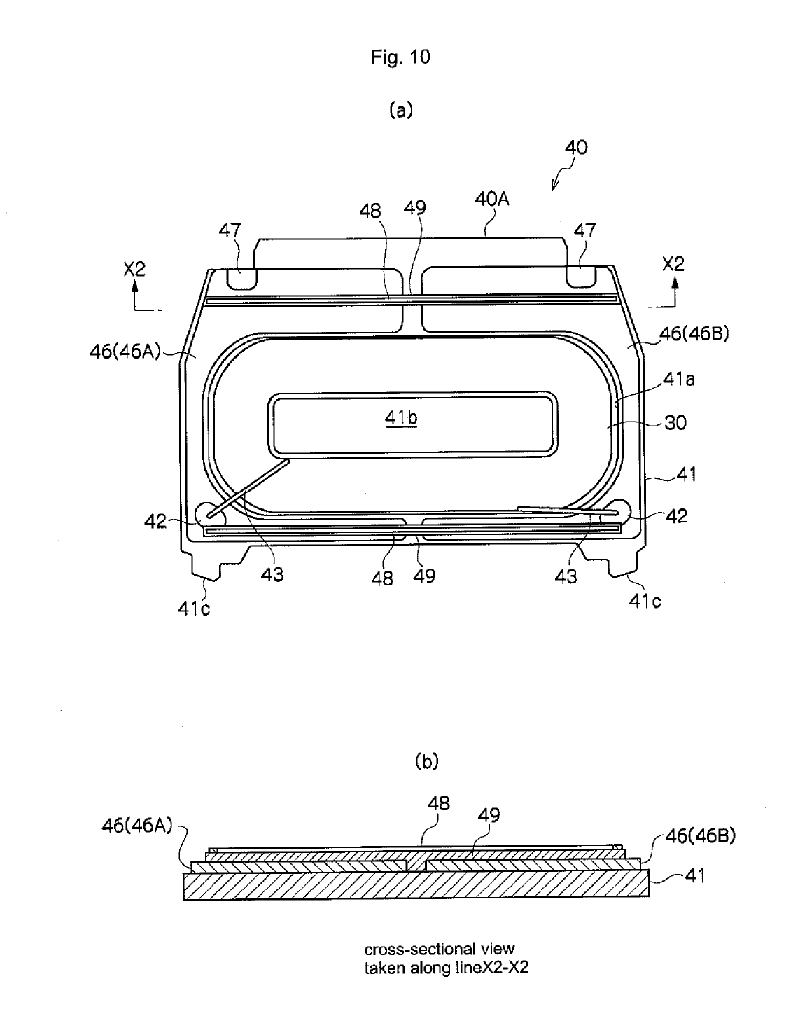

Further, in FIG. 10, the short ring layer 48 is fowled such that the width of the shortring layer 48 is substantially the same as the width of the magnetic gap 20 G or the conducting member 30 in the direction orthogonal to the vibration direction of the voice coil 40.

The short ring layer 48 being formed in a shape as described above, a damping force applied to the voice coil 40 can be adjusted in the vibration direction of the voice coil 40. Also, an excessively large vibration is prevented from being exerted on the voice coil 40. Particularly when the width of the short ring layer 48 is made smaller than the width of the magnetic gap 20G or the conducting member 30, the damping force becomes comparatively small, while the width of the short ring layer 48 is made substantially the same as the width of the magnetic gap 20 G or the conducting member 30, the damping force becomes comparatively large.

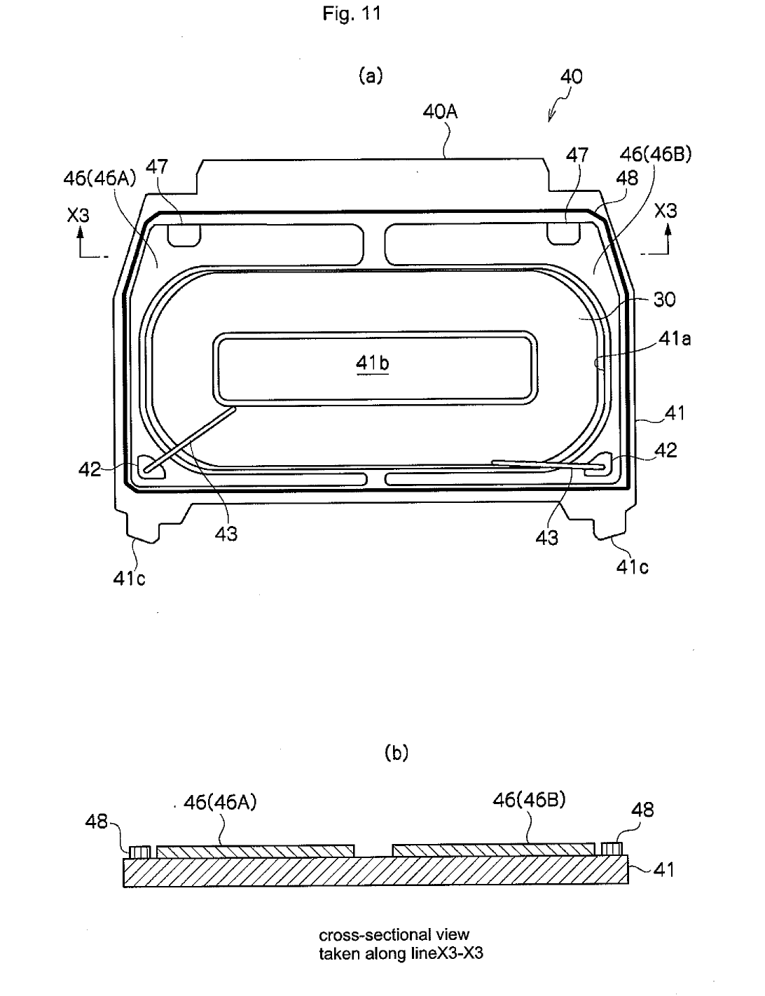

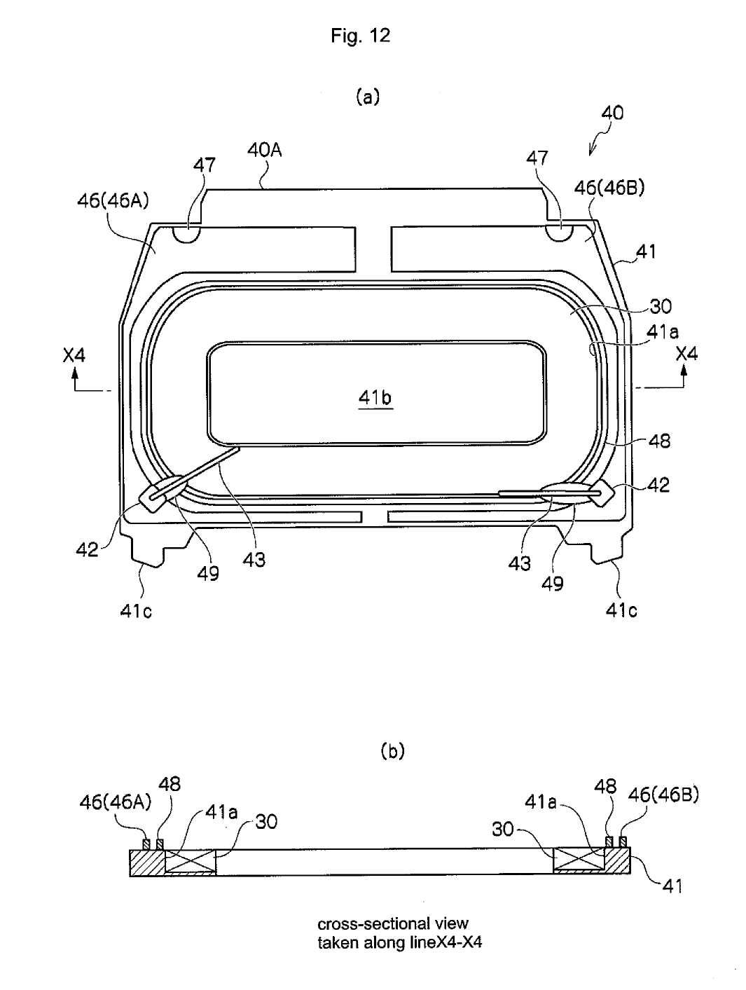

In the example shown in FIG. 11, the short ring layer 48 is annularly pattern formed on the base 41 so as to surround the outer periphery of the conducting layers 46. In the example shown in FIG. 12, the short ring layer 48 is annularly pattern formed on the base 41 at the inner side of the conducting layers 46. Although the short ring layer 48 is arranged in the side of the conducting member 30 at the base 41, the configuration is not limited to the example. The short ring layer 48 may be arranged in the side opposite to the side of the conducting member 30.

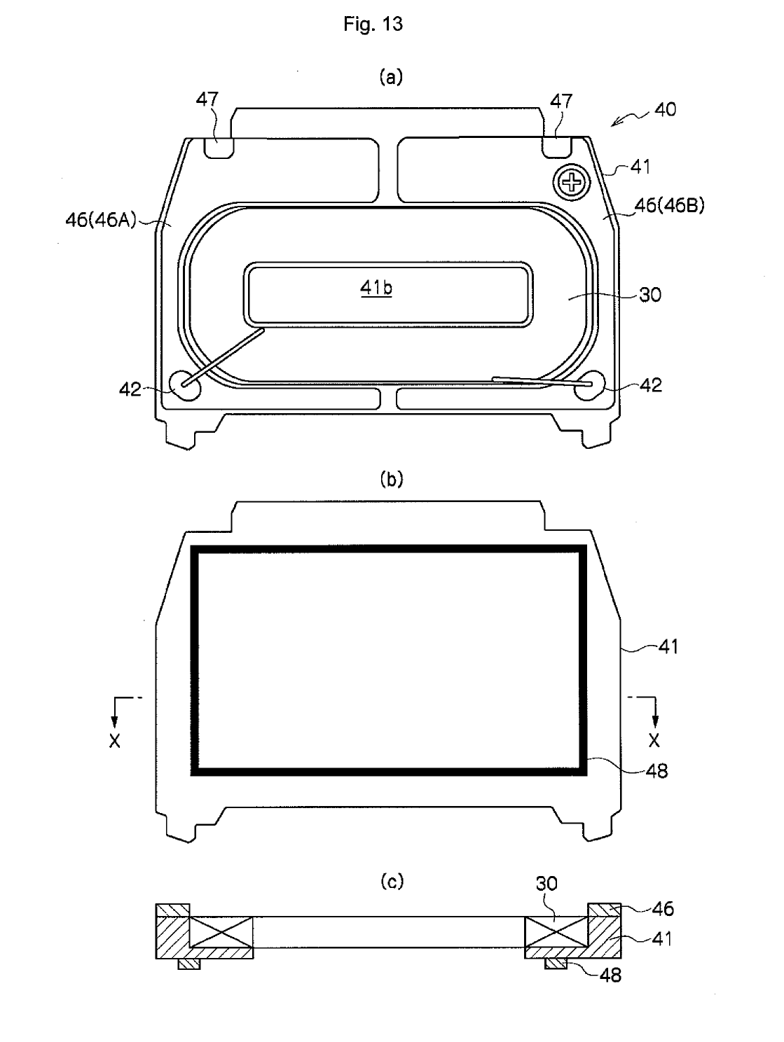

FIG. 13 shows an example in which the short ring layer 48 is arranged in the side opposite to the side of the conducting member 30. FIG. 13(a) is a plan view illustrating the face supporting the conducting member 30 of the voice coil 40, FIG. 13(b) is a back view of the voice coil 40, and FIG. 13(c) is a cross-sectional view taken along line X-X of FIG. 13(b). The short ring layer 48 being formed at the back face of the base 41, the short ring layer 48 can be formed with little limitations of space.

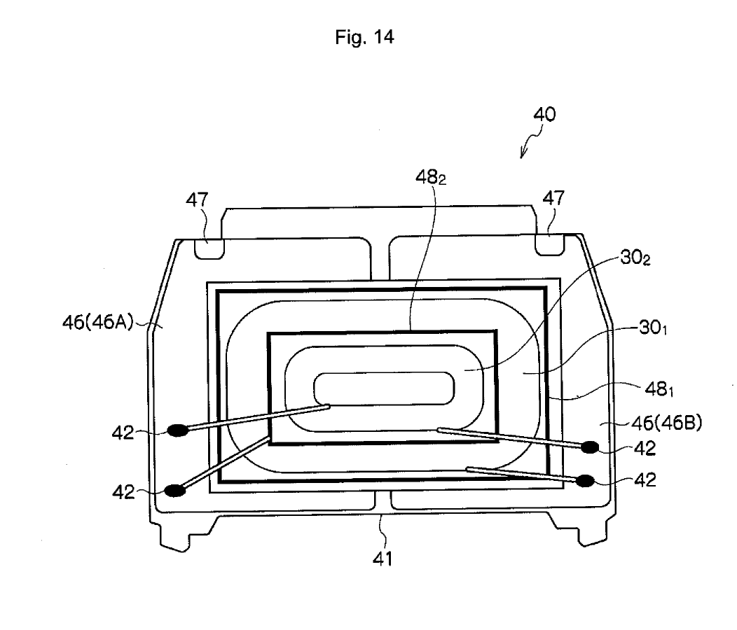

FIG. 14 shows an example in which the conducting member 30 is formed with a plurality of conducting wires. The conducting member is formed with a first conducting member 30₁ and a second conducting member 30₂. And, for example, the first conducting member 30₁ is arranged so as to surround the second conducting member 30₂, the second conducting member 30₁ is arranged on the base 41. In this case, a plurality of conducting layers (short ring layers 48₁, 48₂) may be arranged corresponding to the first conducting member 30₁ and the second conducting member 30₂.

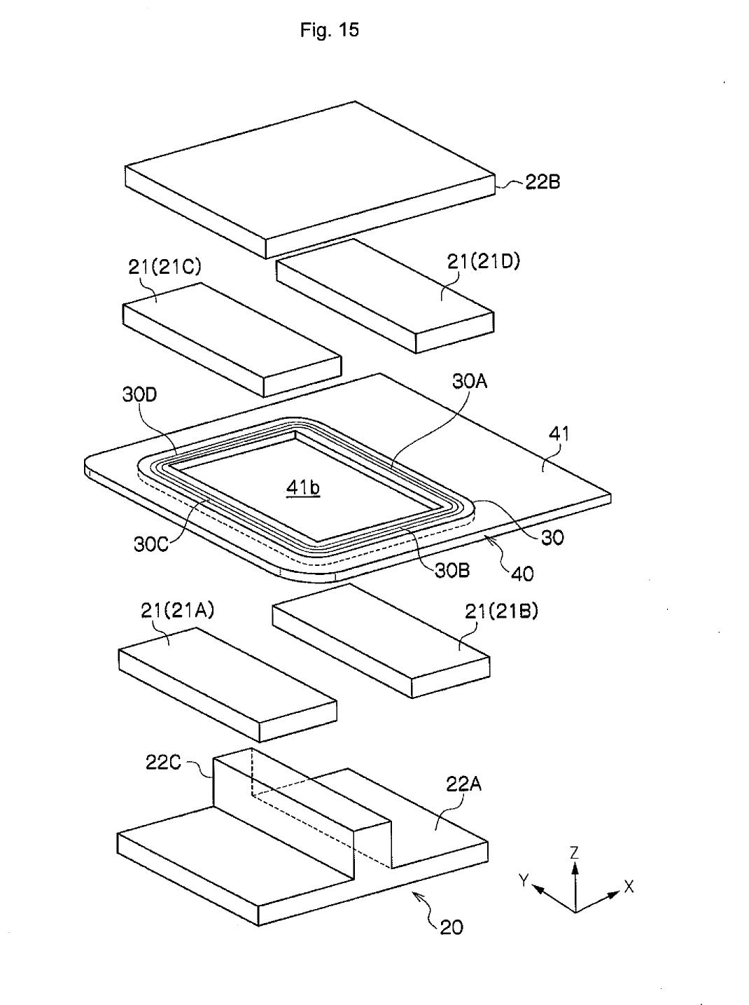

### Voice Coil and Magnetic Circuit; FIGS. 15 to 17

FIGS. 15 to 17 are views illustrating a magnetic circuit vibrating the above-mentioned rigid voice coil 40.

A magnetic circuit 20 for vibrating the voice coil 40 forms a magnetic gap 20 G in the vibration direction of the voice coil 40, which generates a pair of magnetic fields having opposite directions each other in order to apply a Lorentz force in the similar direction as currents flowing through the conducting member 30 that is planarly wound on the voice coil 40. In FIGS. 15 to 17, although a pair of magnetic gaps 20G is formed in the vibration direction of the voice coil 40, the configuration is not limited to described above. A single magnetic gap 20G may be provided in the magnetic circuit 20. Further, in FIGS. 15 to 17, two magnetic pole parts forming two magnetic gaps 20 G arranged in the vibration direction of the voice coil 40 allows the widths of both magnetic gaps 20G to be the similar size with the opposing faces being arranged substantially in parallel.

That is, the magnetic circuit 20 is formed with a magnet 21 and a yoke part 22, and a pair of magnetic gaps 200 (20G1 and 20 G2) having magnetic field directions opposite each other in the Z axial direction are formed side by side at a prescribed interval in the X axial direction. And, the conducting member 30 is wound such that currents flowing through these magnetic gaps 20 G (20G1, 20G2) are opposite each other in the Y axial direction, and thereby a Lorentz force is exerted on the conducting member 30 in the X axial direction. In the example shown in the drawing, the conducting member 30 of the voice coil 40 includes a pair of linear portions 30A and 30C, and the conducting member 30 is arranged so as to itinerate in the pair of the magnetic gap 20G1 and 20G2 such that currents flow in the opposite directions through the linear portions 30A and 30 C in the pair of magnetic gaps 20G1 and 20G2.

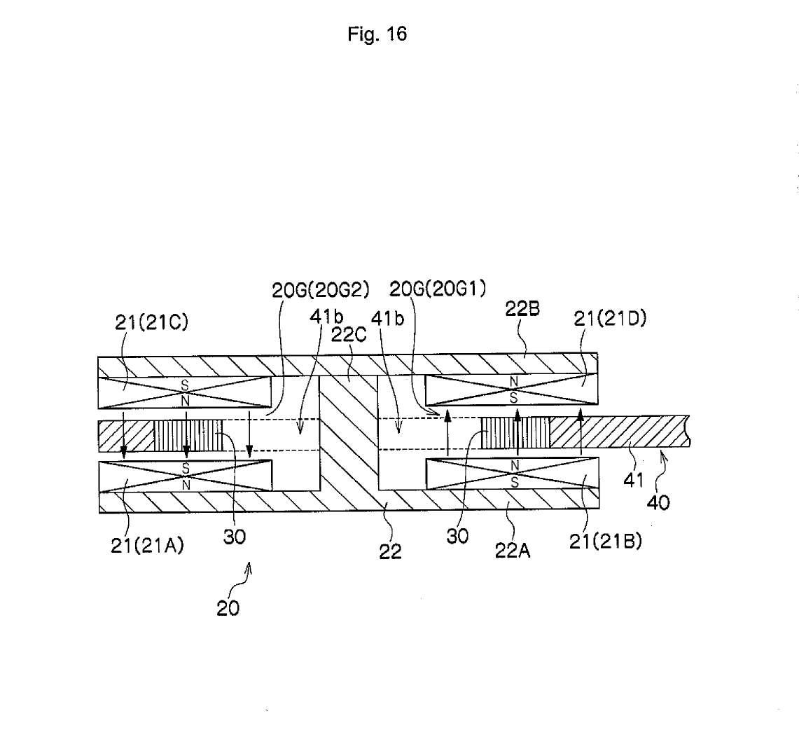

By changing arrangement of the magnet 21 and the yoke part 22, a various forms of magnetic circuits 20 can be formed. In an example shown in FIGS. 15 and 16, the magnetic circuit 20 includes a plurality of the magnets 21 (21A to 21D). In this magnetic circuit 20, the magnets 21 are provided at both sides of the magnetic gap 20G in the direction of magnetic field.

In the example shown in the drawing, the yoke part 22 includes a lower yoke part 22A, an upper yoke part 22B, and a pole part 22C. The yoke part 22A and the yoke part 22B are arranged substantially in parallel at a prescribed interval, and the pole part 22C is formed at a central part of the yoke part 22 such that the pole part 22C extends substantially in the direction orthogonal to the yoke part 22A and the yoke part 22B.

The magnets 21A to 21D are arranged on the yoke parts 22A and 22B. One magnetic gap 20G2 is formed by the magnets 21A and 21C while another magnetic gap 20G1 is formed by the magnets 21B and 21D. This pair of magnet gaps 20G1 and 20G2 is planarly formed side by side such that magnetic fields having opposite directions to each other are generated.

On the other hand, the conducting member 30 is formed in a rectangular shape in a planar view, and is formed with linear portions 30A and 30C formed in the Y axial direction and linear portions 30B and 30D formed in the X axial direction. The linear portions 30A and 30C of the conducting member 30 are arranged in the magnetic gap 20G of the magnetic circuit 20 so as to generate a magnetic field in the Z axial direction. No magnetic field may be applied to the linear portions 30B and 30D of the conducting member 30. Also, even when a magnetic field is applied to the linear portions 30B and 30D, the Lorentz forces generated in the linear portions 30B and 30D are configured to cancel each other out. It is possible to make comparatively large a portion of the conducting member in the magnetic gap 20G by comparatively increasing the winding number in the conducting member 30 and thereby a comparatively large driving force is obtained when driving the speaker.

In the example of the magnetic circuit 20 shown in FIG. 16, the magnet 21A and the magnet 21C are magnetized in the similar direction and the magnet 21B and the magnet 21D are magnetized in the similar direction opposite to the magnets 21A and 21C with respect to a plurality of magnets 21A to 21D such that the direction of a magnetic field applied to the linear portion 30 A of the conducting member 30 is opposite to the direction of a magnetic field applied to the linear portion 30C. Magnetization of the magnet 21 can be performed after the magnet 21 and the yoke part 22 are attached; however, in the example shown in FIGS. 15 and 16, the process of the magnetization is required to be applied two times.

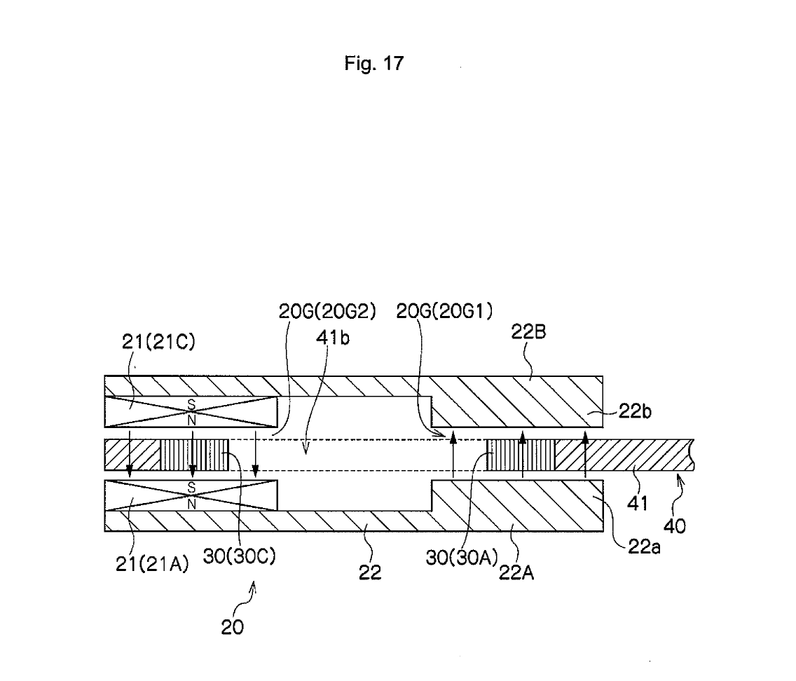

In contrast, in the example shown in FIG. 17, the magnetic gap 20G2 is formed with the magnets 21A and 21C that are magnetized in the similar direction, and the magnetic gap 20G1 is formed between yoke projecting parts 22a and 22b that are formed at each of the yoke parts 22A and 22B. According to this configuration, the time of magnetization process performed after attaching the magnet 21 to the yoke part 22 can be one time, thus the process can be simplified. Although not shown in the drawings, the magnetic circuit 20 may be configured such that both magnetic gaps 20G1 and 20G2 are constructed with the magnet and the yoke projecting part, or one of the magnetic gaps 20G1 and 20G2 is constructed with the magnet and the yoke part and another is constructed with two magnets or two yoke parts.

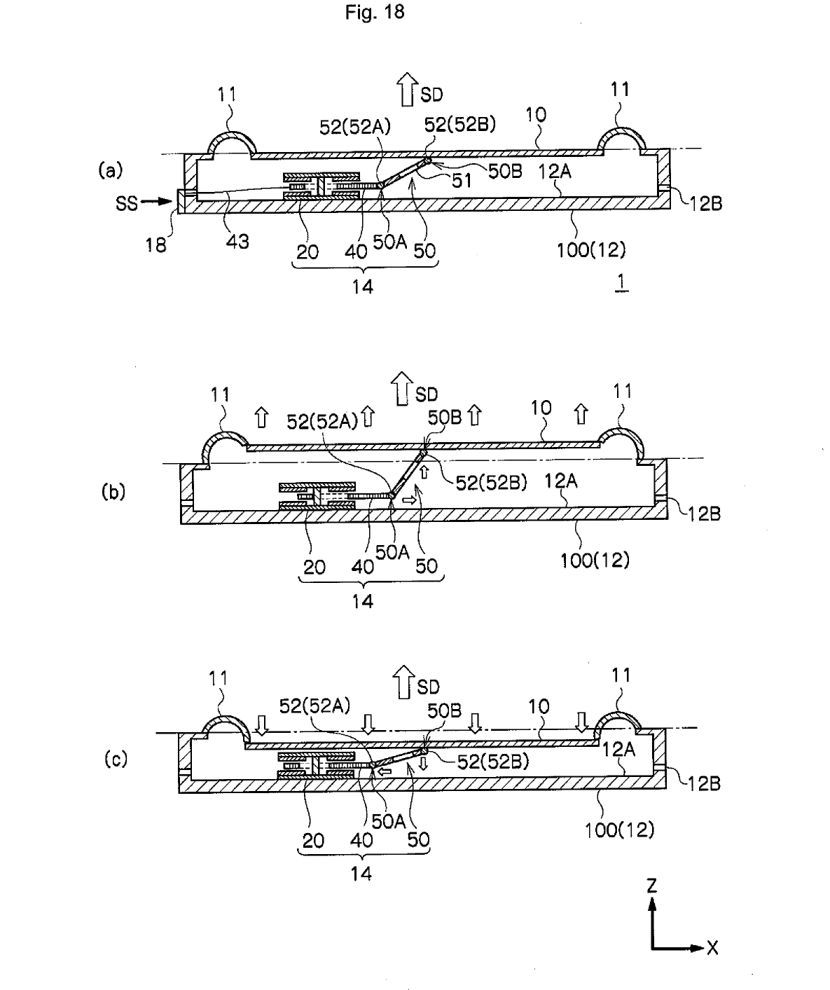

### Whole Configuration of Speaker Device: FIGS. 18 to 20

FIGS. 18 to 20 are views illustrating a whole configuration of the speaker device including the voice coil according to an embodiment of the present invention. A speaker devices 1, 1A, 1B, 1C, and 1D include a driving part 14 having the voice coil 40 and the magnetic circuit 20 vibrating the voice coil 40, a diaphragm 10 to which vibration from the driving part 14 is transmitted in response to the audio signal, and a static part 100 supporting the driving part 14 and the diaphragm 10. The static part 100 is a collective term of component supporting vibration of the diaphragm 10 and the driving part 14, etc. The static part 100 is a frame 12, a yoke part functioning as the frame 12 as referred to below, or an attachment unit, etc. The static part 100 may not be completely static in itself. The whole part may vibrate affected by vibration of the driving part 14 or by other forces. The outer periphery part of the diaphragm 10 is supported by the frame 12 as the static part 100 via an edge 11. A vent hole 12B is provided at the frame 12 as necessary. The driving part 14 includes a vibration direction converter part 50 that angle converts the vibration of the voice coil 40 and transmit the vibration to the diaphragm 10, the vibration direction converter part 50 includes a rigid link part 51 that is disposed slantwise with respect to each of the vibration direction of the diaphragm 10 and the vibration direction of the voice coil 40.

As shown in the drawing, the diaphragm 10 is supported by the frame 12 vibratably in the vibration direction (Z axial direction). The diaphragm 10 emits a sound wave in the sound emission direction (SD) when driving the speaker. Further, the diaphragm 10 is supported by the frame 12 via the edge 11, and the movement of the diaphragm in other direction than the vibration direction of the diaphragm, specifically, in the X axial direction or the Y axial direction is restricted by the edge 11. The edge 11 and the diaphragm 10 may be integrally formed.

For example, the diaphragm 10 may be formed with resin-system material, metal material, paper material, fiber-system material, ceramic material, compound material, etc. For example, the diaphragm 10 may have rigidity. The diaphragm 10 may be formed in a prescribed shape such as a tabular shape, a dome shape, a cone shape, etc. In the example shown in the drawing, the diaphragm 10 is formed in a tabular shape, and is supported along the planar bottom part 12A of the frame 12. The diaphragm 10 formed in a tabular shape is useful according to the embodiment of the present invention, because one of the aspects of the present invention is to realize a thin speaker device. Also, the diaphragm 10 may be formed in a prescribed shape such as a rectangular, elliptical, circular, or polygonal shape viewed from the sound emission direction (planar shape). Alternatively, the diaphragm 10 may be formed in a honeycomb structure.

Further, a protrusion part may be provided at the front surface (surface of a sound emission side) or the back surface (surface of the opposite side of the sound emission side) as necessary. The protrusion part has a function to increase rigidity of the diaphragm 10. The protrusion part may be formed in a linear shape or in a annular shape or in a lattice shape with respect to the surface of the diaphragm 10, and it can be modified as necessary, for example, a plurality of linear protrusion parts may be provided at the surface of the diaphragm.

The diaphragm 10 is vibratably supported by the frame 12. When the space surrounded by the diaphragm 10 and the frame 12 on the rear side of the diaphragm 10 (opposite to the sound emission direction) is sealed against the sound emission direction, it is possible to prevent the sound wave emitted from the rear side of the diaphragm 10 from being emitted toward the sound emitting direction.

The edge 11 is arranged between the diaphragm 10 and the frame 12, and the inner periphery part of the edge 11 supports the outer periphery part of the diaphragm 10 while the edge 11 holds the diaphragm 10 in a prescribed position by the outer periphery part of the edge 11 being connected to the frame 12. Specifically, the edge 11 supports the diaphragm 10 vibratably in the vibration direction (Z axial direction) and restrains vibration in the direction orthogonal to the vibration direction. The edge 11 shown in the drawing is formed in a ring shape (annular shape) as viewed from the sound emission direction, and the cross-sectional shape is formed in a prescribed shape, for example, a projecting shape, a recessed shape, a corrugated shape, etc. The edge 11 may be formed in a projecting shape or in a recessed shape in the sound emission direction. For example, the edge 11 may be formed with leather, cloth, rubber, resin, each of which is sealed with filler, a member formed in a prescribed shape with rubber, resin, or the like.

A driving part 14 includes the above-mentioned magnetic circuit 20, the voice coil 40 and the vibration direction converter part 50. When the audio signal SS is inputted to the voice coil 40 from an audio signal input terminal 18 via a voice coil lead wire 43, a Lorentz force is applied to the voice coil 40 in the magnetic gap 20G described above in the X axial direction, and thus the voice coil 40 vibrates in the X axial direction.

The frame 12 vibratably supports the diaphragm 10 in the vibration direction and supports the driving part 14 therein. The frame 12 supports a part of the link body of the vibration direction converter part 50 and applies a reaction force from the frame 12 to action of the link body. The above-mentioned frame 12 may include a planarly shaped bottom part 12A. Also, the frame 12 is the static part 100 arranged in a static state with respect to the voice coil 40. The static part 100 does not intend to be completely static, for example, it may be static enough to support the diaphragm 10. Vibration generated when driving the speaker devices 1 to 1D may be transmitted to the static part 100, thereby causing vibration in the overall static part 100. Here, the static part 100 includes a part of the magnetic circuit 20, an attachment counterportion to which the speaker devices 1 to 1D are attached, etc. other than frame 12. Further, because the static part 100 may be arranged mechanically integrally with the magnetic circuit 20 and the frame 12 can be said to be supported by the magnetic circuit 20, thus the frame 12 may be the static part 100. Accordingly, for example, a component member configuring the magnetic circuit 20 (for example, the after-mentioned yoke part 22), or a member supported by the magnetic circuit 20 can be the static part 100.

The vibration direction converter part 50 direction-converts the vibration of the voice coil 40 and transmits the vibration to the diaphragm 10. The vibration direction converter part 50 includes a rigid link part 51, angle converts the rigid link part 51 disposed slantwise with respect to the vibration direction of the diaphragm 10 and the vibration direction of the voice coil 40 respectively, and thus direction-converts the vibration of the voice coil 40 and transmits the vibration to the diaphragm 10.

In the speaker device 1 according to an embodiment shown in FIG. 18, the vibration direction converter part 50 is formed with a single link part 51, and an end part 50A in the side of the voice coil 40 of the vibration direction converter part 50 is formed with a joint part 52 (52A). An end part 50B in the side of the diaphragm 10 of the vibration direction converter part 50 is formed with a joint part 52 (52B) connecting the link part 51 to the diaphragm 10. FIG. 18(a) shows an initial state and FIGS. 18(b), 18(c) show states when driving the speaker.

As shown in FIGS. 18(b), 18(c), the joint part 52 rotatably connects the link part 51 to a connection counterpart and the joint part 52A in the side of the voice coil 40 moves in the X axial direction along the moving direction of the voice coil 40 in response to the vibration of the voice coil 40, and the joint part 52B in the side of the diaphragm 10 moves in the vibration direction of the diaphragm 10 (for example, Z axial direction). Thus, the vibration in the X axial direction of the voice coil 40 is direction-converted, causing the diaphragm 10 to vibrate in a direction (for example, Z axial direction) different from the X axial direction.

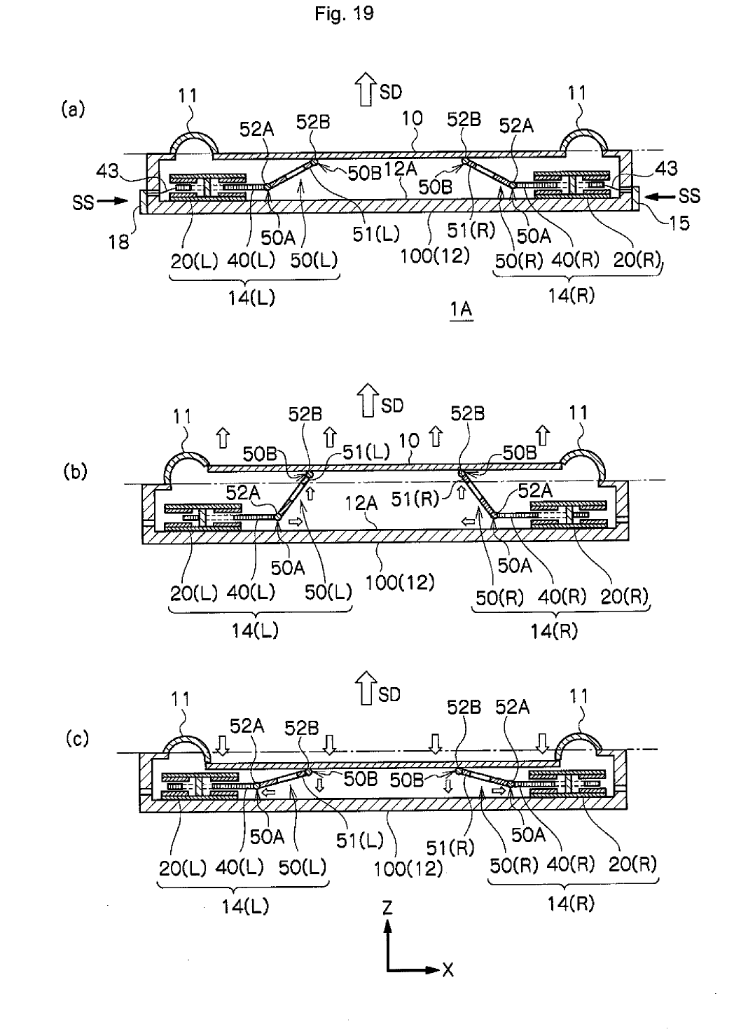

The speaker device 1A according to an embodiment shown in FIG. 19 is formed with the driving parts 14 shown in FIG. 18 symmetrically arranged opposite to each other, including driving parts 14(R) and 14(L). Each of the driving parts 14(R), 14(L) is provided with a link part 51(R) or 51(L), a voice coil 40(R) or 40(L) and a magnetic circuit 20(R) or 20(L). FIG. 19(a) shows an initial state and FIGS. 19(b), 19(c) show states when driving the speaker.

As such, with the directions of the vibrations of the voice coils 40(R), 40(L) oppositely synchronized, the two driving forces of the driving parts 14(R), 14(L) can be combined, driving the diaphragm 10 as shown in FIG. 19(b), 19(c). Further, with a plurality of the joint parts 52B provided in the side of the diaphragm 10 provided, the number of supporting points of the diaphragm 10 is increased, thus a phase of vibration of the diaphragm 10 can be synchronized.

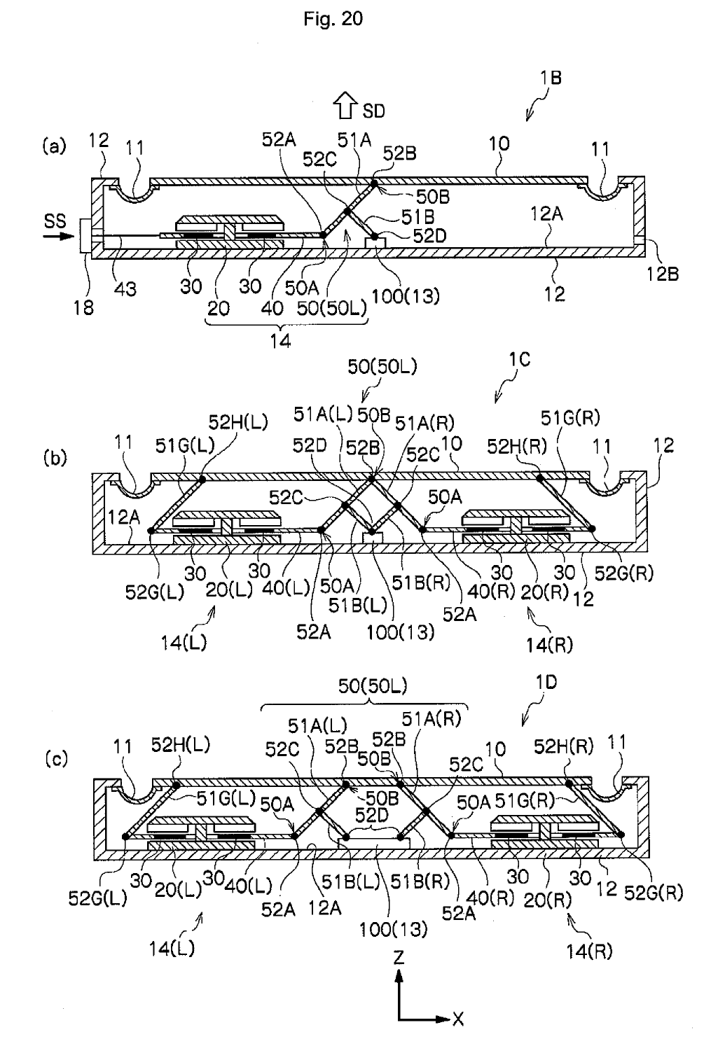

In the speaker devices 1B, 1C, 1D according to embodiment shown in FIG. 20, the vibration direction converter part 50 is formed with a link body 50L including a rigid first link part 51A and a second link part 51B. The end part 50A of the vibration direction converter part 50 in the side of the voice coil 40 is connected to the voice coil 40 at a joint part 52A, and the end part 50B of the vibration direction converter part 50 in the side of the diaphragm 10 is formed with the joint part 52B connecting the first link part 51A to the diaphragm 10. The first link part 51A and the second link part 51B are obliquely arranged in a different direction with respect to the vibration direction of the voice coil 40, and one end part of the second link part 51B is connected to a joint part 52C in the middle part of the first link part 51A and another end of the second link part 51B is connected to the static part 100 at a joint part 52D. Note that the static part 100 is provided in the opposite side of the diaphragm 10 with respect to the vibration direction converter part 50. In the example shown in the drawing, the static part 100 is a support base 13 formed on the bottom part 12A of the frame 12.

Further, the frame 12 includes a planar bottom part 12A, the diaphragm 10 is planarly supported along the bottom part 12A of the frame 12, a magnetic gap 20G of the magnetic circuit 20 is formed along the bottom part 12A of the frame 12, the static part 100 is formed with the bottom part 12A of the frame 12, thus the vibration direction converter part 50 vibrates the diaphragm 10 in a direction intersecting the bottom part 12A.

The joint parts 52A, 52B, 52C and 52D rotatably connects the first link part 51A, the second link part 51B and a connection counterpart, and the joint part 52A in the side of the voice coil 40 moves in the X axial direction along moving direction of the voice coil 40, the joint part 52D connected to the support base 13 being the static part 100 is in a fixed state, and movement of the joint part 52A in response to a reaction force receiving from the support base 13 of the static part 100 converts angle between the first link part 51A and the second link part 51B, causing the joint part 52B in the side of the diaphragm 10 to move in the vibration direction of the diaphragm 10 (for example, Z axial direction).

In the speaker device 1B according to an embodiment shown in FIG. 20(a), a single driving part 14 vibrates the diaphragm 10. In the speaker devices 1C, 1D according to embodiments shown in FIGS. 20(b), 20(c), the driving parts 14 are symmetrically arranged opposite to each other and auxiliary link parts 51G(R), 51G(L) forming parallel links with the first link parts 51A(R), A(L) are connected to the outside end parts of each of the voice coils 40(R), 40(L). The auxiliary link parts 51G(R), 51G(L) are connected to the outside end parts of the voice coils 40 (R), 40 (L) at joint parts 52G(R), 52G(L) and connected to the diaphragm 10 at joint parts 52H(R), 52H(L). Each of the driving parts 14(R), 14(L) is provided with a link body 50 L, the voice coils 40 (R), 40 (L) and the magnetic circuits 20 (R), 20 (L). In the speaker device 1C shown in FIG. 20(b), a first link part 51A (R), (L) and a second link part 51B (R), (L) have common joint parts 52B, 52D, and in the speaker device 1D shown in FIG. 20(c), a first link parts 51A (R), (L) and a second link parts 51B (R), (L) have joint parts 52B, 52D spaced apart. Further, the auxiliary link parts 51G(R), 51G(L) may be removed as necessary.

With this configuration, with the directions of the vibrations of the voice coils 40 (R), 40 (L) oppositely synchronized, the driving forces of the two driving parts 14 (R), 14 (L) can be combined, vibrating the diaphragm 10. Further, with a plurality of the joint parts 52B, 51G provided in the side of the diaphragm 10, the number of supporting points of the diaphragm 10 is increased, thus a phase of vibration of the diaphragm 10 can be synchronized, in other words, the diaphragm 10 can be vibrated substantially in the same phase. Further, for example, when the voice coils 40 (R), 40 (L) vibrate in a horizontal direction, occurring of a vibration of the diaphragm in the horizontal direction can be prevented.

In the speaker devices 1 to 1D according to embodiments of the present invention described above, when an audio signal SS is inputted, the voice coil 40 vibrates along the magnetic gap 20G formed in a direction different from the allowable vibration direction of the diaphragm 10. This vibration is direction-converted by the vibration direction converter part 50 and is transmitted to the diaphragm 10, causing the diaphragm 10 to vibrate, and thus a sound corresponding to the audio signal SS is emitted in the sound emission direction (SD).

During this process, the direction of the magnetic gap 20G intersects with the vibration direction of the diaphragm 10 and the thickness directions of the speaker devices 1 to 1D, and thus increasing the driving force of the magnetic circuit 20 or the vibration stroke of the voice coil 40 has little effect directly on the size in the thickness direction (Z axial direction) of the speaker devices 1 to 1D. Thus, the speaker devices 1 to 1D can be made thin while pursuing a loud sound.

Also, the vibration direction converter part 50 converts the direction of the vibration of the voice coil 40 and transmits the vibration to the diaphragm 10 by using a mechanical link body, and therefore efficiency of vibration transmission is high. In particular, in the speaker devices 1B to 1D according to embodiments shown in FIG. 20, the first link part 51A and the second link part 51B are angle converted by the vibration of the voice coil 40 and the reaction force from the support base 13 being the static part 100, and thus the vibration of the voice coil 40 can be more securely transmitted to the diaphragm 10. With this configuration, a useful reproduction efficiency of the speaker devices 1B to 1D can be obtained.

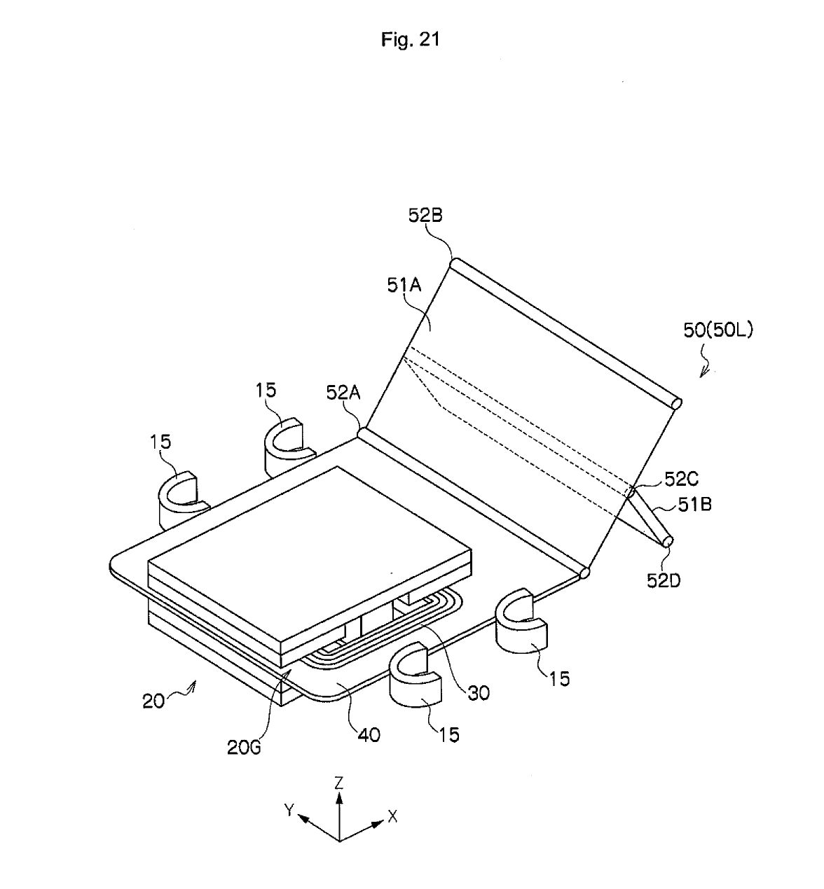

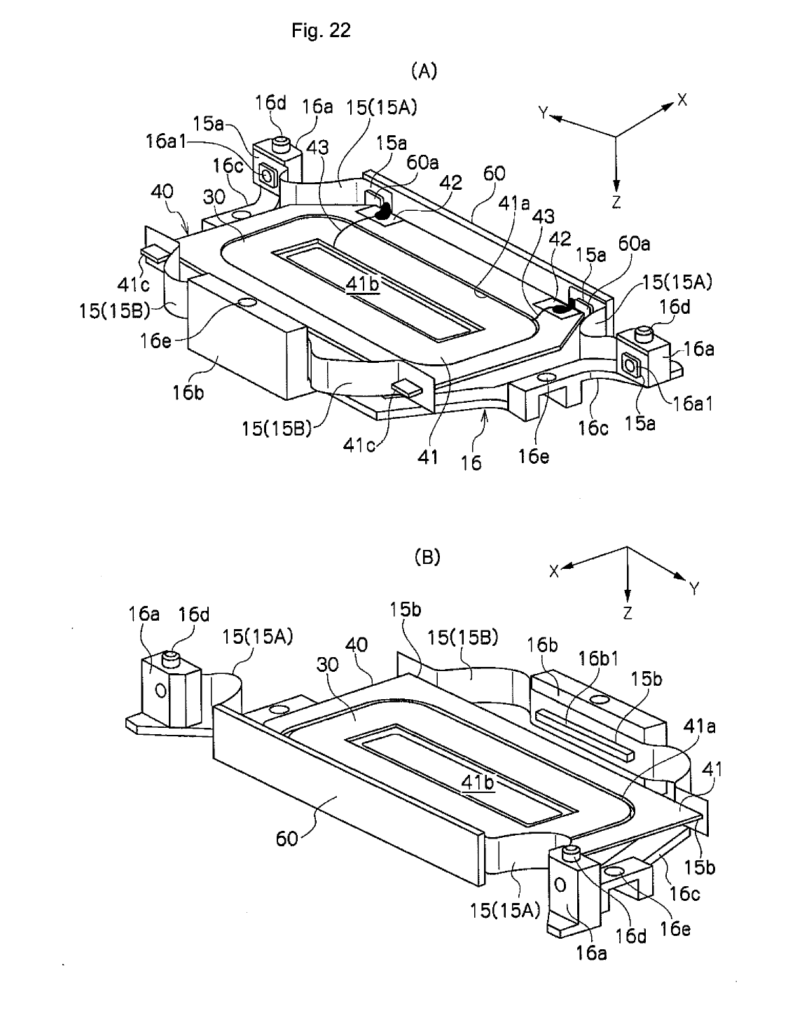

### Holding Part and Attachment Unit: FIGS. 21, 22

FIGS. 21 and 22 are views illustrating a body holding the voice coil according to an embodiment of the present invention to the frame being the static part. The voice coil 40 according to an embodiment of the present invention is held with a holding part 15 to the frame 12 being the static part 100 directly or via other members.

The holding part 15 holds the voice coil 40 in the prescribed position in the magnetic gap 20G such that the voice coil 40 does not contact the magnetic circuit 20 and movably hold the voice coil 40 to the frame 12 directly or via other member such that the voice coil 40 linearly vibrates in the X axial direction. The holding part 15 regulates the voice coil 40, preventing the voice coil 40 from moving in a direction (for example, Z axial direction or Y axial direction) different from the vibration direction of the voice coil.

For example, the holding part 15 shown in FIG. 21 is formed in a plate shape and has flexibility. The cross-sectional shape of the holding part 15 is formed in a curved shape and has a bendable shape. Further, the holding part 15 has the prescribed thickness in the Z axial direction (larger than the thickness in the X axial direction), and is formed in a shape having rigidity particularly in the Z axial direction. The holding part 15 may be formed in a various shape, for example, cross-sectionally formed in a projecting shape, a recessed shape, a corrugated shape, etc., having the uniform, non-uniform thickness, etc. The holding part 15 includes one end part connected to the voice coil 40 and another end part connected to the frame 12. The holding part 15 is not limited to this embodiment but, for example, one end part of the holding part 15 may be connected to the voice coil 40 and another end part of the holding part 15 may be connected to the magnetic circuit 20.

FIG. 22 is a view illustrating an example of holding the voice coil to the frame via an attachment unit (FIG. 22(a) is a perspective view viewed from a middle part direction between the X axial direction and the Y axial direction and FIG. 22(b) is a perspective view viewed from the opposite direction). Here, the voice coil 40 is connected to the vibration direction converter part 50 via a connecting part 60, and the connecting part 60 is held to the frame via the attachment unit 16.

The connecting part 60 is attached to one end part of the voice coil 40 in the vibration direction of the voice coil so that the connecting part 60 extends along the width of the voice coil 40. In the voice coil 40, the voice coil attachment portion 41a is formed in the tabular base 41 as described above, and the conducting member 30 is attached to the voice coil attachment portion 41a. An opening part 41b is formed inside the conducting member 30 of the voice coil 40, thus decreasing a weight of the voice coil 40.

The voice coil 40 and the connecting part 60 are held to the frame 12 with the holding part 15 via the attachment unit 16. In this example, the holding part 15 has a structure so as to regulate movement of the voice coil 40 in other directions, allowing the movement in the X axial direction. More specifically, a projecting shaped curved portion in the X axial direction is formed with a plate member having the thickness in the Z axial direction, thus regulates deformation in other directions, allowing the deformation of the curved portion in the bending and extending direction.

In the example shown in FIG. 22, one end part of the holding part 15 is connected to the voice coil 40 or the connecting part 60 and another end of the holding part 15 is connected to the attachment unit 16. Alternatively, the middle part of the holding part 15 is connected to the voice coil 40 or the connecting part 60 and both end parts are connected to the attachment unit 16.

The holding part 15 includes a first holding part 15A and a second holding part 15B, and the first holding part 15A and the second holding part 15B hold the voice coil 40 to the frame 12 via the attachment unit 16. The first holding part 15A holds the connecting part 60 to the attachment unit 16, and the inside end parts of the first holding parts 15A provided at both sides are connected to both outside end parts of the connecting part 60, and the outside end part of each of the first holding parts 15A is connected to the attachment unit 16 respectively. More specifically, engage protrusions 60a, 60a are formed at both outside end parts of the connecting part 60, and engaging holes 15a, 15a engaging with the engage protrusions 60a, 60a are formed at the inside end parts of the first holding parts 15A. In the attachment unit 16, first connecting parts 16a, 16a are formed at both sides of the connecting part 60, and engaging holes 15a engaging with engage protrusions 16a1, 16a1 of the first connecting part 16a, 16a are formed at the outside end parts of the first holding parts 15A.

In the example shown in the drawings, a central part of the second holding part 15B is connected to a second connecting part 16b of the attachment unit 16, and both end parts are connected to both ends of the voice coil 40. The second connecting part 16b includes an engage protrusion 16b1, and an engaging hole 15b of the second holding part 15B engages with the engage protrusion 16b1. Engage protrusions 41c, 41c are formed at both left and right ends of the voice coil 40 and engaging holes 15b formed at both end parts of the second holding part 15B engage with the engage protrusions 41c, 41c. In this example, the second holding part 15B is arranged within the width of the voice coil 40, such that a holding body of the voice coil 40 takes up little space in the width direction of the voice coil 40. If space is large enough, the second connecting parts 16b are arranged at left side and right side as are the first connecting parts 16a, and thus left end part and right end part of the voice coil 40 may be connected to the left and right second connecting parts 16b respectively via the second holding part 15B.

In the attachment unit 16, the first connecting parts 16a to which the end parts of the first holding parts 15A are connected, are provided at both sides of the connecting part 60, and the second connecting part 16b to which the second holding part 15B is connected, is provided at the back of the voice coil 40, and the attachment unit 16 includes a unitized supporting part 16c supporting the first connecting part 16a and the second connecting part 16b integrally. Further, the attachment unit 16 includes an attachment locking part 16d and an attachment locking hole 16e attaching the attachment unit 16 to the frame 12. The voice coil 40, the connecting part 60, the holding parts 15 (the first holding part 15A and the second holding part 15B) and the attachment unit 16 are unitized so as to be incorporated to the frame 12 with one process of attachment.

Further, in the above embodiment, the first connecting part 16a of the attachment unit 16 functions as an audio signal input terminal, such that an audio signal may be supplied to the conducting member 30 via the first holding part 15A. In this case, a signal line is provided along the first holding part 15A, the first holding part 15A is configured as a flexible wiring board, or the first holding part 15A is formed with a conducting property material, making a signal line in itself. Then, a voice coil lead wire 43 from the conducting member 30 is formed on the base 41 having insulating property, and an edge part of the voice coil lead wire 43 is electrically connected to a voice coil connecting terminal 42, and the voice coil connecting terminal 42 is electrically connected to the end part of the first holding part 15A in the side of the voice coil. The end part of the first holding part 15A in the side of the frame is electrically connected to the first connecting part 16a functioning as an audio signal input as well.

With the input wiring path of an audio signal as described above, wiring space of an input signal line can be saved, thereby space efficiency can be increased in a device. Further, a signal line moves little even when the voice coil 40 vibrates, making little abnormal noise caused by the signal line contacting each part in the device.

### Vibration Direction Converter Part: FIGS. 18 to 20 and FIGS. 23 to 26

In the speaker device 1, 1A shown in FIG. 18 and FIG. 19, the vibration direction converter part 50 is formed with a single link part 51 and the joint parts 52A, 52B, and the link part 51 is angle varied such that the vibration of the voice coil 40 in the X axial direction is converted to the vibration of the diaphragm 10 in a direction (for example the Z axial direction) other than the X axial direction. In the vibration direction converter part 50 of the speaker devices 1B, 1C, 1D shown in FIG. 20, the link body 50L is formed with the first link part 51A, the second link part 51B, joint parts 52A, 52B, 52C and 52D. In this example, the joint part 52D between the second link part 51B and the support base 13 as the static part 100 is a joint part not displacing the position, and other joint parts 52A, 52B and 52C are joint parts displacing the positions. With this configuration, the whole link body 50L is configured to receive a reaction force from the static part 100 at the joint part 52D. In the link body 50L, as the joint part 52A moves in the X axial direction in response to the vibration of the voice coil 40, the joint part 52B moves in the Z axial direction, and thus the vibration of the voice coil 40 is direction-converted and is transmitted to the diaphragm 10.

The vibration direction converter part 50 according to an embodiment of the present invention can be formed with plate shaped members having linear bending parts, and the bending parts can be the joint parts of the above-mentioned link body 50L. For example, in the example shown in FIG. 20, the first link part 51A and the second link part 51B are formed with plate shaped members, and the joint parts 52A, 52B, 52C and 52D of the link body 50L can be formed with linear bending parts. According to this configuration, connecting portion to the diaphragm 10 can be made linearly, thereby a uniform vibration can be applied to the planar diaphragm 10 in the width direction, and thus the whole diaphragm can vibrate substantially in the same phase. That is, divided vibration is prevented from occurring, and particularly, sound in high frequency range can be reproduced. Also, each of the link parts having rigidity, vibration hardly occurs in the characteristic vibration mode, thereby preventing flexural vibration, etc. of the link parts from having an adverse effect on the vibration of the diaphragm 10, thus preventing reduction of the acoustic characteristic.

For example, the vibration direction converter part 50 according to this embodiment may have a vent hole. The vent hole can reduce a local fluctuation of air pressure of the space surrounded by the diaphragm 10 and the frame 12 when driving the speaker, thus preventing damping of the vibration direction converter part 50 due to air pressure. Also, for example, a cutout is formed in the link part with the vent hole, the link part can be weight-saved, thus enabling a high frequency reproduction. In addition, weight-saving of the vibration direction converter part helps to broaden reproduction characteristic and increase amplitude of vibration and sound pressure level of a sound wave with respect to the prescribed voice currents.

The vibration direction converter part 50 may be formed with integrally formed part which parts of the integrally formed part are connected by a bending part. In that case, the vibration direction converter part 50 forming a complicated link body can be instantly connected to the voice coil 40 or the diaphragm 10, thus facilitating assembly of a device. Also, for example, the vibration direction converter part 50 may be formed integrally with the voice coil 40 or the diaphragm 10.

The joint parts 52A, 52B, 52C and 52D of the vibration direction converter part 50 may be configured with a mechanical joint or may be configured with a member made of fiber including polymer such as polyester or polyaramid, a member including polyurethane resin, rubber, etc. and a flexible member such as flexible film. Also, for example, the voice coil 40 and the vibration direction converter part 50 may be integrally molded using the prescribed material such as resin material, and then the joint parts 52A, 52B, 52C and 52D may be bendably formed by applying processing treatment to the prescribed portion.

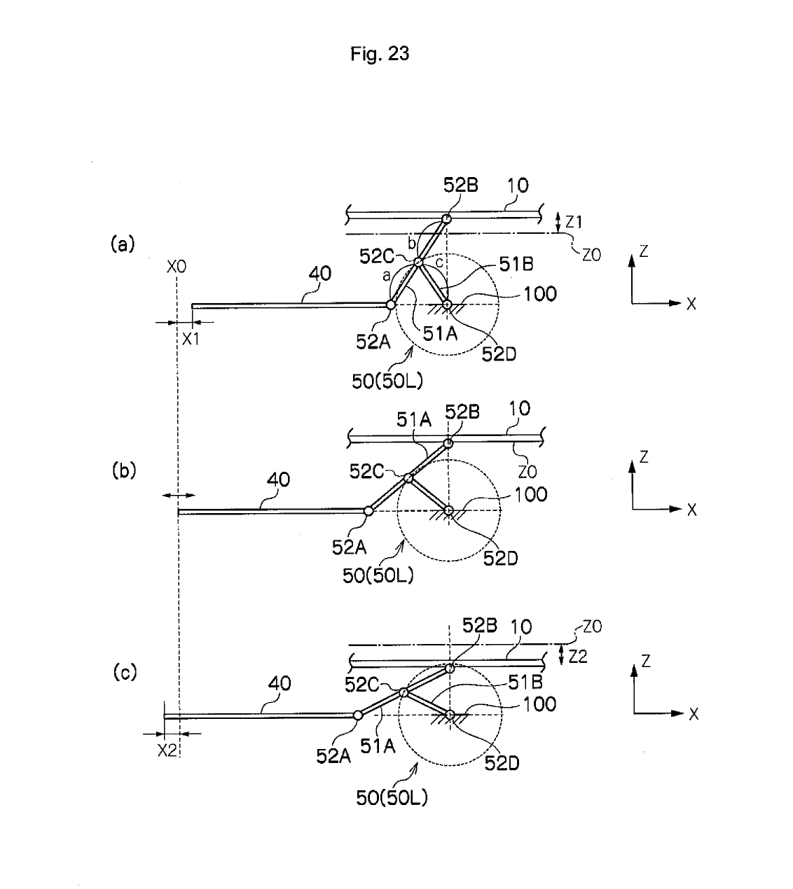

FIG. 23 is a view illustrating operation of the vibration direction converter part 50 according to the embodiment of the present invention shown in FIG. 20. More specifically, FIG. 23(b) shows a state of the vibration direction converter part 50 when the diaphragm 10 is located at a reference position, FIG. 23(a) shows a state of the vibration direction converter part 50 when the diaphragm 10 is displaced toward the sound emission side with respect to the reference position, and FIG. 23(c) shows a state of the vibration direction converter part 50 when the diaphragm 10 is displaced in a direction opposite to the sound emission side with respect to the reference position.

As described above, the hinge part 52D is the only hinge part that is not displaced, which is supported by the static part 100 such as the frame 12 and the support base 13, thus applying the reaction force from the static part 100 to the link body 50L. Accordingly, when the voice coil 40 moves from the reference position X0 by X1 in the X-axis direction, the angles of the first and the second link parts 51A and 51B obliquely arranged in different directions are increased substantially by the same angle as shown in FIG. 23(a), and the hinge part 52B, receiving the reaction force from the frame at the hinge part 52D, securely pushes up the diaphragm 10 from the reference position Z0 by Z1 in the Z-axis direction. Further, when the voice coil 40 moves by X2 reversely in the X-axis direction the angles of the first and the second link parts 51A and 51B are decreased substantially by the same angle as shown in FIG. 23(c), and the hinge part 52B, receiving the reaction force from the static part 100 at the hinge part 52D, securely pushes down the diaphragm 10 from the reference position Z0 by Z2 reversely in the Z-axis direction.

The length a of the link part from the hinge parts 52A to 52C, the length b of the link part between the hinge parts 52C and 52B, and the length c of the link part between the hinge parts 52C and 52D may be configured to be similar so that the hinge parts 52A and 52D are arranged on a straight line in the moving direction of the voice coil 40. This link body is well known as Scott Russell linkage where the hinge parts 52A, 52B and 52C lie on a circumference of a circle having the diameter being the length of the first link part 70 (a+b=2a) and having the center at the hinge part 52D. Namely, the angle defined by the line passing the hinge parts 52A and 52D and the line passing the hinge parts 52B and 52D is always a right angle. Therefore, when the voice coil 40 is moved in the X-axis direction, the hinge part 52B between the first link part 51A and the diaphragm 10 always moves in the Z-axis direction that is perpendicular to the X-axis, thus it is possible to convert the vibration direction of the voice coil 40 to its perpendicular direction and transmit the vibration to the diaphragm 10.

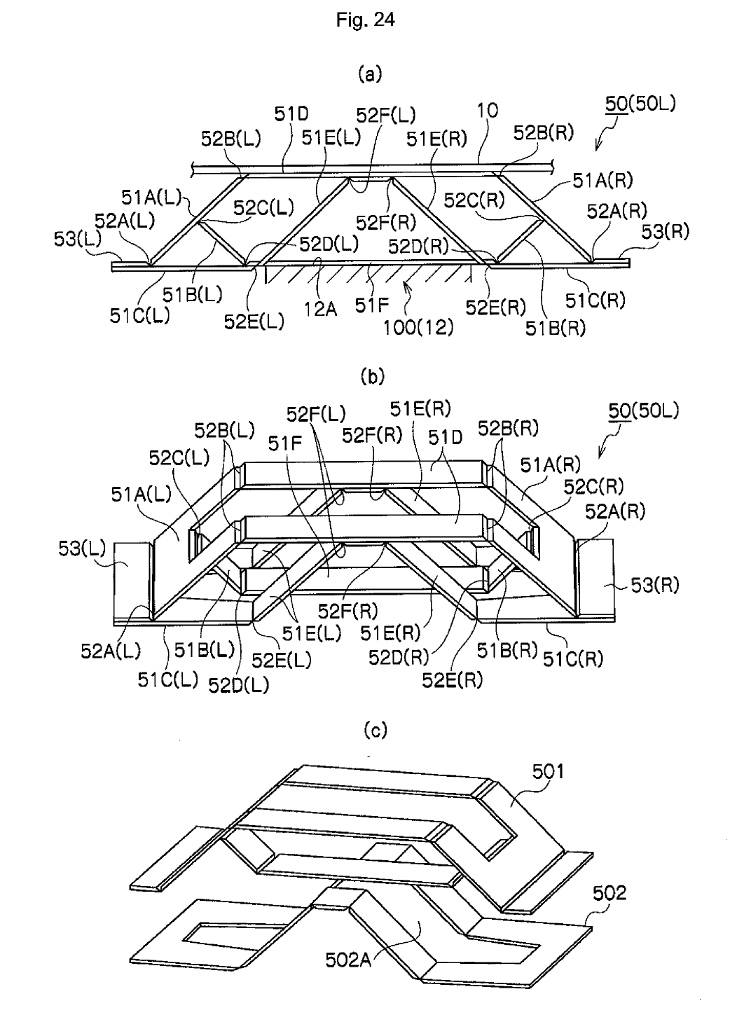

FIG. 24 is a view illustrating an example of the vibration direction converter part 50 according to the embodiment of the present invention (FIG. 24(a) is a side view, FIG. 24(b) is a perspective view and FIG. 24(c) is an exploded perspective view). The vibration direction converter part 50 includes a pair of driving parts and the vibration direction converter parts 50 are substantially left and right symmetrically arranged opposite to each other, and the vibration direction converter part 50 is formed with an integrally formed part.

The vibration direction converter part 50 according to this embodiment includes a pair of first link parts 51A(R) and 51L(L) having hinge parts 52B(R) and 52B(L) to the connecting part 60 at one end part, and having a hinge parts 52B(R) and 52B(L) to the diaphragm 10 at the other end part. Also, it includes a pair of second link parts 51B(R) and 51B(L) having a hinge parts 52C(R) and 52C(L) to the middle portions of the first link parts 51A(R) and 51A(L) at one end, and having hinge parts 52D(R) and 52D(L) to the static sixth link part 51F described below at the other end. Further The vibration direction converter part includes a pair of third link parts 51C(R) and 51C (L) integrally extending from the voice coil supporting part 6 and a fourth link part 51D fixed along the diaphragm 10. Moreover it includes a pair of fifth link parts 51E(R) and 51E(L) having hinge parts 52F(R) and 52F (L) to the end of the third link parts 51C (R) and 51C (L) at one end part, and having hinge parts 52E(R) and 52E (L) to the fourth link part 51D at the other end. The hinge parts 52B(R) and 52B(L) between the first link part 51A and the diaphragm 10 (the fourth link part 51D) are formed at both ends of the fourth link part 51D, and the hinge parts 52D(R) and 52D (L) between the second link parts 51B(R) and 51B(L) and the static sixth link part 51F described below) are formed at both ends of a sixth link part 51F having substantially the same length as the fourth link part 51D. Further, the first link part 51A(R) and the fifth link part 51E(R), or the first link part 51A(R) and the fifth link part 51E(L) form a parallel link respectively, while the third link parts 51C(R) and 51C(L) and the fourth link part 51D form a parallel link respectively. Further, connecting parts 53(R). 53(L) connecting to the connecting part 60 are provided at the base end parts of the third link parts 51C. The connecting parts 53 are connected to the connecting part 60 described above.

The link body 50L of the vibration direction converter part 50 as described above substantially includes a function combining the link body shown in FIG. 20 and the parallel link body, each link part is formed with a plate shaped member, each joint part between link parts is formed with a linear bending part, and the link body 50L is integrally formed with each link part being connected via the bending part.

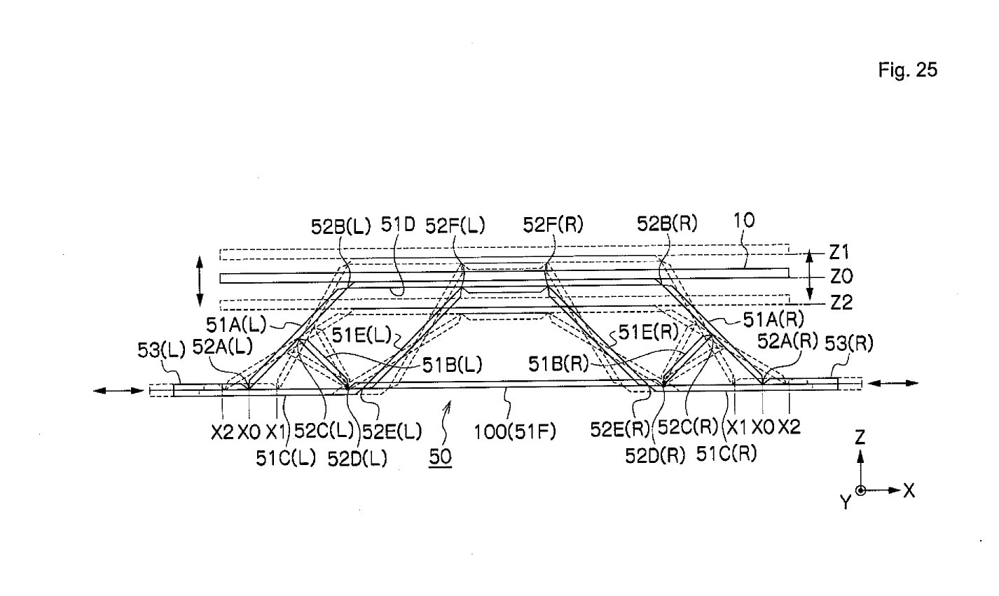

The operation of the vibration direction converter part 50 is described with reference to FIG. 25. In this example, the sixth link part 51F supported by the frame 12 functions as the static part 100. According to the above vibration direction converter part 50, the joint parts 52A (R), (L) move from a reference position X0 to X1 in the X axial direction in response to movement of the connecting part 60 due to the vibration of the voice coil 40, thereby the fourth link part 51D goes up with a parallel link of the third link parts 51C(R), (L) and the fourth link part 51D staying in the parallel state and the first link parts 51A(R), (L) and the fifth link parts 51E(R), (L) constructing parallel links, angle-convert as being raised. The joint parts 52D(L), (R) supported by the sixth link part 51F as the static part 100, receive a reaction force from the static part 100, thereby the first link part 51A(R), (L) and the fifth link part 51E(R), (L) are securely angle-converted, and thus displacements of the joint parts 52A(R), (L) from the position X0 to X1 are securely converted to the displacement of the diaphragm 10 from the position Z0 to Z1.

Similarly, the joint parts 52A(R), (L) move from the reference position X0 to X2 in the X axial direction, thereby the fourth link part 51D goes down with a parallel link of the third link part 51C(R), (L) and the fourth link part 51D staying in the parallel state, and the first link part 51A(R), (L) and the fifth link part 51E(R), (L) constructing parallel links angle-convert as being laid. The joint parts 52D(L), (R) supported by the static part 100, receive a reaction force from the static part 100, thereby the first link part 51A(R), (L) and the fifth link parts 51E(R), (L) are securely angle-converted, and thus displacement of the joint part 52A(R), (L) from the position X0 to X2 is securely converted to the displacement of the diaphragm 10 from the position Z0 to Z2.

According to the embodiment as described above, the vibration of one voice coil 40 in the X axial direction is converted to the vibration in the Z axial direction of the joint parts 52B(R), (L), 52F(R), (L) and the fourth link part 51D vibrating substantially in the same phase and substantially at the same amplitude. With this configuration, the diaphragm 10 is supported by a broad area and vibration substantially in the same phase and substantially at the same amplitude is applied to the diaphragm 10, the vibration of the voice coil 40 can be transmitted to the planar diaphragm 10 having large area substantially in the same phase.

The link body of the above vibration direction converter part 50 can include each link part formed with a plate shaped member as described above, where each joint part may be formed by connecting each of the link parts rotatably or each link part may be connected therebetween or may be integrally formed foldably or bendably. The plate shaped member may be formed with a highly rigid and lightweight member and fiber-reinforced plastic film, etc. can be employed.

As shown in FIG. 24(b), each pair of the third link parts 51C(R), (L), the fourth link parts 51D and the fifth link parts 51E(R), (L) is arranged in parallel, and the first link parts 51A(R), (L) have a biforked shape. The joint parts 52C(R), (L) with the second link parts 51B(R), (L) are formed at the middle parts of the first link parts and the second link parts 51B(R), (L) and the sixth link part 51F are provided between each pair of the third link parts 51C(R), (L), the fourth link parts 51D and the fifth link parts 51E(R), (L) arranged in parallel.

With the link parts formed with a single plate shaped member, the diaphragm 10 can be vibrated supported by plane, thereby the whole diaphragm can be vibrated substantially in the same phase, preventing divided vibration. Although the link parts can be formed with a plurality of plate shaped members, the manufacturing process can be simplified by forming link parts with a single plate shaped member. When forming the link parts with a single plate shaped member, the link parts may be cut out of a single planar plate shaped member.

As shown in FIG. 24(b), in the vibration direction converter part 50 according to this embodiment, a whole plate shaped member including the link parts is bent in a projecting trapezoidal shape, forming the first link parts 51A(R), (L) and the fourth link part 51D, and the plate shaped member is partially cut out and is bent in a recessed trapezoidal shape, forming the second link parts 51B(R), (L) and the sixth link part 51F.

Further, the vibration direction converter part is formed by attaching two plate members 501 and 502 to each other as shown in FIG. 24(c). The first link parts 51A(R) and 51A(L), the second link parts 51B(R) and 51B(L), the fourth link part 51D and the sixth link part 51F are formed with one plate member 501, while the Third link parts 51C(R) and 51C(L) and the fifth link parts 51E(R) and 51E(L) are formed with the other plate member 502. And, the third link parts 51C(R) and 51C(L) and the fifth link parts 51E(R) and 51E(L) are formed along the first link parts 51A(R) and 51A(L) and the fourth link part 51D, and an opening 502A corresponding to the second link parts 51B(R) and 51B(L) and the sixth link part 51F is formed in the plate member 502.

In the example shown in FIG. 24(c), an opening 502A formed in another plate shaped member 502 corresponding to the second link part 51B(R), (L) and the sixth link part 51F is configured to expand from one end part of another plate shaped member 502 toward the inside. With this configuration, the second link parts 51B(R), (L) and the sixth link part 51F have little contact with another plate shaped member 502, thus the link body can be moved smoothly. The shape of the opening 502A may be altered as necessary, and substantially the same width may be applied from one end part of another plate shaped member 502 toward the inside.

A slant face is formed at the end part of each link part in the proximity of each joint part. More particularly, the slant face is formed at the side face opposite to the side faces of the link parts getting closer when the link parts are bent at the joint part, such that the link parts can be bent efficiently at the joint part.

In such an embodiment, because the link body of the vibration direction converter part can be formed simply with a single integral part being attached to two voice coil 40 opposite to each other, the assembling process of a speaker device even with a pair of driving parts can be facilitated. Further, the sixth link part 51F enables to always hold the hinge parts 52D(R) and 52D(L) in fixed positions on the frame 12 without particularly fixing them onto the frame 12 corresponding to opposing vibrations of the voice coil supporting parts 6 (a plurality of the voice coils 40 vibrate in directions opposite to each other), thereby facilitating the incorporation of the vibration direction converter part into the speaker device.

Further, because the right side first link part 51A(R) and the third link part 51C(R), and the left side first link part 51A(L) and the third link part 51C(L) form parallel links in the link body, the fourth link part 51D fixed to the diaphragm 10 can be parallel moved stably along the Z-axis direction corresponding to the opposing vibrations of the voice coil supporting parts 6, thereby enabling to apply a stable vibration to the planar diaphragm 10.

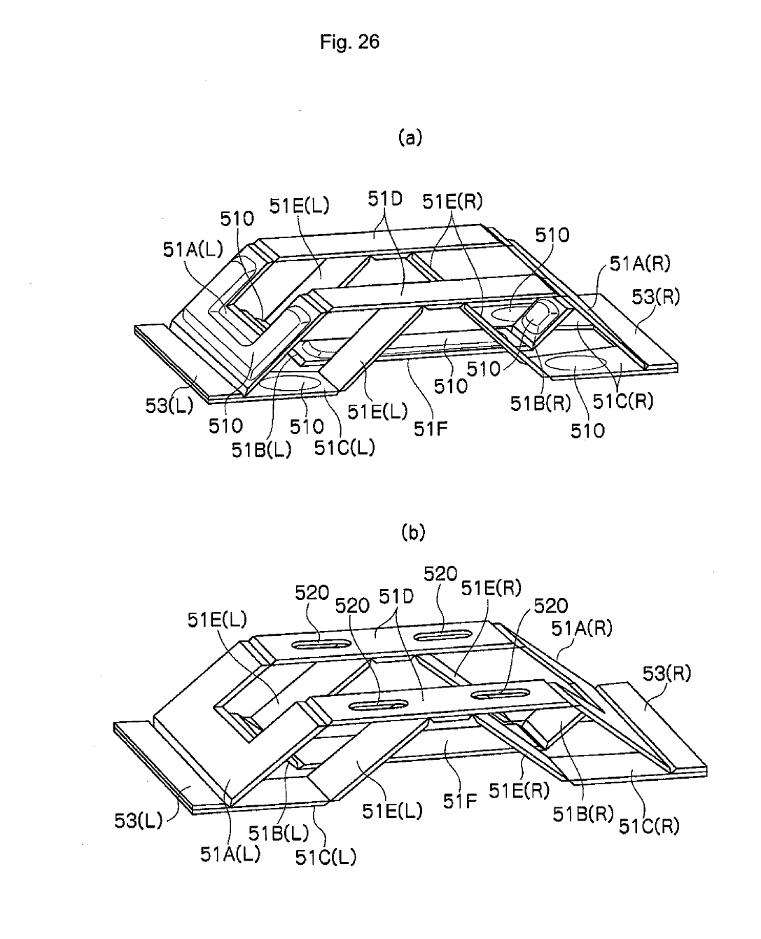

FIG. 26 illustrates an improved embodiment of the embodiment shown in FIG. 24. In this embodiment shown in FIG. 26(a), a projecting portion 510 is provided on the link part which is subject to bend by the opposing vibrations of the voice coil supporting part 6 in order to increase the rigidity. As shown in the drawing, the first link part 51A(R) and 51A(L), the second link parts 51B(R) and 51B(L), the first link parts 51C(R) and 51C(L) and the sixth link part 51F are provided with the projecting portion 510 respectively. In addition, in the embodiment shown in FIG. 26(b), an opening 520 is provided in the link part which does not particularly need strength in order to make the vibration direction converter part light in weight. In the drawing, the fourth link part 51D has the openings 520. The vibration direction converter part is effectively formed light in weight to broaden a bandwidth of a reproduction characteristic or increase the amplitude and sound pressure level of a sound wave corresponding to a predetermined voice current.

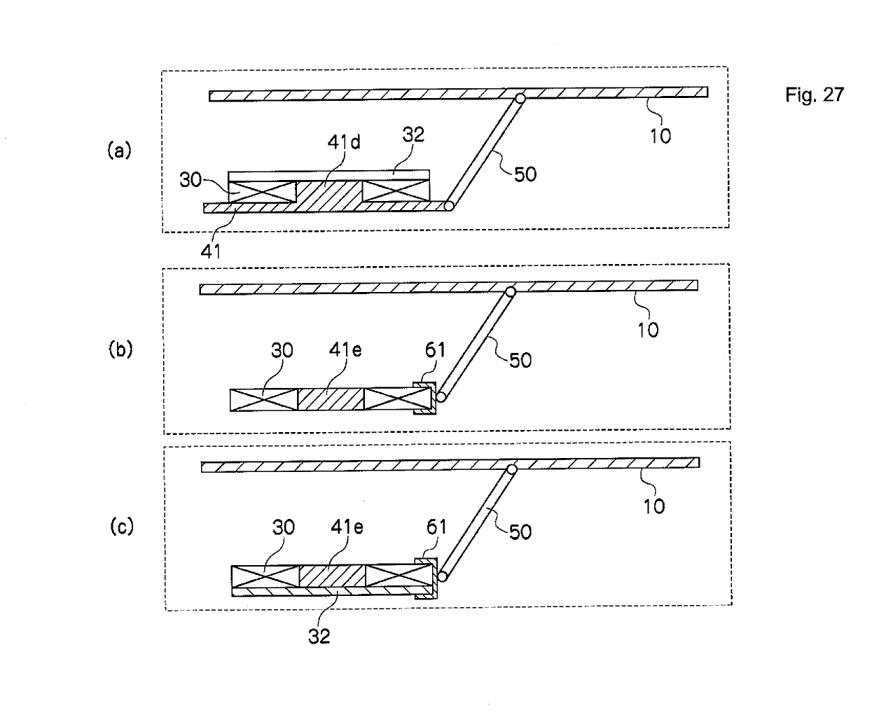

### Modified Examples: FIGS. 27, 28 and 29

FIG. 27 is a view illustrating a modified example of the voice coil 40, and a conducting wire such as winding wire is planarly wound along outer periphery part of the winding core, thereby annular conducting member 30 is formed. In the example shown in FIG. 27(a), a conducting wire is wound around a projecting shaped winding core 41d formed at the center of the base 41. Further, a protection film 32 formed with, for example, a resin film may be applied to the surface of the conducting member 30 formed with winding wire as necessary. Meanwhile, in the conducting member 30 formed with the conducting wire, a part of the conducting wire is uplifted as time passes due to change in shape over time caused by stress occurring when winding the conducting wire. This uplift can be prevented with the protection film 32.

In the example shown in FIG. 27(b), the conducting wire is planarly wound around the outer periphery part of a winding core 41e formed integrally with the base 41 or separately from the base 41, and thereby the annular conducting member 30 is formed, and the vibration direction converter part 50 is supported via a connection unit 61 by the end part of the voice coil 40 formed with the conducting member 30. With the connection unit 61 attached to the end part of the conducting member 30 as sandwiching the end part in the thickness direction, a part of the conducting wire at the end part of the voice coil 40 can be prevented from uplifting due to change in shape over time.

In the example shown in FIG. 27(c), the conducting wire is planarly wound around the outer periphery part of a winding core 41e and thereby the annular conducting member 30 is formed, and a protection film 32 formed with, for example, resin film, etc. is applied to the rear side of the conducting member 30, a part of the conducting wire can be prevented from uplifting due to change in shape over time. As shown in FIG. 27(a), the protection film 32 may be applied to the surface of the conducting member 30 as necessary. The end part of the voice coil 40 includes conducting member 30 and the protection film 32. The conducting member and the protection film are integrally stacked in the voice coil. The vibration direction converter part 50 is supported by the end part of the voice coil 40 via the connection unit 61, a part of the conducting wire at the end part of the voice coil 40 can be prevented furthermore from uplifting due to change in shape over time. Although the voice coil 40 is constructed with the conducting member 30 formed with a conducting wire, for example, the voice coil is formed with a print circuit board formed with metal foil, conducting film, etc. in place of the conducting wire.

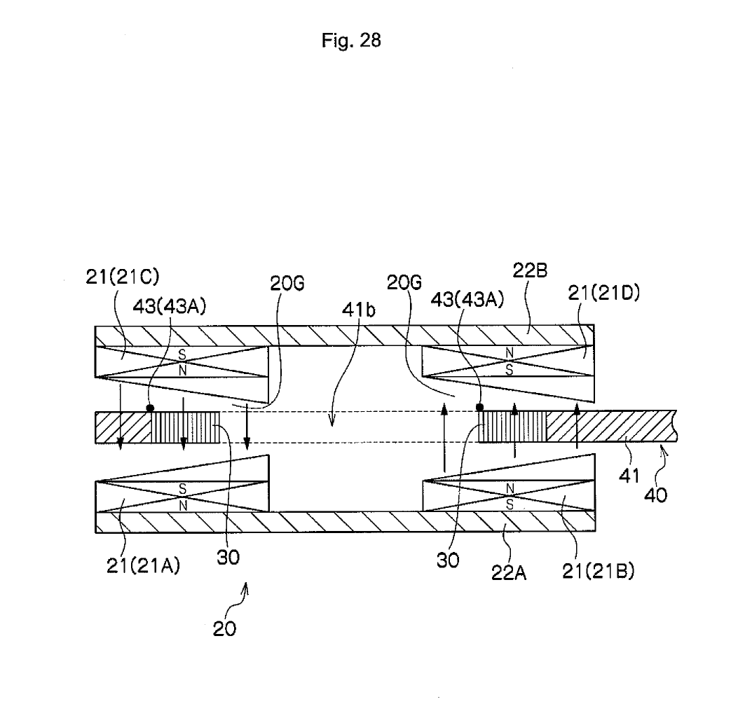

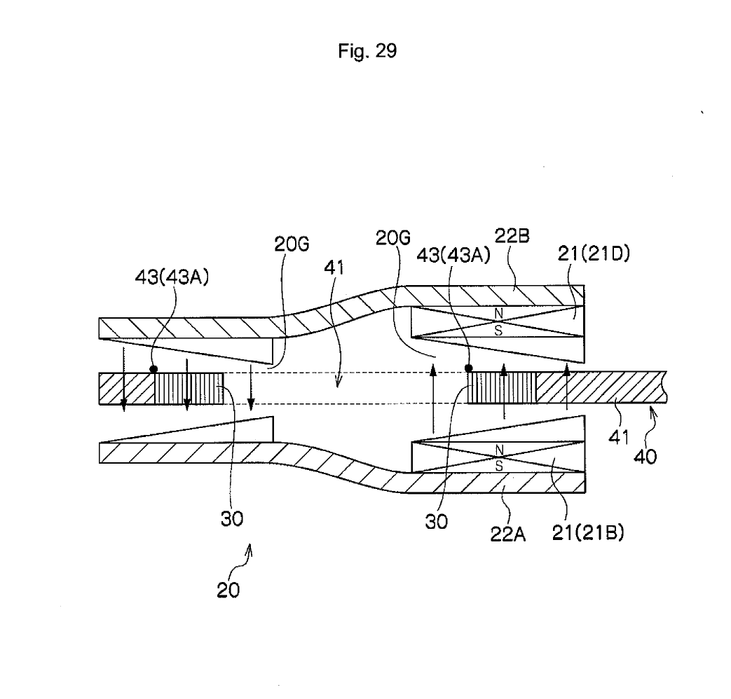

FIGS. 28 and 29 are views illustrating modified examples of the magnetic circuit 20. The magnetic circuit 20, similarly to those shown in FIGS. 16 and 17, two magnetic pole parts, constituting each of the magnetic gaps 20G, obliquely form opposing faces, such that the width of the magnetic gap 20G between one end parts of the magnetic pole parts is larger than the width of the magnetic gap 20G between another end parts, and a leading part 43A of the voice coil leading wire 43 pulled out of one end part of winding wire of the conducting member 30 is arranged in the proximity of the one end part.

In the example shown in FIG. 28, in the magnetic circuit 20 shown in FIG. 16, a magnetic body having a cross-sectional shape formed in a triangle shape is fixed to the surfaces of a plurality of the magnets 21A to 21D facing the conducting member 30, or a magnet having a cross-sectional shape formed in a trapezoidal shape is used, such that the two magnetic gaps 20G oblique in the similar direction respectively, and the voice coil lead wire 43 is pulled out of the larger magnetic gap 20G.

In the example shown in FIG. 29, in the magnetic circuit 20 shown in FIG. 17, yoke parts 22A, 22B are curved and a magnetic body having a cross-sectional shape formed in a triangle shape is fixed to the surfaces facing the conducting member 30, or a magnet having a cross-sectional shape formed in a trapezoidal shape is used, such that the two magnetic gaps 20G oblique in the same direction respectively, and the voice coil lead wire 43 is pulled out of the larger magnetic gap 20G. With this configuration, with the voice coil lead wire 43 pulled out from the region where the width of the magnetic gap 20G is large, the voice coil lead wire 43 is prevented from contacting the magnetic body. Also, occurrence of abnormal noise can be prevented.

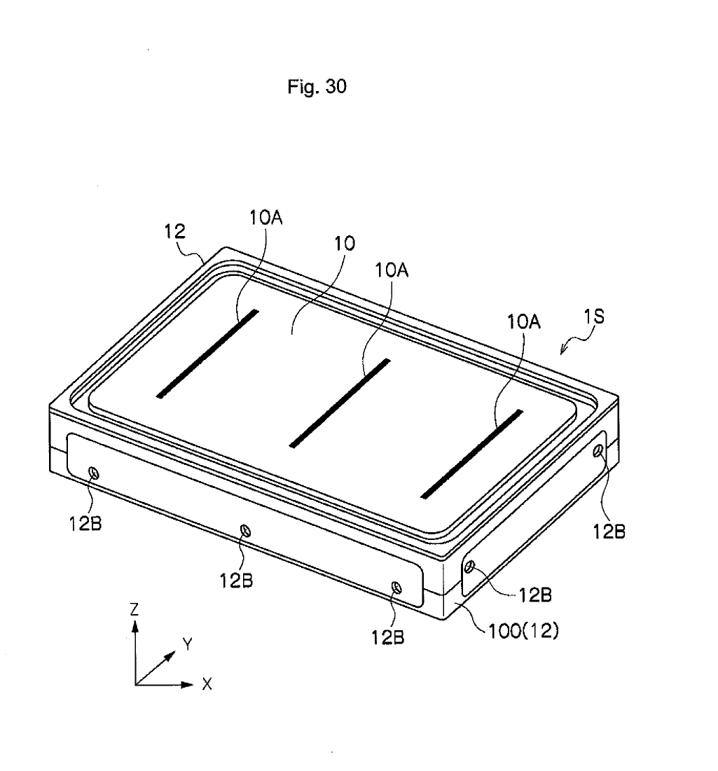

### Embodiments and On-Board Examples: FIGS. 30 to 33, 34, 35, and 36 to 44

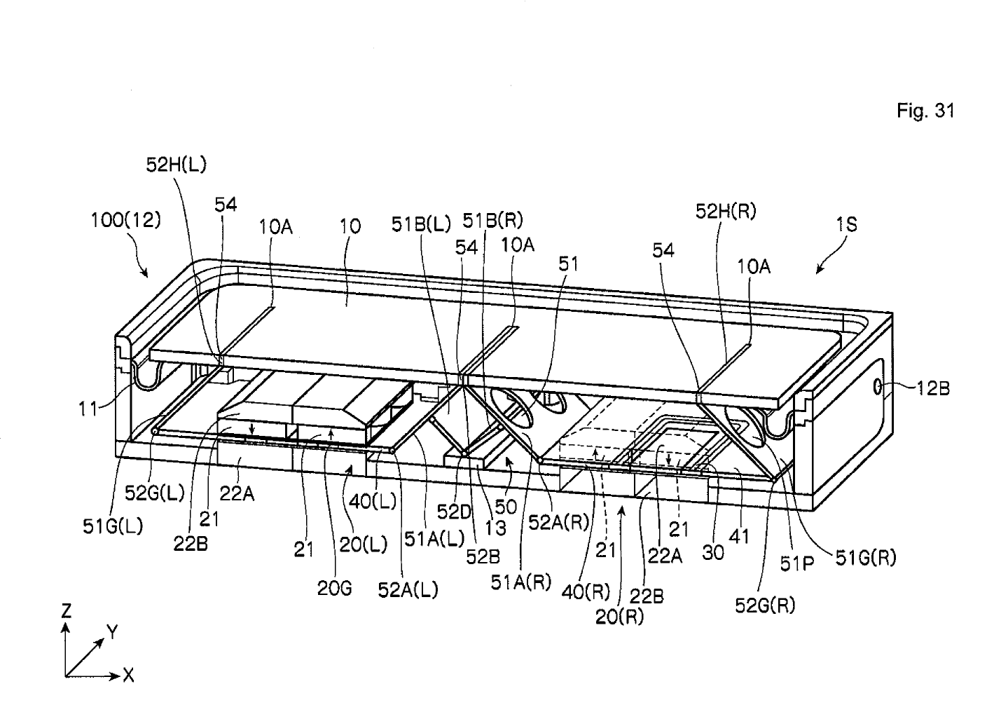

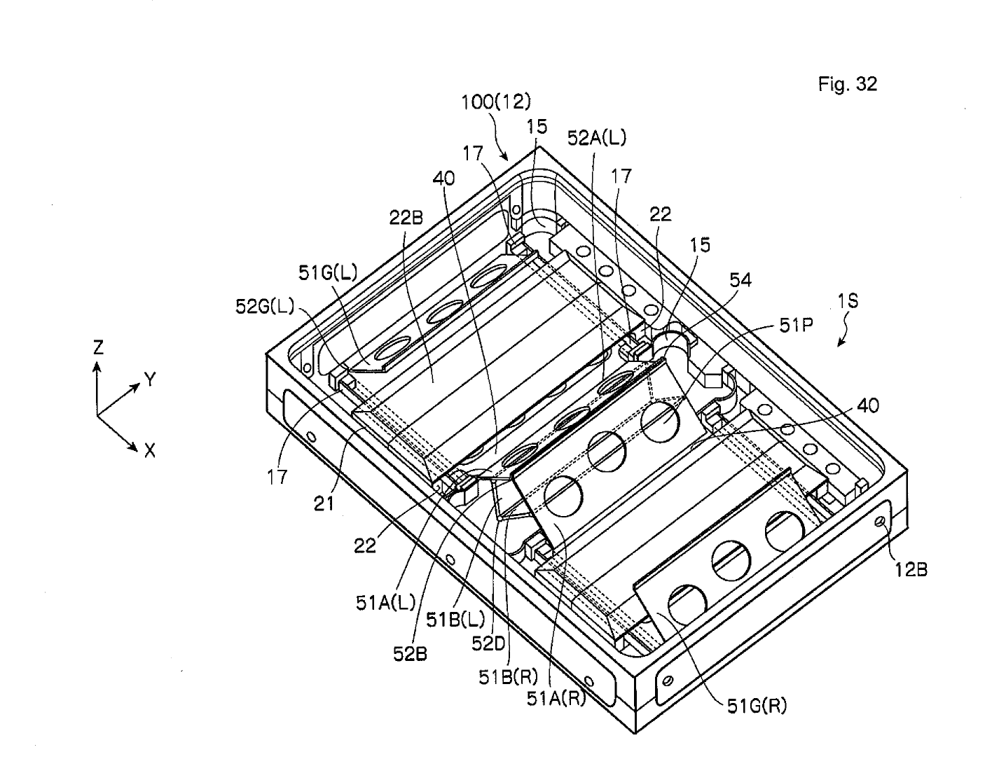

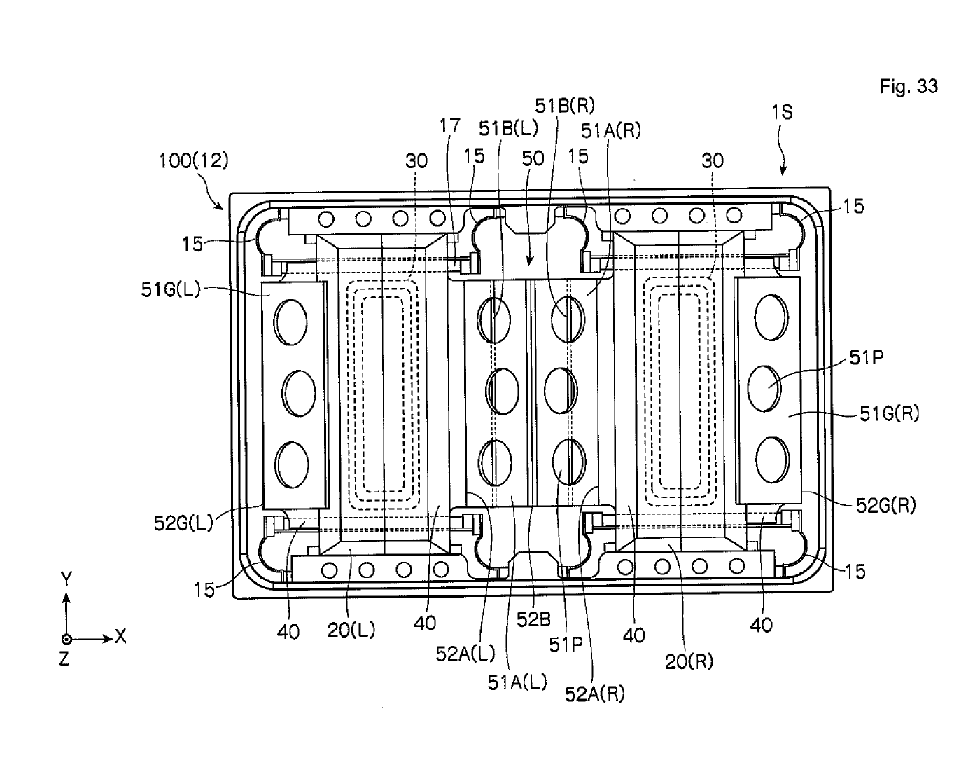

Hereinafter, embodiments of the present invention are described with reference to the drawings. FIG. 30 is a view illustrating the perspective view of the speaker device 1S according to an embodiment of the present invention. FIG. 31 is a cross-sectional perspective view of the speaker device 1S shown in FIG. 30. FIG. 32 is a top view of essential parts of the speaker device 1S shown in FIG. 30. FIG. 33 is a top view of essential parts of the speaker device 1S shown in FIG. 30. Hereinafter, the same symbols are applied to the same parts described in the above-mentioned embodiments and part of the description is abbreviated. In FIGS. 32 and 33, showing the diaphragm is abbreviated. In FIG. 31, part of the magnetic circuit on the right hand of the drawing is not shown.

As described in the above embodiments, the speaker device 1S includes the diaphragm 10, the frame 12, the edge 11, the magnetic circuit 20, the voice coil 40, the vibration direction converter part 50, and the holding part 15. In this embodiment, the frame 12 includes a rectangular outer periphery part and the planar diaphragm 10 having a rectangular outer periphery part corresponding to the shape of the frame is arranged in the rectangular opening part of the frame 12. The edge 11 is provided at the outer periphery edge of the diaphragm 10, and the whole periphery of the diaphragm 10 is supported by the outer periphery edge of the frame 12 via the edge 11. Also, the frame 12 includes a planar bottom part 12A, and the diaphragm 10 is supported planarly along the bottom part 12A.

A pair of the voice coils 40 driven by a pair of the magnetic circuits 20(R), 20(L) is provided with the vibration direction converter parts 50 respectively at both end parts in the vibration direction. In this embodiment, pairs of the first link parts 51A(R), (L) and the second link parts 51B(R), (L) are provided at the center, and auxiliary links 51G(R), (L) are provided outside each voice coil 40.

The first link parts 51A(R), (L) are bendably connected to the central part (position of the center of gravity) of the diaphragm 10 via the joint part 52B. The auxiliary link 51G(R), (L) are bendably connected to the diaphragm 10 in the side of outer periphery part from the central part (position of the center of gravity)of the diaphragm 10 via the joint parts 52H (R), (L).

Further, a connection end part 54 is formed in the proximity of the upper end part of the first link parts 51A (R), (L) and the auxiliary links 51G(R), (L) and the connection end part 54 is fitted into a groove part 10A formed on the diaphragm 10. For example, the connection end part 54 is fixed to the diaphragm 10, projecting from its front face. The diaphragm 10 is linearly supported by the vibration direction converter part 50 at three positions, and the linear connection end part 54 is embedded inside the diaphragm 10 as a reinforcing member, thereby the diaphragm 10 has comparatively largestrength, preventing occurrence of deflection of the diaphragm. With this configuration, the whole diaphragm 10 can be vibrated substantially in the same phase.

Also, the first link parts 51A (R), (L) and the auxiliary links 51G(R), (L) form the two opposing parallel links, thereby the three connecting portions vibrate substantially in the same phase and substantially at the same amplitude in accordance with opposing vibrations of the voice coils 40 (a plurality of the voice coils 40 vibrate mutually in the opposite direction). This will also help the whole diaphragm 10 to vibrate substantially in the same phase, and thus occurrence of divided vibration can be prevented.

The first link parts 51A (R), (L) and the auxiliary links 51G(R), (L) are provided with a vent hole 51P. Provided with this vent hole 51P, each link part of the plate shaped member can vibrate without receiving large air resistance. Also, provided with the vent hole 51P, each link part can be weight-saved, and reproduction characteristic can be broaden.

A means for regulating the moving direction of the voice coil 40 includes the holding part 15 and the supporting part 17. For example, the supporting part 17 is an L-shape member formed in the longitudinal direction along both end parts of the voice coil 40, supporting each voice coil 40 in the longitudinal direction. The end part of the supporting part 17 is vibratably supported by the frame 12 via the holding part 15. That is, with the above regulating means, each voice coil 40 is formed movably only in the X axial direction. The holding part 15 includes a damping configuration substantially symmetrically with respect to an axis passing parallel to the Y axial direction passing between the two magnetic circuits 20 (R), (L). Specifically, the holding part 15 is formed in a projecting shape in a direction away from the axis.

Further, in this embodiment, a vent hole 12B is formed at the side part of the frame 12, enabling air communication between the inside and the outside of the frame 12. With this configuration, a damping force due to pressure inside the frame 12 is prevented from being applied to the diaphragm 10, and thus the diaphragm can be securely vibrated with a small driving force.

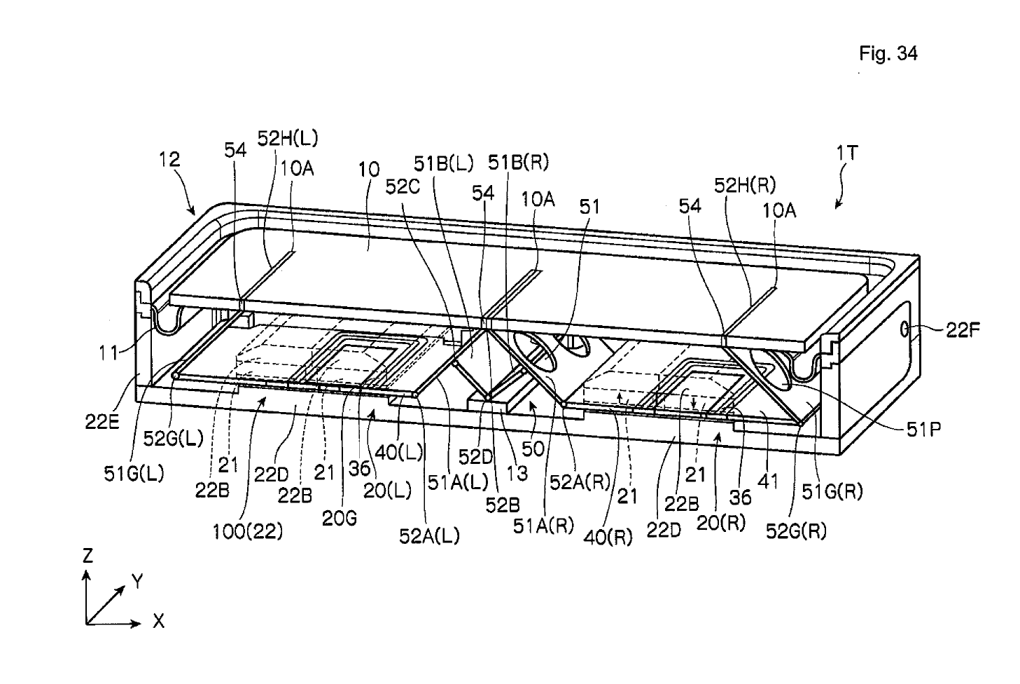

FIG. 34 is a perspective view of the speaker device 1T according to another embodiment of the present invention. A cross-sectional perspective view of the speaker device 1T shown in FIG. 34 and a top view of the essential parts of the speaker device 1T shown in FIG. 34 are abbreviated because they are substantially the same as those shown in FIGS. 32, 33 except that the frame is formed with the yoke part. Hereinafter, the same symbols are applied to the same parts described in the above-mentioned embodiments and part of the description is abbreviated. In FIG. 34, part of the magnetic circuit on the right hand of the drawing is abbreviated.

As described in the above embodiments, the speaker device 1T includes the diaphragm 10, the yoke part 22, the edge 11, the magnetic circuit 20, the voice coil 40, the vibration direction converter part 50, and the holding part 15. In this embodiment, the yoke part 22 includes a rectangular outer periphery part and the planar diaphragm 10 having a rectangular outer periphery part corresponding to the shape of the yoke part is arranged in the rectangular opening part of the yoke part 22. The edge 11 is provided at the outer periphery edge of the diaphragm 10, and the whole periphery of the diaphragm 10 is supported by the outer periphery edge of the yoke part 22 via the edge 11.

The yoke part 22 functions as the static part 100 arranged in a static state with respect to the voice coil 40. Also, the yoke part 22 constituting the driving part 14 includes a bottom face part 22D arranged under the magnet 21 and a side face part 22E configured to surround the bottom face part 22D. Further, the yoke part 22 as the static part 100 is not intended to be in a complete static state, for example, the yoke part 22 may be static enough to support the diaphragm 10, and vibration occurring when driving the speaker device 1T may be transmitted, thus causing vibration in the whole static part 100.

Further, in this embodiment, a vent hole 22F is formed at the side part of the yoke part 22, enabling air communication circulation between the inside and the outside of the yoke part 22. With this configuration, a damping force due to pressure inside the yoke part 22 is prevented from being applied to the diaphragm 10, and thus the diaphragm can be securely vibrated with a small driving force.

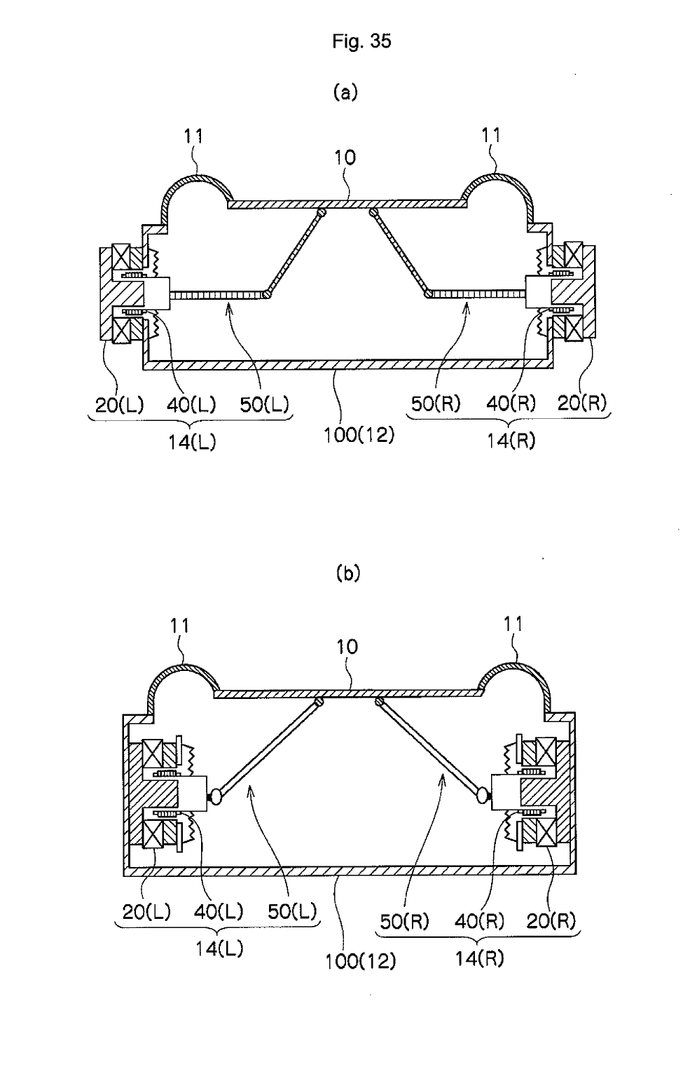

FIG. 35 shows a reference example of one or more embodiments of the present invention. In the reference example shown here, the driving parts 14(R), 14(L) are provided at the side part of the frame 12 as the static part 100, and the vibration direction converter parts 50 (R), (L), the voice coils 40 (R), 40 (L), and the magnetic circuits 20 (R), 20 (L) are provided at each of the driving parts 14(R), 14(L) as described above. In the example shown in FIG. 35(a), the magnetic circuits 20 (R), 20 (L) are attached to the outside of the frame 12 and in the example shown in FIG. 35(b), the magnetic circuits 20 (R), 20 (L) are attached to the inside of the frame 12. In this reference example, a rigid columnar voice coil 40 is employed, and the voice coil 40 is supported by the frame via a known supporting means and is connected to the vibration direction converter part 50.

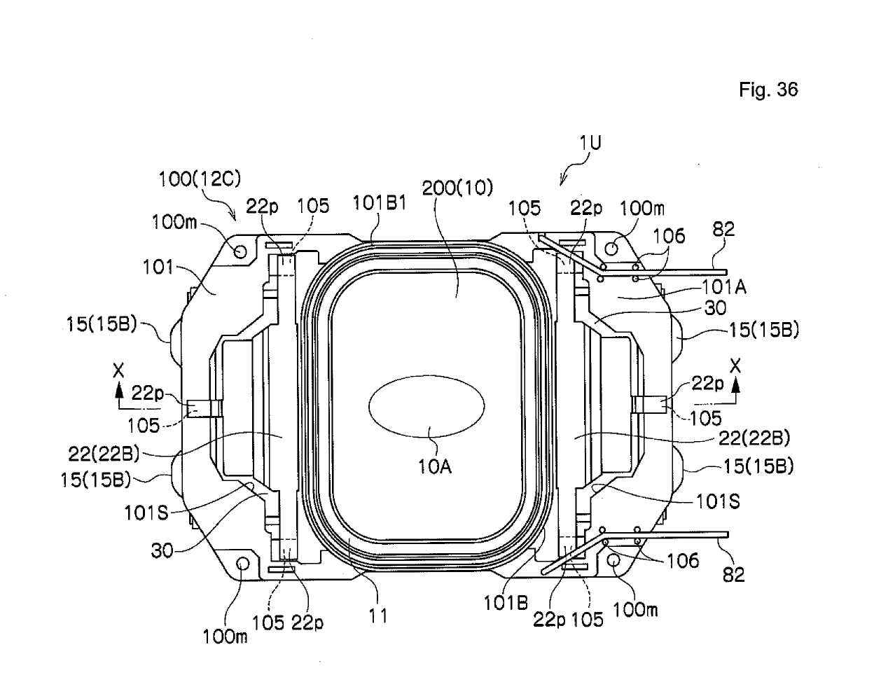

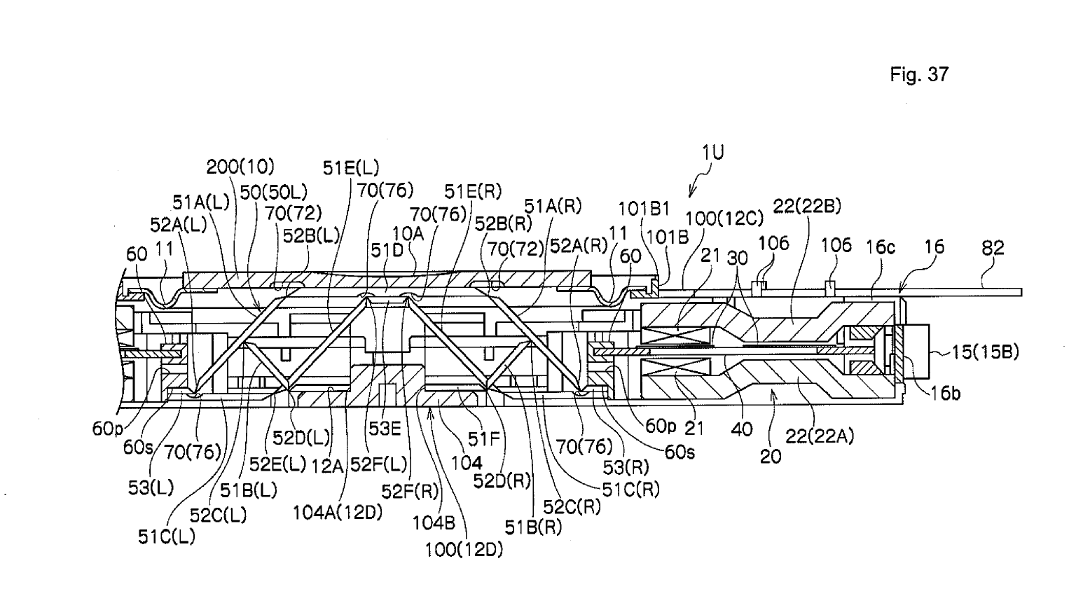

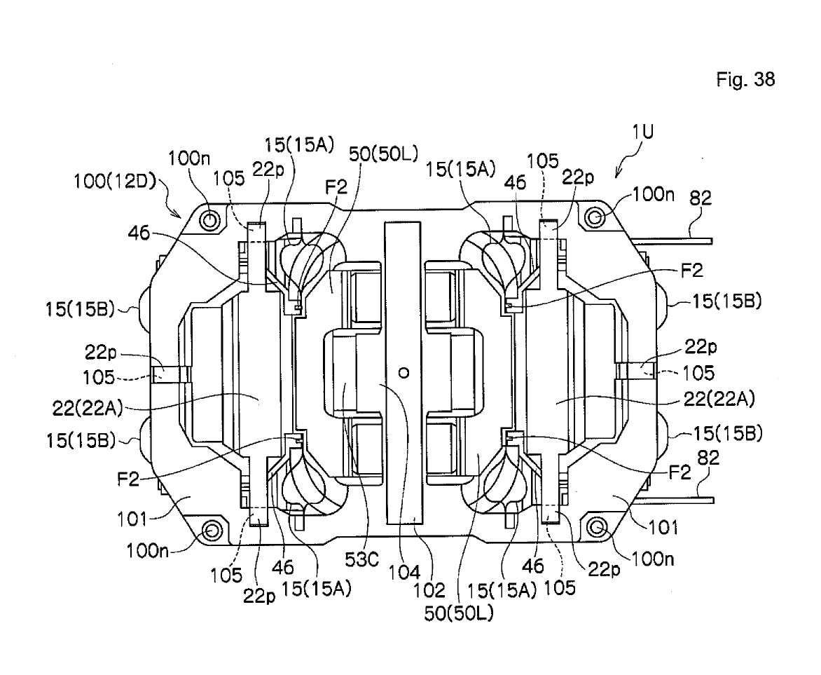

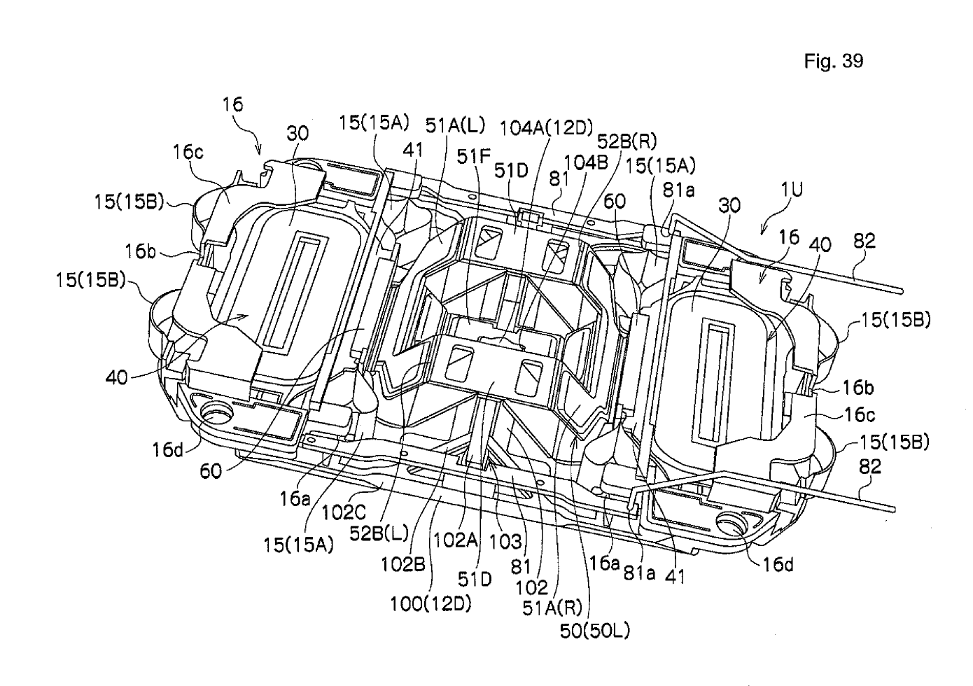

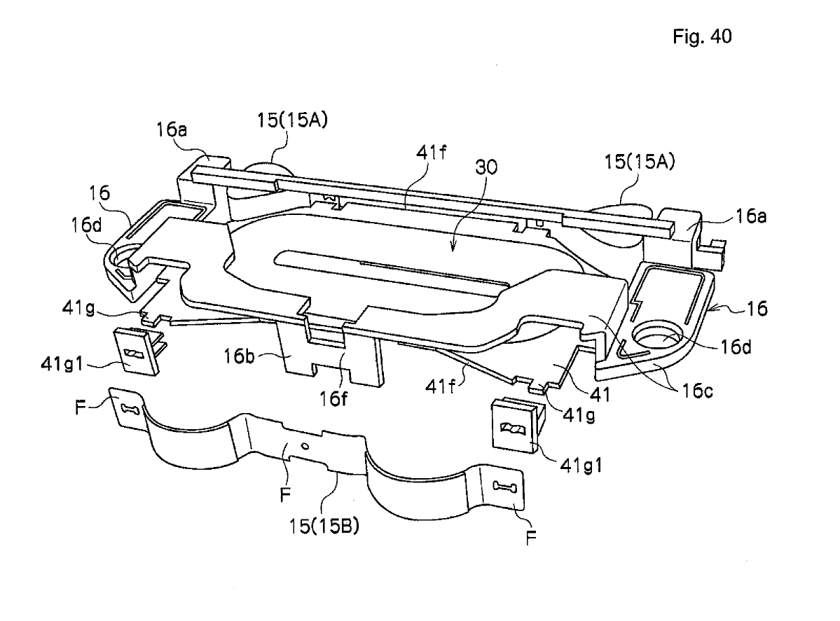

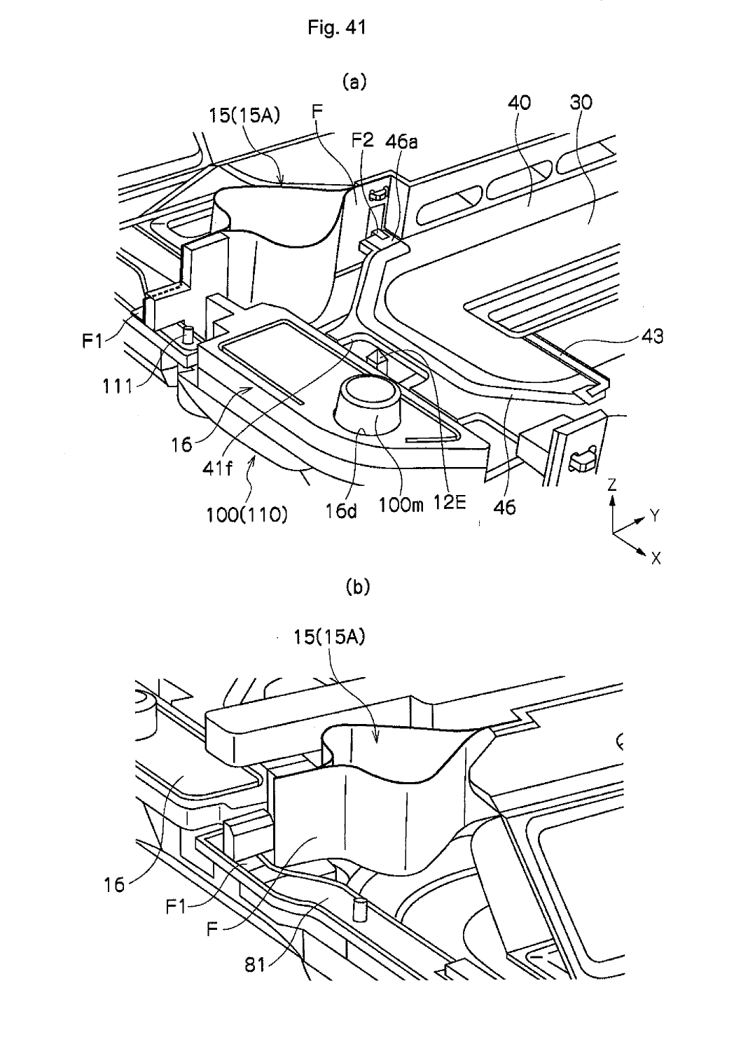

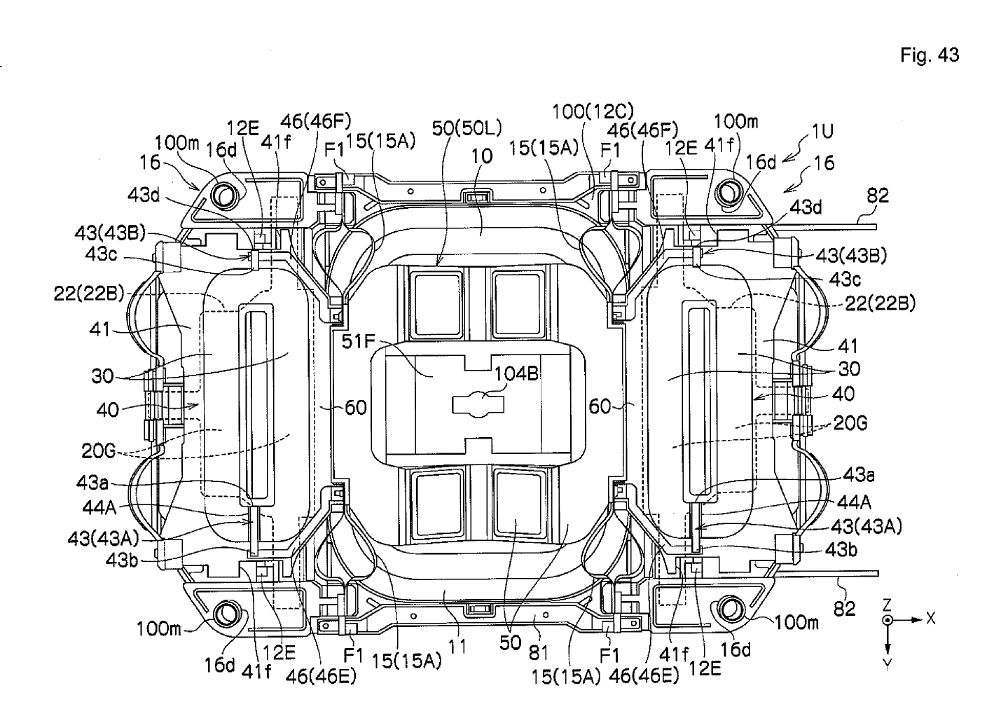

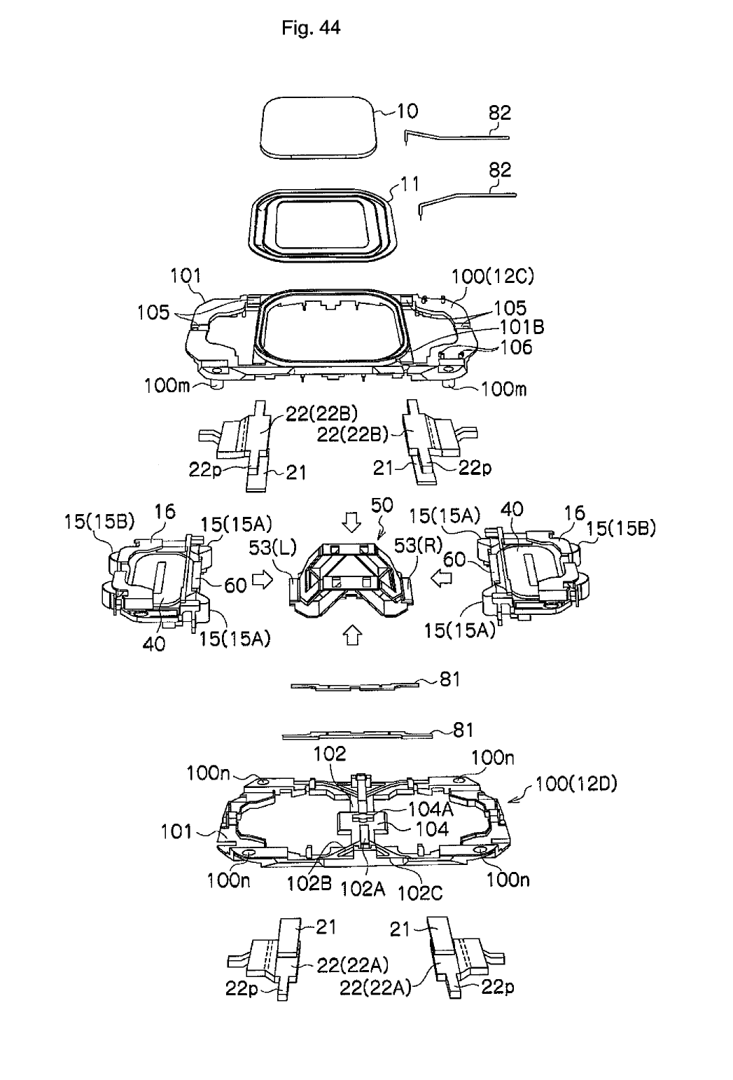

FIGS. 36 to 44 are views illustrating a speaker device 1W according to another embodiment of the present invention (FIG. 36 is a top view, FIG. 37 is a cross-sectional view taken along line X-X, FIG. 38 is a back view, FIG. 39 is a perspective view except a first component member, FIG. 39 is a bottom face view except a second component member, FIG. 40 is exploded perspective views of essential parts, FIGS. 41(a) and 41(b) are partially enlarged cross-sectional perspective views of essential parts, FIG. 43 is a bottom view devoid of the second configuration member and FIG. 44 is an exploded perspective view of the whole speaker device). The same symbols are applied to the same parts as those described above to avoid repeated descriptions. Common parts from the description above are given the same reference numerals and duplicate descriptions are omitted. The vibration direction converter part 50 is applied to the example shown in FIGS. 24 and 25.

According to the example shown in FIG. 36, the diaphragm 10 is formed in a rectangular shape viewed from the sound emission direction, and a curved portion 2A with elliptical outer shape and recessed cross-sectional shape is formed near the central part, and thus the diaphragm 10 has a predetermined bending rigidity in the vibration direction of the diaphragm 10 and the vibration direction of the voice coil 40. Further, with the recessed shaped curved portion 10A formed at the diaphragm 10, density of the curved portion 10A becomes larger than other part of the diaphragm 10 and thereby rigidity may be made comparatively large. Further, when a pair of the vibration direction converter parts 50 are arranged opposite each other, the curved portion 10A is formed between a pair of the hinge parts 52B which are formed between the vibration direction converter part 50 and the diaphragm 10.

Because the diaphragm 10 has rigidity (bending rigidity included) in the vibration direction of the diaphragm, generation of deflection, etc. of the diaphragm 10 may be restrained, and thus generation of difference in phase between sound waves, deterioration of acoustic characteristic, etc. may be restrained. Further, with the curved portion 10A of the diaphragm 10 formed between a pair of the hinges 52B that is formed between the vibration direction converter part 50 and the diaphragm 10, generation of deflection may be restrained.

Further, the diaphragm 10 is formed substantially in a rectangular shape including a short axis extending in the vibration direction of the voice coil 40 and a long axis extending along the direction orthogonal to the vibration direction of the voice coil 40, a reinforcing part (not shown) may be formed in the direction of the long axis or the short axis. The reinforcing part includes a groove part, having, for example, V-shaped cross-section, which is formed linearly, annularly or in a lattice shape in the front face or rear face of the diaphragm 10. For example, filling material such as damping material may be applied to inside of the groove part. As such, with the groove part filled by the filling material, rigidity (bending rigidity included) of the diaphragm 10 may be increased and the peak and dip of sound pressure frequency characteristic of a speaker may be lowered. Further, as another example of the reinforcing part, for example, fiber member made of unwoven fabrics (not shown), etc. may be applied instead of forming the groove part. With the reinforcing part constructed with the fiber member as described above, rigidity (bending rigidity) of the diaphragm 10 may be increased, and thus generation of deformation such as deflection in the diaphragm 10 due to vibration or air resistance transmitted from the vibration direction converter part when the diaphragm 10 vibrates, may be restrained. Further, provided with the reinforcing part, an internal loss of the diaphragm 10 may be improved.

Further, the diaphragm 10 is formed with a first layer constructed with foamed resin including acrylic resin, etc. and a second layer including a fiber member such as a glass fiber, configuring a stacking structure in which the first layer is sandwiched between a pair of the second layers. As a forming material of the diaphragm 10, for example, resin material, metal material, paper material, fiber material, ceramics material, compound material, etc. may be adopted.

The edge 11, vibratably supporting the diaphragm 10 at the frame 12 as the static part 100, is arranged between the diaphragm 10 and the frame 12, and the inner periphery part supports the outer periphery part of the diaphragm 10 while the outer periphery part is connected to the frame 12 directly or via other member, and thus the diaphragm 10 is held at a prescribed position. As other member, elastic member functioning as a packing (including resin member), adhesive resin, etc. are included. More specifically, the edge 11 vibratably supports the diaphragm 10 in the vibration direction (Z-axis direction), and restrains vibration in the direction orthogonal to the vibration direction (Y-axis direction). The edge 11 is formed in a ring shape (annular shape) viewed from the sound emission direction, and the cross-section of the edge 11 is formed in a prescribed shape, for example, a recessed shape, projecting shape, corrugated shape, etc. in the sound emission direction. As the forming material of the edge 11, conventional material, for example, fur, cloth, rubber, resin, a filler-applied member with a material such as fur, cloth, rubber or resin, rubber member or resin member molded in a prescribed shape, may be adopted. Further, in a part or whole circumference of the edge 11, a projection part projecting from the front face (in the sound emission direction), or from the rear face (in the direction opposite to the sound emission direction) or a recessed portion may be formed, rigidity of the edge 11 in a prescribed direction may be increased.

The static part 100 is divided into the first component member 12C and the second component member 12D, and the diaphragm 10 is supported by a central opening part of the first component member 12C via the edge 11. The magnetic circuit 20 can be divided into two parts arranged in the upper side and the lower side of the voice coil 40, and one part of the magnetic circuit in the upper side is supported by the first component member 12C and another part in the lower side is supported by the second component member 12D. In the example shown in the drawing, a yoke part 22B in the upper side of the first component member 12C and a yoke part 22A in the lower side of the second component member 12D are supported so as to be parallel to each other.

The static part 100 includes an outer peripheral frame part 101 surrounding the diaphragm 10 and a bridge part 102 bridging inside of the outer peripheral frame part 101. The bridge part 102 exerts a reaction force on the above link body 50L (vibration direction converter part 50), and has rigidity in the vibration direction of the link body 50L.

As described above, upon vibration of the voice coil 40, the vibration is transmitted to the diaphragm 10 via the link body 50L. At this time, the link body 50L angle converting the link part 51 is subjected to a reaction force exerted by the diaphragm 10. When the link body 50L is subjected to this reaction force, if the static part 100 supporting the link body 50L is deflected, the link body 50L itself vibrates, and thus the link body 50L may transmit unwanted vibration to the link part 51. When the unwanted vibration transmitted to the link part 51 is transmitted to the diaphragm 10, the vibration of the voice coil 40 may not be efficiently transmitted to the diaphragm 10. Accordingly, the bridge part 102, which is a part of the static part 100 supporting the link body 50L, is provided with a function of restraining generation of deflection, and thus unwanted vibration that may be transmitted to the link part and the diaphragm 10 may be restrained. As such, vibration of the voice coil 40 may be efficiently transmitted to the diaphragm 10.

In order that the bridge part 102 supporting the link body 50L may have rigidity against a force exerted by the diaphragm 10 via the link body 50L, compliance of the bridge part 102 may be substantially the same or smaller than compliance of the outer peripheral frame part 101 in the vibration direction of the diaphragm 10. More specifically, thickness of the bridge part 102 may be substantially the same or larger than thickness in a part of the static part 100 supporting the diaphragm 10 or the magnetic circuit 20.

In the example shown in the drawing, the bridge part 102 provided at the second component member 12D has a first projection part 102A projecting in the direction that the bridge part extends and in the vibration direction of the diaphragm 10. This first projection part 102A includes a rib structure formed in a longitudinal direction of the bridge part 102, which increases bending rigidity of the bridge part 102. Further, a second projection part 102B is formed extending in the direction crossing the first projection part 102A, in the plane of the bridge part 102 facing the diaphragm 10. This second projection part 102B acts as a reinforcing rib at both end portions of the bridge part 102, and rigidly supports the bridge part 102 at the outer peripheral frame part 101 by both end portions.

Further, the bridge part 102 has a third projecting part 102C crossing the first projection part 102A and the second projecting part 102B. The third projecting part 102C is formed in the plane of the static part 100 facing the diaphragm 10, and a reinforcing part 103 having polygonal planar shape is formed with a plurality of the second projection part 102B and the third projecting part 102C.

Further, the first component member 12C includes the outer peripheral frame part 101 of the static part 100 as a first outer peripheral frame part 101A, and includes a second outer peripheral frame part 101B supporting the diaphragm 10 inside the first outer peripheral frame part 101A. An opening inside the second outer peripheral frame part 101B is sealed by the edge 11 and the diaphragm 10. A projection part 101B1 projecting in the sound emission direction is formed at the second outer peripheral frame part 101B by which the diaphragm 10 is supported via the edge 11. With this projection part 101B1, rigidity to support the circumference of the diaphragm 10 is obtained.

The first component member 12C and the second component member 12D configuring the static part 100 are formed in a planar shape having a long axis and a short axis, and the bridge part 102 is formed in the short axis direction. Further, the bridge part 102 may be formed in the long axis direction or in the long and short axis directions, and thus rigidity of the static part 100 may be obtained.

Projecting portions 100m are formed at the four corners of the first component member 12C, and recessed portions 100n are formed at the four corners of the second component member 12D. The projecting portions 100m and the recessed portions 100n are fitted such that the first component member 12C and the second component member 12D are coupled. The projecting portion 100m may be formed at one of the first component member 12C and the second component member 12D, and the recessed portion 100n may be formed at the other one of the first component member 12C and the second component member 12D. The recessed portion 100n may be formed to be a hole.

The vibration direction converter part 50 includes a first link part 51A and a second link part 51B as the link body 50L, and one end part of the second link part 51B is supported by the first link part 51A and the other end is supported by the bridge part 102. The bridge part 102 supporting the second link part 51B is formed in a tabular shape, and a connecting part 104, where the other end of the second link part 51B and the bridge part 102 are connected, forms a single plane.

With the other end of the second link part 51B fitted in the bridge part 102, the vibration direction converter part 50 and the bridge part 102 are connected. A projection part 104A is formed at the connecting part 104 of the bridge part 102, and a hole 104B in which the projection part 104A is inserted, is formed at the connecting part 53C integrally formed at the end of the second link part 51B via the hinge part 52.

The projection part 104A of the connecting part 104 in the bridge part 102 acts as a positioning part 102E positioning the vibration direction converter part 50 with respect to the static part 100. The vibration direction converter part 50 is positioned with respect to the static part 100, with the projection part 104A inserted into the hole 104B at the connecting part 53C, which is integrally formed at the end of the second link part 51B via the hinge part 52.

In the condition that the first component member 12C and the second component member 12D as a static part 100 are connected, the fourth link part 51D of the vibration direction converter part 50 is connected to the rear side of the diaphragm 10 supported by the first component member 12C, and the sixth link part 51F of the vibration direction converter part 50 is connected to the connecting part 104 formed at the central part of the bridge part 102 in the second component member 12D.

The s fourth link part 51D is a part integrally formed at the end of the first link part 51A via the hinge part 51B, and the end of the first link part 51A and the diaphragm 10 is connected with this fourth link part 51D connected to the diaphragm 10. A recessed portion is formed at the face of the diaphragm 10 in the sound emission side facing the fourth link part 51D, and the diaphragm 10 has rigidity. The sixth link part 51F is a part integrally formed at the end of the second link part 51B via a hinge part 51B, and the hole 104B is formed at the sixth link part 51F. The projection part 104 is inserted into the hole 104B, and thereby the connecting part 104 and the end portion of the second link part 51B are connected.

The connecting part 60 is attached to one end part of the base 41 of the voice the coil 40 in the vibration direction so that the connecting part 60 extends along the width of the base 41 of the voice coil 40. The connecting part 60 includes a connection step part 60s to which a connecting part 53 of the vibration direction converter part 50 is detachably connected and a through hole 60p passing through in the vibration direction of the base 41 of the voice coil 40. The through hole 60p is a vent hole reducing air resistance exerted on the connecting part 60 in response to vibration of the voice coil 40.

The connecting part 60 connects the connecting part 53 of the vibration direction converter part 50 and the end part of the voice coil supporting part 41 (base) at an interval from each other, and thus the thickness of the magnetic circuit 20 can be included in the thickness of the vibration direction converter part 50.

The base 41 of the voice coil 40 and the connecting part 60 are held to the first component member 12C and the second component member 12D with the holding part 15. The holding part 15 includes the first holding part 15A and the second holding part 15B formed with a curved plate member allowing deformation of one direction in the vibration direction of the voice coil 40 while regulating deformation in other direction. The first holding part 15A and the second holding part 15B hold the base 41 of the voice coil 40 to the first component member 12C and the second component member 12D via the attachment unit 16. The first holding part 15A holds the connecting part 60 to one side part of the attachment unit 16, and the inside end parts of the first holding parts 15A provided respectively at the left side and right side are connected to both outside end parts of the connecting part 60, and each of outside end parts of the first holding parts 15A is attached to the attachment unit 16 respectively.

The first holding part 15A is formed with conducting property metal, and is electrically connected to the voice coil lead wire 43 pulled out of the conducting member 30 of the voice coil 40 via a conducting layer 46, and an audio signal is supplied to the conducting member 30 of the voice coil 40 via the first holding part 15A. Further, the first holding part 15A is electrically connected to linear terminal parts 81, 81 supported by the frame 12 and is electrically connected to the outside via wires 82, 82 electrically connected to the terminal parts 81, 81 respectively.

The central part of the second holding part 15B is connected to another side part of the attachment unit 16, and both end parts of the second holding part 15B are connected to left and right end parts of the voice coil supporting part 41 (base). In this example, the second holding part 15B is arranged within the width of the voice coil supporting part 41 (base), such that a holding body of the voice coil supporting part 41 (base) take up little space in the width direction of the voice coil supporting part 41 (base). Further, the second holding part 15B is formed with a continuous member, having a continuous shape in the central part. However, the second holding part 15B may be formed with a plurality of members and is not limited to being formed with a continuous member. A part of the second holding part 15B is arranged projecting from the static part 100 toward outside, but not limited to this arrangement and may be modified so as to fit inside the static part 100.

FIG. 40 is an exploded perspective view of attachment of the attachment unit 16 to the second holding part 15B seen from an angle. The second holding part 15B and the attachment unit 16 as unitized parts are connected to each other via adhesive resin. Tabular portions F, F at left and right end parts of the second holding part 15B are connected to connecting parts 41g, 41g at left and right end parts of end edge 41f arranged in the vibration direction of the voice coil supporting part 41 (base) via connecting components 41g1, 41g1 respectively, and a flat portion F at the center of the second holding part 15B is connected to a connecting end part 16f of the attachment unit 16. The end edge 41f of the voice coil supporting part 41 (base) in the side opposite to the side of the vibration direction converter part of the voice coil supporting part 41 (base) is formed in a recessed shape toward the voice coil 40, and the voice coil supporting part 41 (base) vibrates in response to vibration of the voice coil 40, and the voice coil supporting part 41 (base) is planarly formed preventing contact with the attachment unit 16. Specifically, a comparatively large gap is formed between the connecting end part 16f of the attachment unit 16 and the end edge 41f of the voice coil supporting part 41 (base), and the voice coil supporting part 41 (base) is planarly formed, projecting toward the second holding part 15B as getting closer to the flat portions F at left and right end parts of the second holding part 15B. Further, hole parts, in which connecting parts 41g at both end parts of the other end edge 41f of the voice coil supporting part 41 are inserted, are formed at the flat portions F at both end parts of the second holding part 15B.

To input an audio signal to the voice coils 40, 40 corresponding to a plurality of the driving parts 14, a pair of terminal parts 81, 81 common to a plurality of the voice coils 40, 40, extending from one voice coil 40 to another voice coil 40 of the plurality of the voice coils 40, 40, is provided at the static part 100. Further, the terminal parts 81, 81 are arranged in an opening part (not shown) formed between the first component member 12C and the second component member 12D constituting the frame 12 being the static part 100. In such a configuration, arrangement of the terminal part can be space saved compared to the arrangement where terminal parts are provided on both end parts of voice coil 40 respectively, thus the speaker device can be made compact or thin. Further, the terminal parts 81, 81 can be stably fixed to the static part 100, preventing bad connection to the voice coils 40, 40. Further, the terminal parts 81, 81 are formed in a shape including a long axis extending from one voice coil 40 to another voice coil 40 and a short axis intersecting the long axis. With this longitudinal shape, efficiency of installation space of the terminal parts can be increased.

A connecting part 81a to wires 82, 82 (second wire) connected to the outside is formed in the terminal parts 81, 81, and the terminal parts 81, 81 are electrically connected to the wires at the connecting parts 81a. The wires 82 (second wire) are fixed to the side face of the static part 100 and are connected to the terminal parts 81, 81. An outer peripheral frame part 101 of the static part 100 includes a side face to which the wire 82 is attached, and guiding parts 106, 106 guiding the wire 82 are formed in the side face of the static part 100.

The conducting layer 46, connected to the voice coil lead wire 43 pulled out of the end part of the conducting member 30, is formed on the voice coil supporting part 41 (base) supporting the conducting member 30 of the voice coil 40. The conducting layer 46 is pattern formed on the voice coil supporting part 41 (base), surrounding the conducting member 30 of the voice coil 40, and the conducting layer 46 electrically connects the conducting member 30 of the voice coil 40 to the holding part 15.

A wire, electrically connecting the conducting member 30 of the voice coil 40 to the terminal part 81 is formed in the holding part 15, and the end parts of the terminal parts 81, 81 are electrically connected to the wire, the wire of the holding part 15 is connected to the voice coil lead wire 43, the wire 82 is connected to the terminal parts 81, 81, and thereby an audio signal is inputted from the outside to the conducting member 30 of the voice coil 40.

A connecting parts F1 connecting to the terminal parts 81, 81 are formed in the holding part 15. The connecting parts F1 extend in a direction intersecting the vibration direction (X axial direction) of the diaphragm 10 and are formed in a tabular shape so as to contact the terminal parts 81, 81. Also, a connecting part F2, connecting to the conducting layer 46 is formed in the holding part 15, extending in a direction intersecting the vibration direction (X axial direction) of the diaphragm 10, and is formed in a tabular shape so as to contact the end part of the conducting layer 46.

FIG. 41 is a partially enlarged view seeing FIG. 39 from a different direction, and FIG. 41 (a) particularly shows that one connecting face F2 of the first holding part 15A is connected to a connecting terminal part 46a of the conducting layer 46. FIG. 41 (b) particularly shows that another connecting face F1 of the first holding part 15A is connected to the terminal part 81. The connecting face F1 at one end side of the first holding part 15A is connected to the terminal part 81, and the connecting face F2 at another end side of the first holding part 15A is connected to the voice coil lead wire 43 via the connecting terminal part 46a of the conducting layer 46. The terminal part 81 electrically connects one end parts of the pair of the first holding part 15A to the wire 82 (outside), and an audio signal inputted from the wire 82 is supplied to the voice coil lead wire 43 via the terminal part 81 and the first holding part 15A. The terminal part 81 is formed with a rod shaped conducting member, having a positioning hole, and is positioned at the specific point of the static part 100 with a positioning protrusion part 111 provided at the static part 100 being inserted into the positioning hole. Insulating is applied to a part of the terminal part 81, and the surface of the conducting member in the region connecting to the connecting face F1 of the first holding part 15A is exposed, enabling an electrical connection to the first holding part 15A. Further, the terminal part 81 may be formed with a member including an insulating property such as a resin member, etc. (insulating member), and a conducting member may be provided on the insulating member, thereby electrically connecting to the connecting face F1 of the holding part 15.

The attachment unit 16 includes a first connecting part 16a to which the end part of the first holding part 15A is connected, being provided at left and right sides of the connecting part 60, and a second connecting part 16b to which the second holding part 15B is connected, being provided at the back of the voice coil 40, and a unitized supporting part 16c integrally supporting the first connecting part 16a and the second connecting part 16b. Also, the attachment unit 16 includes at the four corners connecting hole parts 16d opposing projecting parts 100m provided at the first component member 12C of the static part 100. The projecting part 100m is inserted into a recessed part 100n of the connecting hole part 16d and the second component member 12D, thereby the voice coil supporting part 41 (base), the connecting part 60, the holding part 15 and the attachment unit 16 are unitized and fixed between the first component member 12C and the second component member 12D.

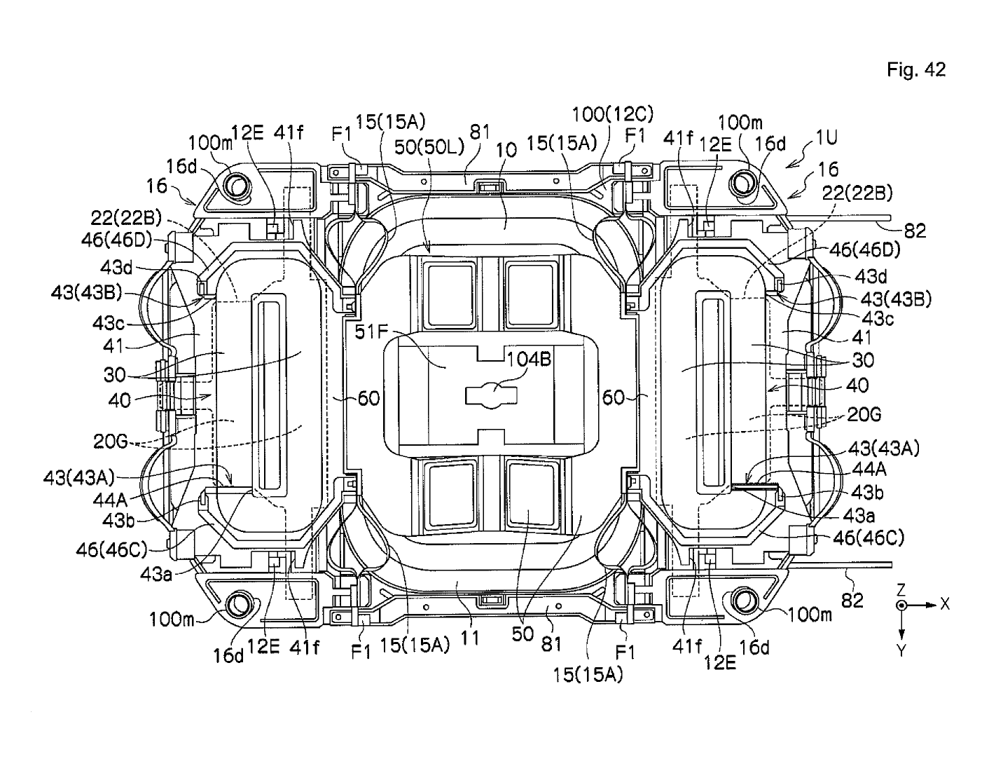

Then, the voice coil lead wire 43 of the voice coil 40 is pulled out of the conducting member 30 as shown in FIG. 42, and at least a part of the voice coil lead wire 43 is arranged outside the magnetic gap 20G. Further, the outer shape of the yoke part 22B is shown by dotted lines, and a region surrounded by the dotted lines shows a magnetic space formed between the yoke parts 22A and 22B, and a pair of the magnetic gaps 20G are formed in the magnetic space with a part of the conducting member 30 arranged therein.

In the example shown in the drawing, the annular conducting member 30 is supported on the surface of the base 41, and a pair of the voice coil lead wires 43A, 43B are pulled out of the inner periphery part and the outer periphery part in the X axial direction, i.e. the vibration direction of the voice coil 40 respectively. A pair of the conducting layers 46C, 46D are pattern formed on the outside surface of the conducting member 30 in the base 41, surrounding the conducting member 30, and the end parts of the pair of the voice coil lead wires 43 are connected to the conducting layers 46C, 46D respectively. That is, one voice coil lead wire 43A includes an inside lead part 43a arranged at the inner periphery part of the conducting member 30 and a connecting part 43b connecting to one conducting layer 46C, and another voice coil lead wire 43B includes an outside lead part 43c arranged at the outer periphery part of the conducting member 30 and a connecting part 43d connecting to another conducting layer 46D, and these voice coil lead wires 43A, 43B from the lead parts 43a, 43b to the connecting parts 43c, 43d are arranged outside the magnetic gap 20G. Further, one voice coil lead wire 43A is arranged along the surface of the conducting member 30, and a insulating sheet 44A is provided between the one voice coil lead wire 43A and the conducting member 30 to insulate between the one voice coil lead wire and the conducting member.

Further, the first component member 12C or the second component member 12D as the static part 100 includes a plurality of projection parts projecting toward the voice coil 40. A plurality of the projection parts are formed as an excessive-vibration restraining parts 12E regulating the vibration range of the voice coil 40, thus preventing excessive-vibration. Also, a notch part 41f is formed at the end edge of the base 41 in the vibration direction of the voice coil 40. The excessive-vibration restraining part 12E is arranged inside the notch part 41f, and the width of notch part 41f in the vibration direction of the voice coil 40 is substantially amplitude of vibration of the voice coil 40. When the voice coil 40 excessively vibrates, the excessive-vibration restraining part 12E contacts the base 41 of the voice coil 40, thereby regulating vibration range of the voice coil 40, preventing the excessive-vibration. In the example of the drawings, the excessive-vibration restraining part 12E is formed with a protrusion part of the first component member 12C. However, the excessive-vibration restraining part 12E is not limited to the above example, for example, may be formed with a protrusion part covered with a tube formed with silicone resin to prevent occurrence of abnormal noise when contacting the voice coil 40, and may be altered as necessary.

To drive a speaker by a comparatively large driving force, the width of the magnetic gap 20G may be made comparatively small and density of magnetic flux in the magnetic gap 20G may be increased as much as possible. However, the voice coil 40 generating vibration is required to be arranged in the magnetic gap 20G, which needs space corresponding to the thickness of the voice coil 40 and an interval simply preventing the voice coil 40 from contacting the magnetic body constituting the magnetic gap 20G (magnet or yoke part of the magnetic circuit 20). Further, to input an audio signal to the voice coil 40 the voice coil lead wire 43 needs to be provided, and thus the thickness of the voice coil lead wire needs to be considered. Therefore, the width of the magnetic gap 20G needs to be comparatively increased. However, in the speaker device 1U, the voice coil lead wire 43 is arranged outside the magnetic gap 20G, and thus the width 20G of magnetic gap can be narrowed and density of magnetic flux can be increased. Also, when the voice coil lead wire 43 is formed with the part of conducting member 30, that is, an electric wire, the change in shape over time may occur such that the part of conducting member 30 is uplifted from the surface of the voice coil 40. In this case, the voice coil lead wire 43, if arranged in the magnetic gap 20G, may contact the magnetic body such as the magnet 21, the yoke parts 22A, 22B, etc. constituting the magnetic circuit. However, in the speaker device 1U, the voice coil lead wire 43 arranged outside the magnetic gap 20G, can be prevented from contacting the magnetic body.

When the voice coil 40 vibrates excessively, the excessive-vibration restraining part 12E contacts the base 41, thereby excessive-vibration of the voice coil 40 can be prevented. In the example shown in the drawings, the excessive-vibration restraining part 12E is formed with the protrusion part of the first component member 12C. The excessive-vibration restraining part 12E is not limited to the above example, and, for example, may be formed with a protrusion part covered with a tube formed with silicone resin preventing occurrence of abnormal noise when contacting the voice coil 40, and may be altered as necessary.

Further, the magnetic circuit 20 of the speaker device 1U includes two magnetic gaps 20G different in density of magnetic flux in the vibration direction (X axial direction) of the voice coil 40, and the voice coil lead wire 43 is arranged in the proximity of one magnetic gap 20G where density of magnetic flux is smaller. In the example shown in FIG. 42, the areas of the magnet and the yoke part of the magnetic circuit 20 with respect to the conducting member 30 of the voice coil 40 are made smaller in the outside than in the inside in the X axial direction, and thus density of magnetic flux is made smaller, and the voice coil lead wires 43A, 43B are arranged toward outside in the X axial direction. As such, an electromagnetic force exerted on the voice coil lead wires 43A, 43B can be made comparatively small, thereby generation of unwanted vibration in the voice coil 40 can be prevented.

Further, in the example shown in FIG. 42, the voice coil lead wires 43A, 43B are pulled out in the X axial direction similar to the vibration direction of the voice coil 40, but the direction is not limited to the above example, for example, as shown in FIG. 41, the voice coil lead wires 43A, 43B may be pulled out in the Y axial direction intersecting the vibration direction of the voice coil 40, and the connecting parts 43c, 43d may be connected to the conducting layers 46E, 46F. In this configuration, the conducting layers 46E, 46F can be shortened having little circumvention like the conducting layers 46C, 46D shown in FIG. 42.

Further, the vibration direction converter part 50 is connected to an attaching counterpart 200 including the diaphragm 10 or the voice coil 40, or including a member other than the diaphragm 10 or the voice coil 40 with, for example, a connecting member such as adhesive, a double faced tape, or a fastening member such as a screw member, etc., and a joint part 52 is arranged near the attaching counterpart 200. A contact avoiding part 70, preventing the attaching counterpart 200 from contacting the joint part 52, is provided in the face side of the attaching counterpart 200 in the proximity of the joint part 52 of the vibration direction converter part 50. Also, the contact avoiding part 70 functions as a joining member restraining part restraining the joining member connecting the vibration direction converter part 50 to the attaching counterpart 200. For example, the contact avoiding part 70 is a recessed part, a notch part, a groove part, etc. formed in a recessed shape along the joint part 52, forming a predetermined space between the joint part 52 and the surface of the attaching counterpart 200 provided in the proximity of the joint part 52, thereby preventing the adhesive member applied between the vibration direction converter part 50 and the attaching counterpart 200 from interrupting the joint part 52. In the example shown in FIG. 37, a recessed part 71 is formed as the contact avoiding part 70 at the third link part 51C of the vibration direction converter part 50 in the proximity of the joint part 52A, the third link part 51C as the attaching counterpart 200. A recessed part 72 is formed as the contact avoiding part 70 at the diaphragm 10 in the proximity of the joint part 52B. A recessed part 76 is formed as the contact avoiding part 70 at the fourth link part 51D in the proximity of the joint part 52F. With this configuration, when a part of the vibration direction converter part 50 or the vibration direction converter part 50 and the end face of the diaphragm 10 are joined with a joining member such as adhesive or a double-face tape, the adhesive or the end part of the double-face tape running off toward the joint parts 52 entering into the recessed parts 71, 72, and 76 and are prevented from contacting and adhering to the joint part 52.

Also, the contact avoiding part 70 can be used as a receiving part receiving the adhesive. Each of the joint parts of the vibration direction converter part 50 can be formed with a bendable or foldable continuous member. Also, each of the link parts of the vibration direction converter part 50 can be formed with a rigid member. Also, each of the joint parts and a rigid part continuing from the joint part can be integrally molded. Each of the link parts is formed with a rigid member and each of the joint parts formed at both end parts of the link part is formed with a bendable continuous member continuing between parts in both sides across the joint part. As an example of the continuous member, woven fabric made of high-strength fiber, unwoven fabric, resin film formed with resin member, etc. can be listed. Also, as an example of the rigid member, a light-weight, moldable material having rigidity after hardening is possible, and thermoplastic resin, thermosetting resin, metal, paper, etc. can be listed. Technology relating to the vibration direction converter part 50 is described in the publication of PCT/JP2009/053752 internationally filed on Feb. 27, 2009, which is incorporated in the present application by reference.

FIG. 44 is an explanatory diagram showing the assembly of the whole speaker device. When assembling the speaker device 1T, inserting each of the connecting part 53(R), 53(L) of the vibration direction converter part 50 into the connecting part 60 thereby integrates the vibration direction converter part 50, the voice coil 40, the connecting part 60, the holding part 15 (the first holding part 15A, the second holding part 15B), and the mounting unit 16 into one body, the voice coil 40 and the connecting part 60 and the holding part 15 and the mounting unit 16 have been pre-assembled as a unit. As the yoke part 22B in the upper side of the magnetic circuit 20 are arranged in the upper side of the voice coil and the yoke part 22A in the lower side of the magnetic circuit 20 are arranged at the lower of the voice coil respectively, the voice coil 40 is sandwiched between the first component member 12C and the second component member 12D. With this configuration, the stationary sixth link part 51F of the vibration direction converter part 50 fits into the support base 13A which is formed at the bottom part of the second component member 12D, and is supported such that the sixth link part is unmovable. Other parts of the attachment unit 16 etc., are positioned at a prescribed position with respect to the first component member 12C and the second component 12D. Further, the attachment unit 16 is fixed at a prescribed position with respect to the static part 100 by inserting the projecting parts 100m, provided at the first component member 12C of the static part 100, into the connecting hole parts 16d constructed in the four corners of the attachment unit 16.

In the example shown in the drawings, first, the yoke part 22B in the upper side of magnetic circuit 20 is mounted with respect to the inner face of the first component member 12C and the attachment unit 16 and the vibration direction converter part 50 are mounted in order and positioned. Thereafter, as the yoke part 22A in the lower side of the magnetic circuit 20 is mounted, the second component member 12D is superimposed, sandwiching each of the components. Accordingly, by inserting the projecting part 100m formed in the first component member 12C into the positioning hole part 16d of the attachment unit 16 and inside the recessed part 100n of the second component member 12B, the voice coil support part 41 (the base), the connecting part 60, the holding part 15 and the attachment unit 16 are fixed between the first component member 12C and the second component member 12D. Finally, at the same time the second connecting part 53B of the vibration direction converter part 50 and the diaphragm 10 are joined together by an adhesive bonding member, the outer periphery part of the diaphragm 10 is attached to the rim part of the central opening part of the first component member 12C, via the edge 11. In an assembled state, by forming an interval between the first component member 12C and the upper side yoke part 22B arranged in the proximity of the first component part 12C, the vibration of the diaphragm 10 is transmitted to the magnetic circuit 20 via the upper side yoke part 22B, thereby preventing contact between the magnetic circuit 20 and the voice coil 40.

Further, the assembly process may be performed as follows. First, the wires 82 are connected to the connecting terminals 81, 81 and the magnet 21 is connected to the yoke part 22. Subsequently, the connecting terminals 81, 81 with the wire 82 connected, are attached to the outer peripheral frame part 101A of the first component member 12C. Subsequently, the pair of attachment units 16 to which the above described voice coil 40 is attached are attached to the first component member 12C. At this time, the connecting terminals 81, 81 and the holding part 15A attached to the attachment unit 16, are electrically connected by employing a solder, etc. Subsequently, the vibration direction converter 50 is attached to the connecting part 104, connecting the vibration direction converter part 50 and the voice coil 40. Next, the second component member 12D is arranged on the first component member 12C; and the magnetic pole member (yoke part) 22 joined with the magnet 21 connected is attached to the outer peripheral frame part 101A of the second component part member 12D. Next, the diaphragm 10 and the edge 11 are attached to a second outer peripheral frame part 101B of the first component member 12C. Subsequently, the magnetic pole member (yoke part) 22 with the magnet 21 connected is attached to the first outer peripheral frame part 101A of the first component member 12C. Finally, the wire 82 is attached to the guiding part 106 which is provided at the first outer peripheral frame part 101A of the first component member 12C.

The frame 12 as the static part 100 is provided with the first component member 12C (the first frame) and the second component member 12D (the second frame) as described above. The first component part member 12C is arranged in the sound emission side of the speaker device 1U and the second component member 12D is arranged in the opposite (rear surface) of the sound emission side. The driving part 14 of the speaker device 1 is supported such that it is sandwiched between the first component member 12C and the second component member 12D.

The outer peripheral frame part 101 of the first component member 12C, formed in an annular shape, supports one side (22B) of the magnetic pole member (yoke part) 22 of the magnetic circuit 20. In contrast, the second component member 12D includes the outer peripheral frame part 101 and the bridge part 102 and supports the other side (22A) of the magnetic pole member (yoke part) 22 of the magnetic circuit 20.

The first component member 12C and the second component member 12D provide a recessed receiving part 105 housing a part of the yoke part 22. A projection part 22p is fitted into this receiving part 105, positioning the yoke part 22 in order to form the appropriate magnetic gap. Further, in the second component member 12D, an opening part 101S is formed between the outer peripheral frame part 101 and the bridge part 102. In the outer peripheral frame part 101, a fourth protrusion part (not shown) is formed along the outer periphery edge of the opening part 101S. The fourth protrusion part increases the torsional rigidity of the outer peripheral frame part 101.

In addition, an excessive vibration restraining part (not shown) suppressing the excessive vibration of the voice coil 40, is formed in the first component member 12C. The excessive vibration restraining part protrudes into the movable space of the voice coil 40. With this, the voice coil support part 41 (base) contacts the excessive vibration restraining part, thereby excessive vibration of the voice coil 40 is suppressed.

The magnetic circuit 20 with the magnetic pole member 22 and the magnet connected, is attached to the first component member 12C and the second component member 12D. There are a plurality of projection parts 22p provided in the magnetic pole member 22, and these projection parts 22p are supported by the receiving part 105. The width of the yoke part 22, which is a plate-shaped magnetic body, is narrower than the width from the vibration direction converter part 50 to the static part 100, thereby preventing the holding part 15 from contacting with the yoke part 22.

The yoke parts 22A and 22B are attached to the first component member 12C and the second component member 12D; the first component member 12C and the second component member 12D are connected, thereby providing an interval as the magnetic gap 20G, between the yoke parts 22A, 22B or between the magnets 21. This forms the magnetic circuit 20.

According to this embodiment, the height of the magnetic circuit 20 is substantially the entire height of the whole device. The construction is such that the voice coil 40 vibrates in the proximity of the center of the magnetic circuit 20 and the end part of the voice coil 40 and the end part of the vibration direction converter part 50 are, via the connecting part 60, connected at different heights. With this configuration, enough length can be secured within the height of the device for each link part of the vibration direction converter part 50; and, it becomes possible to include a portion of the height of the magnetic circuit 20 within the height of the vibration direction converter part 50.

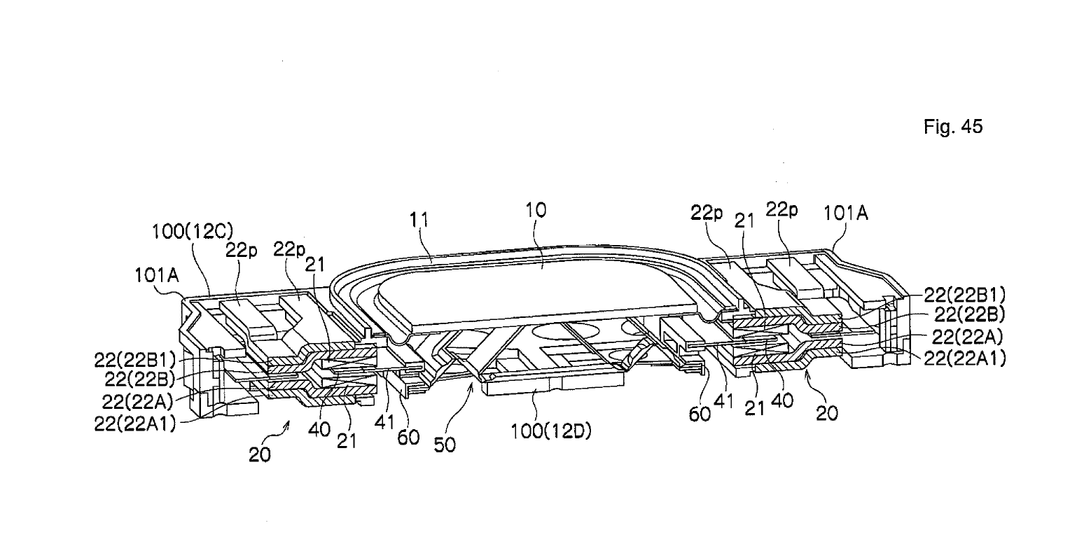

FIG. 45 shows a modification of the speaker device according to an embodiment of the present invention. Common parts from the description above are given the same reference numerals and duplicate descriptions are omitted. In this modification example, the yoke parts 22 formed with plate-shaped magnetic bodies are stucked. The yoke parts 22B, 22B1 formed with two stacked sheets of a magnetic body are supported in the side of the first component member 12C supporting the diaphragm 10. The yoke parts 22A, 22A1 formed with the two stacked sheets of a magnetic body are supported in the side of the second component member 12D. The magnetic gaps of the magnetic circuit 20 are formed between the magnets 21, 21 and between the neighboring yoke parts 22A, 22B.

Accordingly, the speaker device according to embodiments or examples of the present invention can be made thin and can make louder sound. Further, a thin speaker device capable of emitting louder reproduced sound with a comparatively simple structure can be realized by vibrating the diaphragm in a direction different from the vibration direction of the voice coil. When converting the vibration direction of the voice coil to a different direction by using a mechanical link body, durability of the hinge part of the link body that can tolerate the high-speed vibration specific to a speaker device and flexibility that can restrain generation of abnormal sound during high-speed vibration, may be required. According to the configuration of the speaker device described above, the hinge part of the link body can have the durability and flexibility.

Further, in order to direction convert the vibration of the voice coil and transmit the vibration of the voice coil to the diaphragm, it is necessary to efficiently and accurately reproduce the vibration of the voice coil, and thus it may be necessary to prevent the link body from being deformed and make the link body itself light. In addition, it may be necessary to easily incorporate the link body into the speaker device and easily manufacture the link body itself. According to the configuration of the speaker device described above, a speaker device, which is light weight and easy to manufacture, can be realized.

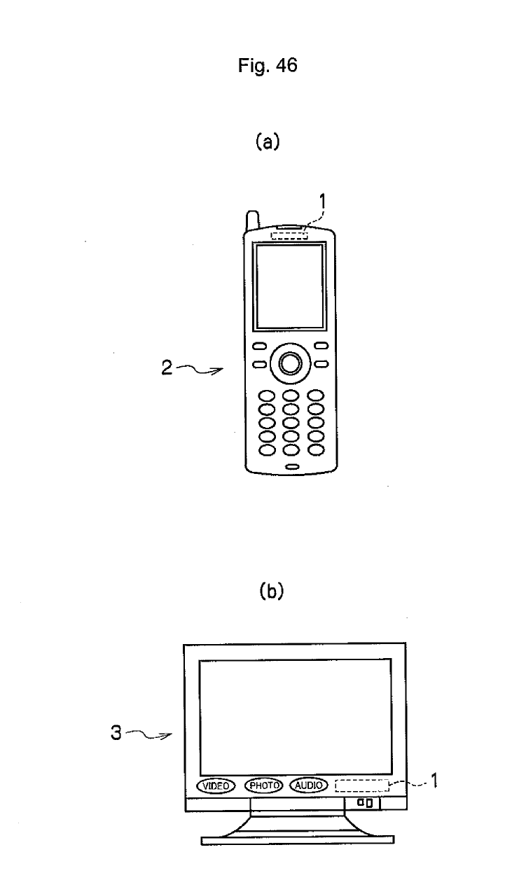

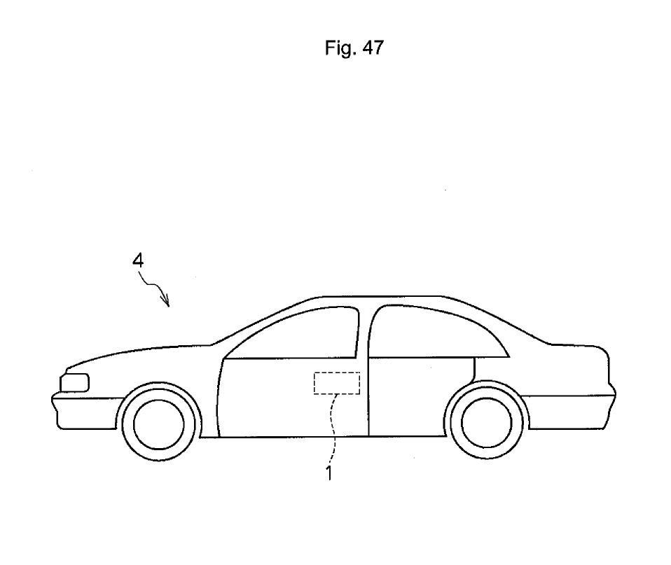

This speaker device can be efficiently used as various types of electronic devices or in-car devices. FIG. 46 is a view illustrating an electronic device including a speaker device according to an embodiment of the present invention. In an electronic device 2 such as a mobile phone or a handheld terminal shown in FIG. 46 (a) or an electronic device 3 such as a flat panel display shown in FIG. 46 (b), a speaker device is housed in the housing, which act as the attaching counterpart provided at the electronic device 3. And the speaker device 1 is attached to the side face of the housing as the attaching counterpart of the electronic device. Even if this case, because installation space in thickness direction required for installing the speaker device 1 may be decreased, the whole electronic device may be made thin. Further, a sufficient audio output may be produced even by the electronic device made thin. FIG. 47 is a view illustrating an automobile provided with a speaker according to an embodiment of the present invention. In an automobile 4 shown in FIG. 47, in-car space may be widened with the speaker device 1 made thin. More particularly, the speaker device 1 according to the embodiment of the present invention, even if attached to a door panel, ceiling, rear tray or a dashboard as the attaching counterpart, may comparatively reduce a bulge projecting into a door panel, ceiling, and thus enabling to widen space for a driver to operate or space inside room. Further, with sufficiently produced audio output, it is possible to enjoy listening to music or radio broadcasting pleasantly in a car even when driving on a noisy highway.

Further in a resident building including the speaker device 1, a hotel, an inn or a training facility as a building including a speaker device, when the speaker device 1 is provided on a wall or ceiling as the attaching counterpart, installation space in thickness direction required for the speaker device 1 may be reduced and thus enabling to save space in a room and make effective use of space. The hotel is capable of holding an event and accommodating many guests for conference, meeting, lecture, party, etc. Further, providing a room equipped with audiovisual equipment can be seen in recent years along with prevalence of a projector or a big-screen TV. On the other hand, there is also seen a living room, etc. used as a theater room without room equipped with audiovisual equipment. Also in this case, the living room, etc. can be easily converted to a theater room with the speaker device 1 while making effective use of space in the living room. More particularly, the placement at which the speaker device 1 is arranged may be, for example, ceiling or wall, etc. (attaching counterpart).

Although the embodiments according to the present invention are described with reference to the drawings, specific configurations are not limited to these embodiments, and modifications not departing from the subject matter of the present invention are included in the scope of the present invention.

Further the technologies of each embodiment described above can be applied as necessary to a dynamic speaker device employing a tabular voice coil (example: Ryffel-type speaker device, ribbon-type speaker device, speaker device arranging magnetic pole parts in the sound emission side and in the opposite of the sound emission side of the tabular voice coil), thereby the speaker device can be made thin. In addition, PCT/JP2008/051197 filed on Jan. 28, 2008, PCT/JP2008/068580 filed on Oct. 14, 2008, PCT/JP2008/069480 filed on Oct. 27, 2008, PCT/JP2008/069269 filed on Oct. 23, 2008, PCT/JP2009/053752 filed on Feb. 27, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009, and PCT/JP2009/055528 filed on Jul. 9, 2009, the entirety of which is incorporated by reference into the present application.

1. A voice coil for speaker device, which transmits vibration in one axial direction of said voice coil to a diaphragm via a rigid vibration direction converter part connecting said voice coil and said diaphragm and vibrates said diaphragm in a direction different from the one axial direction, wherein
said voice coil includes a conducting member that is planarly and annularly wound, and has rigidity at least in the vibration direction in the planar direction.

2. The voice coil for speaker device according to claim 1, wherein said voice coil has rigidity by being supported by a base having rigidity.

3.-11. (canceled)

12. The voice coil for speaker device according to claim 2, wherein a conducting layer is pattern formed at the outer surface of said base in the outside of the conducting member.

13. The voice coil for speaker device according to claim 12, wherein a pair of said conducting layers is arranged so as to surround said conducting member and functions as a junction wire inputting an audio signal into said conducting member.

14. The voice coil for speaker device according to claim 12, wherein said conducting layer is formed annularly.

15. The voice coil for speaker device according to claim 14, wherein a plurality of said conducting layers is pattern formed in the vibration direction of said voice coil at both sides of said conducting member.

16. The voice coil for speaker device according to claim 15, wherein one of the plurality of said conducting layers is formed in a closed shape and another is formed in an open shape.

17. The voice coil for speaker device according to claim 16, wherein one of said conducting layers is a short ring layer, and
the width of said short ring layer is configured to be substantially the same or smaller than the width of said conducting member.

18.-20. (canceled)

21. A speaker device comprising: a driving part including the voice coil for speaker device according to claim 1 and a magnetic circuit vibrating said voice coil;
a diaphragm to which the vibration of said driving part is transmitted in response to an audio signal;
and a static part supporting said driving part and said diaphragm; wherein
said driving part includes a vibration direction converter part that angle converts the vibration of said voice coil and transmits the vibration to said diaphragm, and
said vibration direction converter part includes a rigid link part that is provided slantwise with respect to each of the vibration direction of said diaphragm and the vibration direction of said voice coil.

22. The speaker device according to claim 21, wherein said voice coil is planarly formed in an elongated shape that is longer in the direction orthogonal to the vibration direction of the voice coil.

23.-24. (canceled)

25. The speaker device according to claim 21, wherein said static part is provided in the side opposite to the side of said diaphragm with reference to said vibration direction converter part, and
said vibration direction converter part includes a link body angle converting a link part that is disposed between said voice coil and said diaphragm.

26. The speaker device according to claim 21, wherein one end part of said vibration direction converter part is angle-variably connected with said driving part directly or via other member, and another end part is angle-variably connected with said diaphragm directly or via other member, and
said vibration direction converter part is disposed slantwise with respect to each of the vibration direction of said diaphragm and moving direction of said driving part.

27.-44. (canceled)

45. The speaker device according to claim 21, wherein said voice coil has rigidity by being supported by a rigid base, and
a plurality of conducting layers is pattern formed at the surface of said base in the outside of said conducting member.

46. (canceled)

47. A speaker device comprising:
a driving part that includes a voice coil with rigidity at least in the vibration direction having an annularly wound conducting member, and a magnetic circuit vibrating said voice coil;
a diaphragm to which the vibration of said driving part is transmitted in response to an audio signal; and
a static part supporting said driving part and said diaphragm; wherein
said driving part includes a rigid vibration direction converter part that angle converts the vibration of said voice coil and transmits the vibration to said diaphragm, and
one end part of said vibration direction converter part is angle-variably connected with said voice coil directly or via other member and another end part of said vibration direction converter part is angle-variably connected with said diaphragm directly or via other member,
said rigid link part being provided slantwise with respect to each of the vibration directions of said diaphragm and said voice coil.

48. The speaker device according to claim 47, wherein a static part is provided as said frame, and
said vibration direction converter part includes a link body angle converting said link part with the vibration of said voice coil and a reaction force receiving from said static part.

49. A speaker device comprising:
a driving part including a voice coil for speaker device according to claim 1 and a magnetic circuit vibrating said voice coil;
a diaphragm to which the vibration of said driving part is transmitted in response to an audio signal; and
a static part supporting said driving part and said diaphragm; wherein
a conducting member of said voice coil for speaker device is arranged in a magnetic gap of said magnetic circuit, and
a voice coil lead wire of said voice coil is pulled out of said conducting member, and
at least a part of said voice coil lead wire is arranged at the outer side of said magnetic gap.

50. The speaker device according to claim 49, wherein a lead part of said voice coil lead wire is provided at the outer side of said magnetic gap.

51. The speaker device according to claim 50, wherein said voice coil lead wire includes a connecting part connecting to the outside, and
said voice coil lead wire from said lead part to said connecting part is arranged at the outer side of said magnetic gap.

52.-56. (canceled)

57. The speaker device according to claim 1, wherein said voice coil, includes a notch part at the end edge part extending in the vibration direction of said voice coil, and
said static part includes a projection part projecting toward said voice coil, wherein a part of said projection part is arranged inside said notch part.

58. The speaker device according to claim 57, wherein the width of said notch part in the vibration direction of said voice coil is substantially the same or larger than the amplitude of vibration of said voice coil.

59. The speaker device according to claim 21 comprising a connecting part provided between the end part of said vibration direction converter part in the side of said voice coil and the end part of said voice coil in the side of said vibration direction converter part, wherein said connecting part connects said end part of said vibration direction converter part in the side of said voice coil and said end part of said voice coil in the side of said vibration direction converter part at different positions in said vibration direction.

60. The speaker device according to claim 21,
wherein said vibration direction converter part is connected with an attaching counterpart including said diaphragm and said voice coil and includes a joint part in the proximity of said attaching counterpart, and
a contact avoiding part avoiding contact with said joint part is formed in the face side of said attaching counterpart in proximity of said joint part.

61. The speaker device according to claim 21, wherein said vibration direction converter part is connected with an attaching counterpart including said diaphragm and said voice coil and includes a joint part in proximity of said attaching counterpart, and
a receiving part of adhesive material connecting said vibration direction converter part and said attaching counterpart is formed in the face side of said attaching counterpart opposed to said joint part.

62. The speaker device according to claim 21,
wherein said vibration direction converter part includes a rigid link part angle-variably provided slantwise between said voice coil and said diaphragm and joint parts formed at both ends of said link part, and
said joint part is formed with a bendable continuous member continuing between parts of said joint part in both sides crossing said joint part.

63. An electronic device comprising the speaker device according to claim 21.

64. A vehicle comprising the speaker device according to claim 21.

65. A building comprising the speaker device according to claim 21.

66. An electronic device comprising the speaker device according to claim 47.

67. A vehicle comprising the speaker device according to claim 47.

68. A building comprising the speaker device according to claim 47.
